(19) United States
(12) Patent Application Publication
(10) Pub. No.: US 2018/0075681 A1
(43) Pub. Date: Mar. 15, 2018

(54) DOORBELL PACKAGE DETECTION SYSTEMS AND METHODS

(71) Applicant: SkyBell Technologies, Inc., Irvine, CA (US)

(72) Inventors: Joseph Frank Scalisi, Yorba Linda, CA (US); Andrew Paul Thomas, San Francisco, CA (US); Gregory Saul Harrison, Aliso Viejo, CA (US)

(73) Assignee: SkyBell Technologies, Inc., Irvine, CA (US)

(21) Appl. No.: 15/815,555

(22) Filed: Nov. 16, 2017

Related U.S. Application Data
(63) Continuation-in-part of application No. 15/793,552, filed on Oct. 25, 2017.
Application No. 15/793,552 is a continuation-in-part of application No. 15/167,831, filed on May 27, 2016, now Pat. No. 9,508,239.
Application No. 15/167,831 is a continuation-in-part of application No. 15/806,326, filed on Nov. 8, 2017.
Application No. 15/806,326 is a continuation-in-part of application No. 15/815,490, filed on Nov. 16, 2017.
(60) Provisional application No. 62/571,465, filed on Oct. 12, 2017.

(51) Int. Cl. G07C 9/00; G06K 9/20; G06K 7/14; G06K 7/10; G06F 17/30

(52) U.S. Cl. CPC G07C 9/00896; G06K 9/209; G06K 7/1413; G06K 9/00771; G06F 17/30979; G07C 2009/00928; G07C 2009/0092; G06K 7/10366

(57) ABSTRACT

Garage door opening systems can include a parcel identification detection system, a garage door opener, and a first computer system. The parcel identification detection system can be configured to detect a delivery parcel identification code of a delivery parcel. The garage door opener can be configured to open a garage door. The first computer system can be configured to receive the delivery parcel identification code detected by the parcel identification detection system and send a first communication to the garage door opener. The garage door opener can be configured to open the garage door at least partially in response to the first communication.

### CROSS-REFERENCE TO RELATED APPLICATIONS

This application claims the benefit of U.S. Provisional Patent Application No. 62/571,465; filed Oct. 17, 2017; entitled DOORBELL PACKAGE DETECTION SYSTEMS AND METHODS; and having an attorney docket number SKYBELL.079A.CP1PR. The entire contents of U.S. Patent Application No. 62/571,465 are incorporated by reference herein.

This application claims the benefit of and is a continuation-in-part of U.S. Non-Provisional patent application Ser. No. 15/793,552; filed Oct. 25, 2017; entitled DOORBELL PACKAGE DETECTION SYSTEMS AND METHODS; and having an attorney docket number SKYBELL.079A.CP1. The entire contents of U.S. patent application Ser. No. 15/793,552 are incorporated by reference herein. U.S. Non-Provisional patent application Ser. No. 15/793,552 claims the benefit of and is a continuation-in-part of U.S. Non-Provisional patent application Ser. No. 15/167,831 (issued as U.S. Pat. No. 9,508,239 on Nov. 29, 2016); filed May 27, 2016; entitled DOORBELL PACKAGE DETECTION SYSTEMS AND METHODS; and having an attorney docket number SKYBELL.079A. The entire contents of U.S. patent application Ser. No. 15/167,831 are incorporated by reference herein.

This application claims the benefit of and is a continuation-in-part of U.S. Non-Provisional patent application Ser. No. 15/806,326; filed Nov. 8, 2017; entitled DOORBELL PACKAGE DETECTION SYSTEMS AND METHODS; and having an attorney docket number SKYBELL.079A.CP2. The entire contents of U.S. patent application Ser. No. 15/806,326 are incorporated by reference herein.

This application claims the benefit of and is a continuation-in-part of U.S. Non-Provisional patent application Ser. No. 15/815,490; filed Nov. 16, 2017; entitled DOORBELL PACKAGE DETECTION SYSTEMS AND METHODS; and having an attorney docket number SKYBELL.079A.CP3. The entire contents of U.S. patent application Ser. No. 15/815,490 are incorporated by reference herein.

The entire contents of the following application are incorporated by reference herein: U.S. Nonprovisional patent application Ser. No. 15/793,552; filed Oct. 25, 2017; and entitled DOORBELL PACKAGE DETECTION SYSTEMS AND METHODS.

The entire contents of the following application are incorporated by reference herein: U.S. Nonprovisional patent application Ser. No. 15/785,605; filed Oct. 17, 2017; and entitled DOORBELL PACKAGE DETECTION SYSTEMS AND METHODS.

The entire contents of the following application are incorporated by reference herein: U.S. Provisional Patent Application No. 62/571,465; filed Oct. 12, 2017; and entitled DOORBELL PACKAGE DETECTION SYSTEMS AND METHODS.

The entire contents of the following application are incorporated by reference herein: U.S. Nonprovisional patent application Ser. No. 15/167,831; filed May 27, 2016; and entitled DOORBELL PACKAGE DETECTION SYSTEMS AND METHODS.

The entire contents of the following application are incorporated by reference herein: U.S. Nonprovisional patent application Ser. No. 15/130,883; filed Apr. 15, 2016; and entitled SMART LOCK SYSTEMS AND METHODS.

The entire contents of the following application are incorporated by reference herein: U.S. Nonprovisional patent application Ser. No. 15/008,304; filed Jan. 27, 2016; and entitled DOORBELL PACKAGE DETECTION SYSTEMS AND METHODS.

The entire contents of the following application are incorporated by reference herein: U.S. Nonprovisional patent application Ser. No. 14/861,613; filed Sep. 22, 2015; and entitled DOORBELL COMMUNICATION SYSTEMS AND METHODS.

The entire contents of the following application are incorporated by reference herein: U.S. Nonprovisional patent application Ser. No. 14/813,479; filed Jul. 30, 2015; and entitled DOORBELL COMMUNICATION SYSTEMS AND METHODS.

The entire contents of the following application are incorporated by reference herein: U.S. Nonprovisional patent application Ser. No. 14/589,830; filed Jan. 5, 2015; and entitled DOORBELL COMMUNICATION SYSTEMS AND METHODS.

The entire contents of the following application are incorporated by reference herein: U.S. Nonprovisional patent application Ser. No. 14/743,849; filed Jun. 18, 2015; and entitled DOORBELL COMMUNICATION SYSTEMS AND METHODS.

The entire contents of the following applications are incorporated by reference herein: U.S. Nonprovisional patent application Ser. No. 14/612,376; filed Feb. 3, 2015; and entitled DOORBELL COMMUNICATION SYSTEMS AND METHODS; U.S. Nonprovisional patent application Ser. No. 14/502,601; filed Sep. 30, 2014; and entitled DOORBELL COMMUNICATION SYSTEMS AND METHODS; U.S. Nonprovisional patent application Ser. No. 14/492,809; filed Sep. 22, 2014; and entitled DOORBELL COMMUNICATION SYSTEMS AND METHODS; U.S. Nonprovisional patent application Ser. No. 14/275,811; filed May 12, 2014; and entitled DOORBELL COMMUNICATION SYSTEMS AND METHODS; U.S. Nonprovisional patent application Ser. No. 14/142,839; filed Dec. 28, 2013; and entitled DOORBELL COMMUNICATION SYSTEMS AND METHODS; U.S. Nonprovisional patent application Ser. No. 14/099,888; filed Dec. 6, 2013; and entitled DOORBELL COMMUNICATION SYSTEMS AND METHODS; and U.S. Nonprovisional patent application Ser. No. 14/098,772; filed Dec. 6, 2013; and entitled DOORBELL COMMUNICATION SYSTEMS AND METHODS.

The entire contents of the following application are incorporated by reference herein: International Application No. PCT/US14/47622; filed Jul. 22, 2014 with the U.S. Patent and Trademark Office; and entitled DOORBELL COMMUNICATION SYSTEMS AND METHODS.

The entire contents of the following application are incorporated by reference herein: International Application No. PCT/US14/53506; filed Aug. 29, 2014 with the U.S. Patent and Trademark Office; and entitled DOORBELL COMMUNICATION SYSTEMS AND METHODS.

### BACKGROUND

### Field

Various embodiments disclosed herein relate to doorbells. Certain embodiments relate to doorbell systems that detect packages.

### Description of Related Art

Doorbells can enable a person located outside of an entry point, such as a door, to alert a person inside of an entry point that someone outside would like to talk to someone inside. Doorbells sometimes include a button located near a door, such as a front door, side door, or back door of a home, office, dwelling, warehouse, building, or structure. Doorbells are sometimes used near a gate or some other entrance to a partially enclosed area. Pushing the doorbell sometimes causes a chime or other alerting sound to be emitted.

A doorbell chime can be communicatively coupled with a doorbell while the chime is located remotely relative to the doorbell. For example, the doorbell can be coupled to an exterior surface of a building (e.g., near an entryway) and the chime can be coupled to an interior surface of a building.

Delivery parcels (e.g., packages, envelopes) are often left in a publicly accessible entryway of a building. These delivery parcels are sometimes stolen before the rightful owner can pick up the delivery parcels. Thus, there is a need for systems that reduce the likelihood of delivery parcel theft.

### SUMMARY

In several embodiments, methods may include using a delivery parcel detection system. The methods may comprise sending a digital key to a remote computing device of a delivery person. The digital key can be configured to enable unlocking a door of a building to which a delivery parcel is addressed. The door may comprise a lock system configured to impede unauthorized entry into the building. Methods may include detecting, by at least one of a doorbell and the lock system, the digital key via a first wireless communication from the remote computing device to at least one of the doorbell and the lock system.

Some embodiments may include unlocking the door to permit the delivery person to place the delivery parcel inside the building in response to detecting the digital key.

In several embodiments, the delivery parcel may include an expected delivery time window. Methods may include sending the digital key to the remote computing device in response to a first time being at least one of within the expected delivery time window and within a predetermined period prior to the expected delivery time window. Methods may include enabling the digital key. Methods may include disabling the digital key in response to a second time being past the expected delivery time window

In several embodiments, methods may include receiving, by at least one of the doorbell and the lock system, a delivery parcel identification code of the delivery parcel, and unlocking the door in response to both detecting the digital key and receiving the delivery parcel identification code. Methods may include unlocking the door in response to verifying that the delivery parcel identification code corresponds to an expected delivery time. In some embodiments, methods may include unlocking the door in response to verifying that the delivery parcel identification code corresponds to an expected delivery item.

In several embodiments, methods may include recording a video, by the doorbell, in response to detecting the delivery person and in response to determining that the delivery parcel is an expected delivery item. Methods may include saving the video and labeling the video as a delivery such that the labeling indicates to a doorbell user that the video shows the delivery of at least one item.

In some embodiments, methods may include detecting a first location of the remote computing device and sending the digital key to the remote computing device in response to the first location. Methods may include sending the digital key to the remote computing device in response to the first location being within one mile of at least one of the doorbell and the lock system. Methods may include sending the digital key to the remote computing device in response to the first location being within one hundred yards of at least one of the doorbell and the lock system. In some embodiments, methods may include sending the digital key to the remote computing device in response to the first location being within a direct wireless communication range of at least one of the doorbell and the lock system. The delivery parcel may include an expected delivery time window. Methods can include disabling the digital key in response to a second time being past the expected delivery time window.

In some embodiments, methods may include detecting, by at least one of the doorbell and the lock system, a delivery parcel identification code of the delivery parcel, and unlocking the door in response to both detecting the digital key and detecting the delivery parcel identification code.

In several embodiments, methods may include recording a video by the doorbell, determining that the video shows a delivery, and labeling the video. The labeling can indicate to a doorbell user that the video shows the delivery of at least one item.

In several embodiments, methods may include detecting a first location of a delivery vehicle and sending the digital key to the remote computing device in response to the first location. The delivery vehicle can be configured to transport the remote computing device and the delivery parcel. Methods may include sending the digital key to the remote computing device in response to the first location being within one mile of at least one of the doorbell and the lock system. Methods may include sending the digital key to the remote computing device in response to the first location being within a direct wireless communication range of at least one of the doorbell and the lock system. In some embodiments, the delivery parcel may comprise an expected delivery time window. Methods may include disabling the digital key in response to a second time being past the expected delivery time window.

In some embodiments, methods may include detecting, by at least one of the doorbell and the lock system, a delivery parcel identification code of the delivery parcel, and unlocking the door in response to both detecting the digital key and detecting the delivery parcel identification code.

In some embodiments, methods may include recording a video by the doorbell, determining that the video shows a delivery, and labeling the video such that the labeling indicates to a doorbell user that the video shows the delivery of at least one item.

In several embodiments, the method may include detecting a first identification code from the remote computing device, verifying that the first identification code is indicative of the remote computing device being authorized for deliveries, and sending the digital key to the remote computing device in response to detecting the first identification code and in response to verifying the first identification code. Methods may include detecting the first identification code by at least one of the doorbell and the lock system. The delivery parcel may include an expected delivery time window. Methods may include disabling the digital key in response to a second time being past the expected delivery time window.

In some embodiments, the method includes detecting, by at least one of the doorbell and the lock system, a delivery parcel identification code of the delivery parcel, and unlocking the door in response to both detecting the digital key and detecting the delivery parcel identification code. Methods may include recording a video by the doorbell, determining that the video show a delivery, and labeling the video such that the labeling indicates to a doorbell user that the video shows the delivery of at least one item. Methods may include sending the video to an entity associated with sending the delivery parcel.

In several embodiments, doorbells can include communication systems that enable the doorbells to communicate with other devices such as floor coverings and remote computing devices. Floor coverings can include sensors to detect whether a delivery parcel is located on the floor covering. In some embodiments, the floor covering is a box configured to received parcels. When a delivery parcel is placed on the floor covering, the floor covering can send a first communication to the doorbell. The doorbell can then send a second communication to a remote computing device (e.g., a smartphone) regarding the arrival of the delivery parcel.

In some embodiments, the floor covering can also sense when the delivery parcel is removed from the floor covering, which can cause the floor covering to send a third communication to the doorbell. The doorbell can then send a removal alert to the remote computing device regarding the removal of the delivery parcel from the floor covering.

In several embodiments, the doorbell can send a picture of the delivery parcel arriving and can send a picture of the delivery parcel being removed. The doorbell and/or the floor covering can also emit lights and/or sounds in response to the arrival of the delivery parcel and/or the removal of the delivery parcel. The picture can be a still picture and/or a video.

In some embodiments, a delivery parcel detection system can comprise a doorbell having a first wireless communication system and a floor covering. The floor covering can be configured for placement on an entryway floor. The floor covering can comprise a sensor that can be configured to detect a first indication of a delivery parcel on the floor covering. The floor covering can be communicatively coupled to the doorbell.

In several embodiments, the delivery parcel detection system can further comprise a first communication sent from the floor covering to the doorbell. The first communication can be sent in response to the floor covering detecting the first indication of the delivery parcel. The system can further comprise a second communication that can be sent from the doorbell to a remote computing device in response to the doorbell receiving the first communication.

In some embodiments, the floor covering of the system can be a mat.

In several embodiments, the second communication can comprise a first picture taken by the doorbell. The doorbell can be configured to send the first picture to the remote computing device in response to the floor covering detecting the first indication of the delivery parcel. In some embodiments, the first picture shows the delivery parcel.

In several embodiments, the first indication can be associated with an arrival of the delivery parcel to the floor covering.

In some embodiments, the system can further comprise a first alert regarding the delivery parcel. The first alert can be displayed on the remote computing device in response to the remote computing device receiving the second communication from the doorbell.

In several embodiments, the system can further comprise a graphical user interface displayed on the remote computing device. The graphical user interface can be configured to display information regarding the delivery parcel and/or the weather.

In some embodiments, the system can further comprise a graphical user interface displayed on the remote computing device. The doorbell can comprise at least one light. The graphical user interface can be configured to enable changing at least one setting of the light of the doorbell. In several embodiments, the setting can control a color of the light. In some embodiments, the setting can control a brightness of the light. In several embodiments, the system can automatically change the setting in response to the floor covering detecting the first indication of the delivery parcel.

In some embodiments of the system, the first communication can be a first wireless communication. The second communication can be a second wireless communication.

In several embodiments, the doorbell can comprise an electrical power consumption rate. The electrical power consumption rate can increase in response to the floor covering detecting the first indication of the delivery parcel.

In some embodiments, the doorbell can comprise a camera that can be configured to take at least one picture. At least one picture can be taken in response to the floor covering detecting the first indication of the delivery parcel.

In several embodiments of the system, the sensor can comprise a pressure sensor. The pressure sensor can be configured such that placing the delivery parcel on the floor covering enables the pressure sensor to detect the first indication.

In some embodiments, the system can further comprise a camera electrically coupled to at least one of the doorbell and the floor covering. The system can further comprise a video taken by the camera in response to the system detecting a removal of the delivery parcel.

In several embodiments, the system can further comprise a first communication that can be sent from the floor covering to the doorbell. A first communication can be sent in response to the floor covering detecting the first indication of the delivery parcel. The system can further comprise a second communication. The second communication can be sent from the doorbell to a remote computing device in response to the doorbell receiving the first communication.

In some embodiments, the system can further comprise a camera. The camera can be electrically coupled to at least one of the doorbell and the floor covering. The system can further comprise a video. The video can be taken by the camera in response to the camera detecting an object that has moved into a field of view of the camera during a period when the system may have determined the delivery parcel may be located on the floor covering.

In several embodiments, the system can further comprise a motion detector and a camera. The motion detector and the camera can be electrically coupled to at least one of the doorbell and the floor covering. The system can further comprise a video taken by the camera in response to the motion detector detecting a motion indication during a period when the system has determined the delivery parcel is located on the floor covering.

In some embodiments, the system can further comprise a first communication sent from the floor covering to the doorbell in response to the floor covering detecting the first indication of the delivery parcel. In several embodiments, the system can further comprise a second communication sent from the doorbell to a remote computing device. The second communication can be in response to the doorbell receiving the first communication.

In some embodiments, the system can further comprise a second communication sent from the doorbell to a remote computing device. The second communication can be in response to the motion detector detecting the motion indication. The second communication can comprise the video.

In several embodiments, the first indication can be associated with a removal of the delivery parcel from the floor covering. The system can further comprise a first communication sent from the floor covering to the doorbell in response to the floor covering detecting the first indication. The system can further comprise a second communication sent from the doorbell to a remote computing device in response to the doorbell receiving the first communication.

In some embodiments, the system can further comprise a camera. The camera can be electrically coupled to at least one of the doorbell and the floor covering. The second communication can comprise a picture that can be taken by the camera within five seconds of the sensor detecting the first indication.

In several embodiments, the system can comprise a camera that is electrically coupled to the doorbell. A first communication can be sent from the floor covering to the doorbell in response to the floor covering detecting the first indication of the delivery parcel. A picture can be taken by the camera of the doorbell in response to the floor covering detecting a removal of the delivery parcel from the floor covering.

In some embodiments, the system can further comprise a second communication that can be sent from the doorbell to the remote computing device. The second communication can be in response to the floor covering detecting the removal of the delivery parcel from the floor covering. The second communication can comprise the picture.

In several embodiments, the system can further comprise a warning sound. The warning sound can be emitted from the doorbell in response to the system detecting a removal of the delivery parcel from the floor covering.

In some embodiments, the system can further comprise at least one of a warning light and a warning sound that can be emitted from at least one of the doorbell and the floor covering. At least one of a warning light and a warning sound can be emitted in response to the system detecting at least one of motion and an object that has moved into a field of view of a camera of the doorbell. At least one of a warning light and warning sound can be in response to the system determining the delivery parcel is located on the floor covering.

In several embodiments, the system can further comprise at least one of a warning light and a warning sound emitted from at least one of the doorbell and the floor covering. At least one of a warning light and warning sound can be in response to the system detecting a removal of the delivery parcel from the floor covering. The warning may be emitted in response to a removal of the delivery parcel from the floor covering during a period when the system has determined that the remote computing device is not located within a predetermined distance of the doorbell, is not located within a detection range of the doorbell, or both.

In several embodiments, a delivery parcel detection system may comprise a doorbell, a remote computing device, and a delivery parcel. The doorbell may have a first wireless communication system and a radio-frequency identification reader. The remote computing device may be communicatively coupled with the doorbell via the first wireless communication system. The delivery parcel may have a radio-frequency identification tag. The doorbell may be configured to detect the delivery parcel by the radio-frequency identification reader reading the radio-frequency identification tag of the delivery parcel. A first communication may be sent from the doorbell to a remote computer system in response to the doorbell detecting the delivery parcel. The remote computer system may comprise a database. The database may have information regarding the delivery parcel. A second communication may be sent from the remote computer system to the doorbell in response to the remote computer system receiving the first communication. The second communication may comprise the information regarding the delivery parcel.

In some embodiments, the system may further comprise a third communication sent from the doorbell to the remote computing device in response to the doorbell receiving the second communication, wherein the third communication comprises the information. The third communication may comprise a time indicative of when the doorbell first detected the delivery parcel. The system may further comprise a fourth communication sent from the doorbell to the remote computing device in response to the doorbell receiving the second communication. The fourth communication may comprise a first picture taken by a camera of the doorbell. The first picture may show the delivery parcel. The system may further comprise a fourth communication sent from the doorbell to the remote computing device in response to the doorbell detecting the delivery parcel. The fourth communication may comprise a first picture taken by a camera of the doorbell. The first picture may show the delivery parcel.

In several embodiments the system may further comprise a first notification sent from the doorbell to the remote computing device in response to the doorbell detecting the radio-frequency identification tag of the delivery parcel. The first notification may comprise a first picture taken by a camera of the doorbell in response to the doorbell detecting the radio-frequency identification tag of the delivery parcel. The remote computing device may comprise a display screen. The system may further comprise at least a portion of the first picture displayed on the display screen. The system may be configured to enable a user of the remote computing device to see the delivery parcel on the display screen in response to the first notification. The system may further comprise a second notification sent from the doorbell to the remote computing device in response to the doorbell determining that the radio-frequency identification tag of the delivery parcel is no longer detected by the doorbell. The system may be configured to detect a removal of the delivery parcel from a detection range of the radio-frequency identification reader of the doorbell. The second notification may comprise a second picture taken by a camera of the doorbell in response to the doorbell determining that the radio-frequency identification tag of the delivery parcel is no longer detected by the doorbell. The system may further comprise a second notification sent from the doorbell to the remote computing device in response to the doorbell detecting a removal of the delivery parcel. The system may further comprise a first signal of the radio-frequency identification tag detected by the doorbell at a first time, a second signal of the radio-frequency identification tag detected by the doorbell at a second time, and a second notification sent from the doorbell to the remote computing device in response to the doorbell detecting a removal of the delivery parcel by determining that the second signal is weaker than the first signal. The second notification comprises a second picture taken by a camera of the doorbell in response to the doorbell detecting the removal. The radio frequency identification tag may be a passive tag. The radio frequency identification tag may be an active tag. The doorbell may be configured to detect the delivery parcel by the radio-frequency identification reader reading the passive radio-frequency identification tag of the delivery parcel. The doorbell may be configured to detect the delivery parcel by the radio-frequency identification reader reading the active radio-frequency identification tag of the delivery parcel.

In several embodiments the delivery parcel detection system may comprise a doorbell, a remote computing device, and a delivery parcel. The doorbell may have a first wireless communication system and a radio-frequency identification reader. The delivery parcel may have a radio-frequency identification tag. Some embodiments may include a method of using the delivery parcel detection system. The method may include detecting, by the doorbell, a delivery parcel; and sending, by the doorbell, a notification to a user. Detecting, by the doorbell, a delivery parcel may comprise reading, by the radio-frequency identification reader, a radio-frequency identification tag on the delivery parcel. The method may further comprise sending, by the doorbell, a notification to a sender. The method may further comprise receiving, by the doorbell system, information associated with the delivery parcel from the sender. The notification to the user may contain the information associated with the delivery parcel. The information associated with the delivery parcel may include at least a description of the contents. Detecting, by the doorbell, a delivery parcel may further comprise the delivery parcel entering an RFID reading distance of the doorbell. The method may further comprise detecting, by the doorbell, that the delivery parcel has been removed. The method may further comprise sending, by the doorbell, a notification to the user in response to the doorbell detecting that the delivery parcel has been removed. The method may further comprise taking, by the doorbell, a picture in response to the doorbell detecting that the delivery parcel has been removed.

In several embodiments, methods may include using a delivery parcel detection system configured to unlock a door of a building to which a delivery parcel is addressed. The door can comprise a lock system configured to impede unauthorized entry into the building. The method may comprise receiving, by a doorbell system, a delivery parcel identification code of the delivery parcel; and sending, by the doorbell system in response to receiving the delivery parcel identification code, a first wireless communication to the lock system. The first wireless communication may be configured to enable unlocking the door such that the delivery parcel detection system is configured to enable a delivery person to place the delivery parcel inside the building in response to the doorbell system verifying the delivery parcel. The door may be unlocked in response to receiving the first wireless communication. The door may be unlocked in response to verifying that the delivery parcel identification code corresponds to an expected delivery item.

In some embodiments, methods may include unlocking the door in response to verifying that the delivery parcel identification code corresponds to an expected delivery time. Methods may include unlocking the door in response to verifying that the delivery parcel identification code corresponds to an address of the building. Methods may include unlocking the door in response to verifying an identity of the delivery person. Methods may include sending a digital key to a remote computing device of the delivery person in response to receiving, by the doorbell system, the delivery parcel identification code.

In several embodiments, methods may include analyzing a database comprising data regarding deliveries to be sent to an address of the building, and then sending the first wireless communication in response to verifying that the delivery parcel identification code is indicative of the delivery parcel being associated with the address of the building. Methods may include analyzing a database comprising data regarding deliveries to be sent to an address of the building, and then unlocking the door in response to verifying that the delivery parcel identification code is indicative of the delivery parcel being associated with the address of the building. The doorbell system may include a database having data regarding deliveries to be sent to an address of the building. Methods may include analyzing, by the doorbell system, the database, and then unlocking the door in response to verifying, by the doorbell system, that the delivery parcel identification code is indicative of the delivery parcel being associated with the address of the building.

In some embodiments, methods may include sending a second communication having the delivery parcel identification code to a computing system. Methods may include determining, by the computing system, that the delivery parcel identification code is associated with an address of the building. In response to determining that the delivery parcel identification code is associated with the address, methods may include enabling the delivery person to unlock the door. Methods may include unlocking the door in response to determining that the delivery parcel identification code is associated with the address. At least one of the doorbell system and the lock system may comprise the computing system.

In several embodiments, methods may include sending a second wireless communication having the delivery parcel identification code to a remote computing system, and determining, by the remote computing system, that the delivery parcel identification code is associated with an address of the building, and then unlocking the door in response to determining that the delivery parcel identification code is associated with the address.

In some embodiments, methods may include recording a video of the delivery parcel. Methods may include analyzing the delivery parcel identification code to identify a description of contents of the delivery parcel. Methods may include sending a second wireless communication to a remote computing device. The second wireless communication may comprise the video and the description of the contents. Methods may include recording a video by a camera of the doorbell system, in response to unlocking the door. Methods may include recording a video, by a camera of the doorbell system, in response to receiving the delivery parcel identification code. Methods may include recording a video, by a camera of the doorbell system, in response to detecting the delivery person and in response to determining that the delivery parcel is an expected delivery item. Methods may include recording a video, by a camera of the doorbell system, in response to detecting the delivery person. Methods may include recording a video, by a camera of the doorbell system, and labeling the video as a delivery such that the labeling indicates to a doorbell user that the video shows the delivery of at least one item. Some methods may include recording a video, by the doorbell system, and sending the video to an entity associated with sending the delivery parcel.

In some embodiments, receiving the delivery parcel identification code may include scanning, by the doorbell system, a barcode of the delivery parcel. The doorbell system may include a camera. Methods may include using the camera to receive the delivery parcel identification code. The doorbell system may include a barcode scanner having a light source and a light sensor. Methods may include using the barcode scanner to receive the delivery parcel identification code.

In some embodiments, the doorbell system may include a camera. The delivery parcel may include a barcode. Receiving the delivery parcel identification code may include taking a picture of the barcode, by the camera. Methods may include analyzing the picture to identify the delivery parcel identification code. Receiving the delivery parcel identification code may include receiving a second wireless communication from a computing device configured to scan packages. Methods may include using visual analysis, by the doorbell system, to detect a shape of the delivery parcel, and then notifying a user of the doorbell that the delivery parcel has arrived in response to detecting the shape. The door may be a garage door.

In several embodiments, methods of using a doorbell system may include scanning, by a doorbell system, a barcode of a delivery parcel; identifying, by the doorbell system, a delivery parcel identification code of the delivery parcel in response to scanning the barcode; and sending, by the doorbell system, at least one wireless communication regarding the delivery parcel identification code to a remote location.

In some embodiments, the doorbell system may include a barcode scanner. The barcode scanner may have a light source and a light sensor. Scanning may include scanning the barcode of the delivery parcel using the barcode scanner. The doorbell system may comprise a camera. Scanning may include taking a picture of the barcode of the delivery parcel using the camera. Identifying the delivery parcel identification code of the delivery parcel can include analyzing the picture to identify the delivery parcel identification code.

In some embodiments, methods may include sending the wireless communication to an entity associated with sending the delivery parcel. The wireless communication can include the delivery parcel identification code. Methods may include notifying, via the wireless communication, an entity associated with sending the delivery parcel that the delivery parcel was delivered. The wireless communication may include an indication of an address of the doorbell system. Methods may include notifying, via the wireless communication, the entity associated with sending the delivery parcel that the delivery parcel was delivered to the address.

In several embodiments, the wireless communication may include the delivery parcel identification code. Methods may include notifying, via the wireless communication, a seller of the delivery parcel that the delivery parcel was delivered. The wireless communication may include an indication of an address of the doorbell system. Methods can include notifying, via the wireless communication, the seller that the delivery parcel was delivered to the address.

In some embodiments, methods may include recording a video, by a camera of the doorbell system, and sending the video to an entity associated with sending the delivery parcel.

In some embodiments, the video may be configured to show the delivery parcel. Methods may include providing video evidence to the entity of the delivery parcel being delivered. Methods can include sending the delivery parcel identification code and an address of the doorbell system to the entity associated with sending the delivery parcel.

In several embodiments, methods can include recording a video, by a camera of the doorbell system, and sending the video to an entity associated with sending the delivery parcel in response to identifying the delivery parcel identification code. Sending, by the doorbell system, the wireless communication regarding the delivery parcel identification code can include sending the wireless communication to a seller of the delivery parcel. Methods may include recording a video, by a camera of the doorbell system, and sending the video to the seller of the delivery parcel to provide video evidence of the delivery parcel being delivered.

In some embodiments, methods may include using the delivery parcel identification code identified by the doorbell system to determine an identity of an entity associated with sending the delivery parcel, and then sending, by the doorbell system, the wireless communication regarding the delivery parcel identification code to the entity. The wireless communication can include a video, taken by a camera of the doorbell system, wherein the video shows a delivery of the delivery parcel. The wireless communication may include an address to which the delivery parcel was delivered. The wireless communication can include the delivery parcel identification code. The at least one wireless communication can be a first wireless communication. Methods may include sending a second wireless communication regarding the delivery parcel identification code to a second remote location. Methods may include sending the first wireless communication to an entity associated with sending the delivery parcel, and sending the second wireless communication to a seller of the delivery parcel.

In several embodiments, methods of using a doorbell system can include receiving, by a doorbell system, a delivery parcel identification code of a delivery parcel and sending, by the doorbell system, at least one wireless communication comprising the delivery parcel identification code to an entity associated with sending the delivery parcel. The wireless communication can be configured to verify, by the doorbell system, that the delivery parcel was delivered to an address of the doorbell system.

In some embodiments, receiving the delivery parcel identification code can include scanning, by the doorbell system, a barcode of the delivery parcel. The doorbell system may include a barcode scanner having a light source and a light sensor. Methods may include using the barcode scanner to receive the delivery parcel identification code.

In some embodiments, the doorbell system can include a camera. The delivery parcel can include a barcode. Receiving the delivery parcel identification code may include taking a picture of the barcode, by the camera, and analyzing the picture to identify the delivery parcel identification code. Receiving the delivery parcel identification code can include receiving a second wireless communication from a computing device configured to scan packages.

In some embodiments, methods may include recording a video, by a camera of the doorbell system, and sending the video to the entity associated with sending the delivery parcel. The video may be configured to show the delivery parcel. Methods may include providing, by the doorbell system, video evidence to the entity of the delivery parcel being delivered. Methods may include recording a video, by a camera of the doorbell system. Methods may include sending the video to the entity associated with sending the delivery parcel in response to receiving the delivery parcel identification code and determining an identity of the entity associated with sending the delivery parcel. The at least one wireless communication can be a first wireless communication. Methods may include sending a second wireless communication comprising the delivery parcel identification code to a seller of the delivery parcel. The at least one wireless communication may include the delivery parcel identification code and the address of the doorbell system.

In several embodiments, a garage door opening system may include a parcel identification detection system, a garage door opener, and a first computer system. The parcel identification system can be configured to detect a delivery parcel identification code of a delivery parcel. The garage door opener may be configured to open a garage door. The first computer system may be configured to receive the delivery parcel identification code detected by the parcel identification detection system, compare the delivery parcel identification code to a first database which may comprise at least one expected delivery identification code, and send a first communication to the garage door opener in response to determining that the delivery parcel identification code is indicative of the delivery parcel being an expected delivery. The garage door opener can be configured to open the garage door at least partially in response to the first communication.

In some embodiments, the first computer system may be communicatively coupled to the parcel detection system and the garage door opener. The parcel identification detection system may be coupled to a building that comprises the garage door. The garage door opener can be configured to open the garage door less than 20 percent at least partially in response to the first communication to enable an entity that delivers the delivery parcel to push the delivery parcel under the partially open garage door. The garage door opener can be configured to open the garage door less than fully. The garage door may be configured to open an amount at least partially based on a size of the delivery parcel, in response to the first communication, to enable an entity that delivers the delivery parcel to push the delivery parcel under the garage door. The garage door opener may be configured to close the garage door in response to a predetermined amount of time passing. The garage door opening system may include a camera and a second computer system configured to analyze a picture taken by the camera to determine that the entity has left at least a portion of a field of view of the camera. The garage door opener may be configured to close the garage door in response to the second computer system determining that the entity has left.

In some embodiments, the garage door opening system may include a camera system configured to take a first picture of the delivery parcel and to take a second picture of the garage door in an at least partially open state. The garage door opening system may include a camera configured to take a first picture of the delivery parcel. The garage door opening system may be configured to send the first picture to a remote computing device. The garage door opening system may include a camera configured to take a first picture of the delivery parcel in response to the parcel identification detection system detecting the delivery parcel.

In several embodiments, the parcel identification detection system may include a camera. The parcel identification detection system may be configured to detect the delivery parcel identification code in response to the camera taking a picture of a barcode on the delivery parcel. The parcel identification detection system may be configured to detect the delivery parcel identification code, in response to analyzing the picture, to identify the delivery parcel identification code. The parcel identification detection system may comprise a barcode scanner comprising a light source and a light sensor. The parcel identification detection system may be configured to detect the delivery parcel identification code in response to the scanner scanning a barcode on the delivery parcel. The parcel identification detection system may be configured to detect the delivery parcel identification code in response to an entity that delivers the delivery parcel scanning the delivery parcel. The parcel identification detection system can be configured to detect the delivery parcel identification code in response to an entity that delivers the delivery parcel scanning the delivery parcel and wirelessly transmitting the delivery parcel identification code to the parcel identification detection system.

In some embodiments, the parcel identification detection system may include an antenna and may be configured to detect the delivery parcel identification code in response to the antenna receiving a second wireless communication having the delivery parcel identification code from a computing device configured to scan parcels. The garage door opening system may include a deliverer identification detection system configured to detect a first deliverer identification code associated with an entity that delivers the delivery parcel. The garage door opening system may include a third computer system configured to receive the first deliverer identification code detected by the deliverer identification detection system, compare the first deliverer identification code to a second database comprising at least one expected deliverer identification code, and determine that the first deliverer identification code is indicative of the entity being authorized to at least one of deliver the delivery parcel and open the garage door. The garage door opener may be configured to open the garage door at least partially in response to the third computer system determining that the first deliverer identification code is indicative of the entity being authorized. The garage door opening system may be configured to open the garage door less than 60 percent at least partially in response to the third computer system determining that the first deliverer identification code is indicative of the entity being authorized. The garage door opening system may be configured to open the garage door less than 15 percent at least partially in response to the third computer system determining that the first deliverer identification code is indicative of the entity being authorized.

In some embodiments, the garage door opening system includes a radio-frequency identification device having the first deliverer identification code and configured to be transported by the entity that delivers the delivery parcel. The deliverer identification detection system may be configured to wirelessly detect the first deliverer identification code from the radio frequency identification device. The radio frequency identification device may be configured to be worn by a delivery driver. The radio frequency identification device may be coupled to a delivery vehicle that transports the delivery parcel. The garage door opening system may include a remote computing device comprising the radio frequency identification device. The remote computing device is configured to be carried by a delivery driver.

In several embodiments, the garage door opening system may include a remote computing device configured to wirelessly transmit the first deliverer identification code to the deliverer identification detection system. The remote computing device is configured to read a barcode on the delivery parcel to determine the delivery parcel identification code, and is configured to wirelessly transmit the delivery parcel identification code to the parcel identification detection system to enable the parcel identification detection system to detect the delivery parcel identification code. The garage door opening system may include a speaker and an audio file. The garage door opening system may be configured to play the audio file via the speaker in response to detecting an entity that delivers the delivery parcel. The audio file may be configured to instruct the entity to put the delivery parcel inside a building having the garage door. The system may include a speaker and an audio file. The garage door opening system may be configured to play the audio file via the speaker in response to detecting the delivery parcel. The audio file can be configured to instruct the entity to put the delivery parcel inside a building having the garage door. The garage door opening system may include at least one of a camera and a motion detector configured to detect the delivery parcel.

In several embodiments, the garage door opening system may include a second wireless communication sent from the garage door opening system to a remote computing device of an entity that delivers the delivery parcel in response to the garage door opening system detecting at least one of the entity and the delivery parcel. The second wireless communication may be configured to instruct the entity to put the delivery parcel inside a building to which the garage door is attached. The system may include a speaker and an audio file. The garage door opening system may be configured to play the audio file via the speaker in response to the garage door opening system detecting at least one of the delivery parcel and an entity that delivers the delivery parcel. The audio file may be configured to instruct the entity to put the delivery parcel inside a building to which the garage door is attached.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a front view of a communication system, according to some embodiments.

FIG. 2 illustrates a computing device running software, according to some embodiments.

FIG. 3 illustrates a diagrammatic view of multiple computing devices and doorbells, according to some embodiments.

FIG. 4 illustrates a back view of a doorbell without a back cover to show various components of the doorbell's electrical system, according to some embodiments.

FIGS. 5 and 6 illustrate diagrammatic views of a doorbell system that can use a floor covering to detect parcels, according to some embodiments.

FIG. 7 illustrates a diagrammatic view of a doorbell system that can use a radio frequency identification reader to detect parcels, according to some embodiments.

FIGS. 8 and 9 illustrate a diagrammatic view of a doorbell system that can use a radio frequency identification reader to detect parcels, according to some embodiments.

FIGS. 10, 11, and 12 illustrate a diagrammatic view of a doorbell system that can use a radio frequency identification reader to detect parcels within a detection range, according to some embodiments.

FIGS. 13 and 14 illustrate a diagrammatic view of a doorbell system that can use a radio frequency identification reader to detect parcels within a detection range, according to some embodiments.

FIGS. 15, 16, and 17 illustrate a diagrammatic view of a doorbell and lock system, according to some embodiments.

FIGS. 18a and 18b are schematics of a method of enabling the unlocking of a door, according to some embodiments.

FIG. 19 illustrates a diagrammatic view of a doorbell and lock system, according to some embodiments.

FIG. 20 is a schematic of a method of recording, labeling, and sending a video, according to some embodiments.

FIGS. 21a and 21b are schematics of methods of activating and deactivating a digital key, according to some embodiments.

FIG. 22 illustrates a diagrammatic view of a doorbell and lock system, according to some embodiments.

FIG. 23 illustrates a diagrammatic view of a doorbell and lock system and a delivery vehicle, according to some embodiments.

FIGS. 24a and 24b are schematics of methods of sending and deactivating a digital key, according to some embodiments.

FIG. 25 illustrates a schematic of a method of verifying and sending a digital key, according to some embodiments.

FIG. 26 illustrates a diagrammatic view of a doorbell and lock system with a scanner, according to some embodiments.

FIG. 27 illustrates a diagrammatic view of a doorbell and lock system and a remote computing device, according to some embodiments.

FIG. 28 illustrates a diagrammatic view of a doorbell and lock system and a computing system, according to some embodiments.

FIG. 29 illustrates a diagrammatic view of a doorbell and lock system, according to some embodiments.

FIG. 30 illustrates a diagrammatic view of a doorbell system and a remote location, according to some embodiments.

FIG. 31 illustrates a diagrammatic view of a doorbell system, a first remote location, and a second remote location, according to some embodiments.

FIG. 32 illustrates a diagrammatic view of a doorbell system, a remote location, and a computing device, according to some embodiments.

FIG. 33 illustrates a diagrammatic view of a doorbell system, a first remote location, and a second remote location, according to some embodiments.

FIG. 34 illustrates a diagrammatic view of a garage door opening system, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Communication systems can provide a secure and convenient way for a remotely located individual to communicate with a person who is approaching a sensor, such as a proximity sensor or motion sensor, or with a person who rings a doorbell, which can be located in a doorway, near an entrance, or within 15 feet of a door. Some communication systems allow an individual to hear, see, and talk with visitors who approach at least a portion of the communication system and/or press a button, such as a doorbell's button. For example, communication systems can use a computing device to enable a remotely located person to see, hear, and/or talk with visitors. Computing devices can include computers, laptops, tablets, mobile devices, smartphones, cellular phones, and wireless devices (e.g., cars with wireless communication). Example computing devices include the iPhone, iPad, iMac, MacBook Air, and MacBook Pro made by Apple Inc. Communication between a remotely located person and a visitor can occur via the Internet, cellular networks, telecommunication networks, and wireless networks.

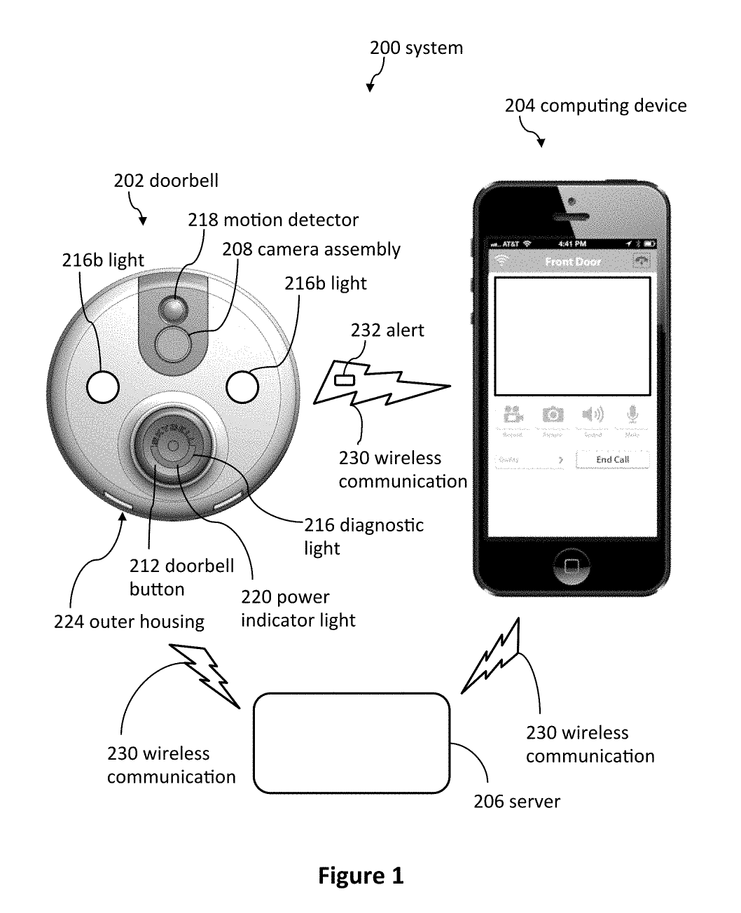

Referring now to FIG. 1, the doorbell 202 can record video and audio, which can then be sent to a remote computing device 204. The remote computing device 204 displays the video and emits the audio from the doorbell 202 to enable a user of the remote computing device 204 to see and hear a visitor. For example, when the doorbell 202 detects a visitor (e.g., a motion sensor 218 detects a visitor or the visitor presses the button 212), the doorbell 202 can send a push notification to the remote computing device 204. A user of the remote computing device 204 can then see and hear the visitor.

The user of the remote computing device 204 can select a button on application software running on the remote computing device 204 to initiate two-way audio and/or video communication with the visitor. In some embodiments, the user can see and hear the visitor, and the visitor can hear (but not see the user). In several embodiments, the user can hear (but not see) the visitor. In some embodiments, the user and visitor can both see and hear each other (e.g., the doorbell 202 can include a display screen to show live video captured by a camera of the remote computing device 204).

Doorbell systems can be a portion of a smart home hub. In some embodiments, the doorbell system 200 forms the core of the smart home hub. For example, the various systems described herein enable complete home automation. In some embodiments, the doorbell 202 controls various electrical items in a home (e.g., lights, air conditioners, heaters, motion sensors, garage door openers, locks, televisions, computers, entertainment systems, pool monitors, elderly monitors). In some embodiments, the computing device 204 controls the doorbell 202 and other electrical items in a home (e.g., lights, air conditioners, heaters, motion sensors, garage door openers, locks, televisions, computers, entertainment systems, pool monitors, elderly monitors).

FIG. 1 illustrates a front view of a communication system embodiment. The doorbell system 200 can include a doorbell 202 (e.g., a security system) and a computing device 204. Although the illustrated doorbell 202 includes many components in one housing, several doorbell embodiments include components in separate housings. The doorbell 202 can include a camera assembly 208 and a doorbell button 212. The camera assembly 208 can include a video camera, which in some embodiments is a webcam. The doorbell 202 can include a diagnostic light 216 and a power indicator light 220. In some embodiments, the diagnostic light 216 is a first color (e.g., blue) if the doorbell 202 and/or the doorbell system 200 is connected to a wireless Internet network and is a second color (e.g., red) if the doorbell 202 and/or the doorbell system 200 is not connected to a wireless Internet network. In some embodiments, the power indicator 220 is a first color if the doorbell 202 is connected to a power source. The power source can be supplied by the building to which the doorbell 202 is attached. In some embodiments, the power indicator 220 is a second color or does not emit light if the doorbell 202 is not connected to the power source.

The doorbell 202 can include an outer housing 224, which can be water resistant and/or waterproof. The outer housing can be made from metal or plastic, such as molded plastic with a hardness of 60 Shore D. In some embodiments, the outer housing 224 is made from brushed nickel or aluminum.

Rubber seals can be used to make the outer housing 224 water resistant or waterproof. The doorbell 202 can be electrically coupled to a power source, such as wires electrically connected to a building's electrical power system. In some embodiments, the doorbell 202 includes a battery for backup and/or primary power.

Wireless communication 230 can enable the doorbell 202 to communicate with the computing device 204. Some embodiments enable communication via cellular networks and/or wireless local area networks (“WiFi”). Some embodiments enable communication via the Internet. Several embodiments enable wired communication between the doorbell 202 and the computing device 204. The wireless communication 230 can comprise the following communication means: radio, WiFi, cellular, Internet, Bluetooth, Bluetooth Low Energy, telecommunication, electromagnetic, infrared, light, sonic, and microwave. Other communication means are used by some embodiments. In some embodiments, such as embodiments that include telecommunication or cellular communication means, the doorbell 202 can initiate voice calls or send text messages to a computing device 204 (e.g., a smartphone, a desktop computer, a tablet computer, a laptop computer).

Several embodiments use near field communication (“NFC”) to communicate between the computing device 204 and the doorbell 202. The doorbell 202 and/or the computing device 204 can include a NFC tag. Some NFC technologies include Bluetooth, radio-frequency identification, and quick response codes (“QR codes”).

Some embodiments include computer software (e.g., application software), which can be a mobile application designed to run on smartphones, tablet computers, and other mobile devices. Software of this nature is sometimes referred to as “app” software. Some embodiments include software designed to run on desktop computers and laptop computers.

The computing device 204 can run software with a graphical user interface. The user interface can include icons or buttons. In some embodiments, the software is configured for use with a touch-screen computing device such as a smartphone or tablet.

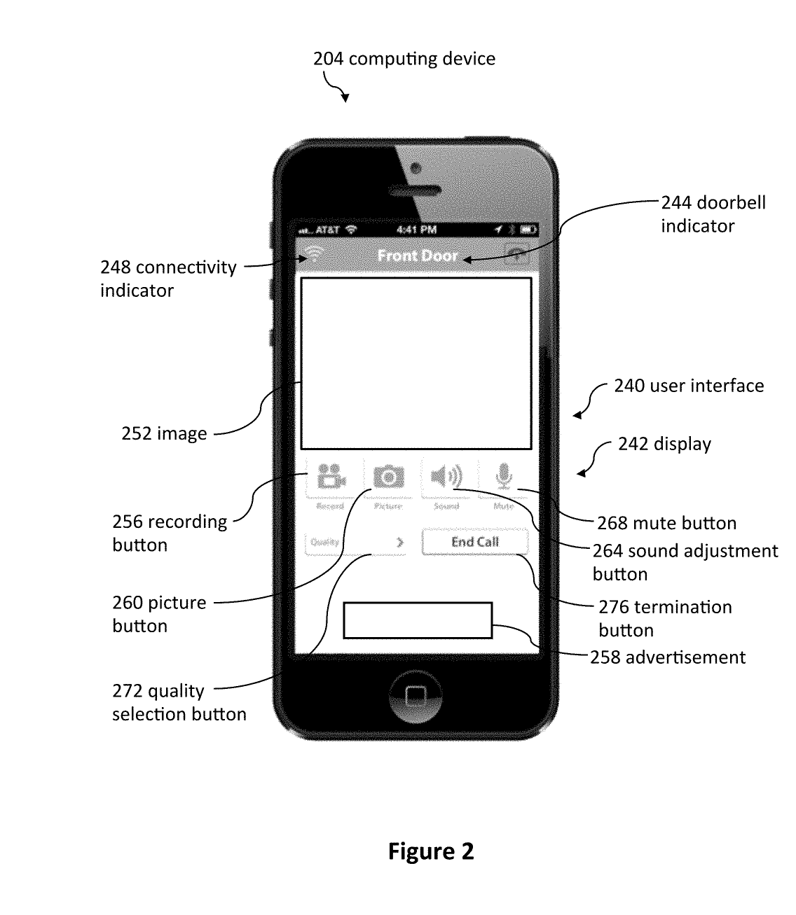

FIG. 2 illustrates a computing device 204 running software. The software includes a user interface 240 displayed on a display screen 242. The user interface 240 can include a doorbell indicator 244, which can indicate the location of the doorbell that the user interface is displaying. For example, a person can use one computing device 204 to control and/or interact with multiple doorbells, such as one doorbell located at a front door and another doorbell located at a back door. Selecting the doorbell indicator 244 can allow the user to choose another doorbell (e.g., a doorbell located by a back door rather than a doorbell located by a front door).

The user interface 240 can include a connectivity indicator 248. In some embodiments, the connectivity indicator 248 can indicate whether the computing device is in communication with a doorbell, the Internet, and/or a cellular network. The connectivity indicator 248 can alert the user if the computing device 204 has lost its connection with the doorbell 202; the doorbell 202 has been damaged; the doorbell 202 has been stolen; the doorbell 202 has been removed from its mounting location; the doorbell 202 has lost electrical power; and/or if the computing device 204 cannot communicate with the doorbell 202. In some embodiments, the connectivity indicator 248 notifies the user of the computing device 204 by flashing, emitting a sound, displaying a message, and/or displaying a symbol.

Referring now to FIG. 1, in some embodiments, if the doorbell 202 loses power, loses connectivity to the computing device 204, loses connectivity to the Internet, and/or loses connectivity to a remote server, a remote server 206 sends an alert 232 (e.g., phone call, text message, image on the user interface 240) regarding the power and/or connectivity issue. In several embodiments, the remote server 206 can manage communication between the doorbell 202 and the computing device 204. In some embodiments, information from the doorbell 202 is stored by the remote server 206. In several embodiments, information from the doorbell 202 is stored by the remote server 206 until the information can be sent to the computing device 204, uploaded to the computing device 204, and/or displayed to the remotely located person via the computing device 204. The remote server 206 can be a computing device that stores information from the doorbell 202 and/or from the computing device 204. In some embodiments, the remote server 206 is located in a data center.

In some embodiments, the computing device 204 and/or the remote server 206 attempts to communicate with the doorbell 202. If the computing device 204 and/or the remote server 206 is unable to communicate with the doorbell 202, the computing device 204 and/or the remote server 206 alerts the remotely located person via the software, phone, text, a displayed message, and/or a website. In some embodiments, the computing device 204 and/or the remote server 206 attempts to communicate with the doorbell 202 periodically; at least every five hours and/or less than every 10 minutes; at least every 24 hours and/or less than every 60 minutes; or at least every hour and/or less than every second.

In some embodiments, the server 206 can initiate communication with the computing device 204 and/or with the doorbell 202. In several embodiments, the server 206 can initiate, control, and/or block communication between the computing device 204 and the doorbell 202. In several embodiments, a user can log in to an “app,” website, and/or software on a computing device (e.g., mobile computing device, smartphone, tablet, desktop computer) to adjust the doorbell settings discussed herein.

In some embodiments, a computing device can enable a user to watch live video and/or hear live audio from a doorbell due to the user's request rather than due to actions of a visitor. Some embodiments include a computing device initiating a live video feed (or a video feed that is less than five minutes old).

Referring now to FIGS. 1 and 2, in some embodiments, the user interface 240 displays an image 252 such as a still image or a video of an area near and/or in front of the doorbell 202. The image 252 can be taken by the camera assembly 208 and stored by the doorbell 202, server 206, and/or computing device 204. The user interface 240 can include a recording button 256 to enable a user to record images, videos, and/or sound from the camera assembly 208, microphone of the doorbell 202, and/or microphone of the computing device 204.

In several embodiments, the user interface 240 includes a picture button 260 to allow the user to take still pictures and/or videos of the area near and/or in front of the doorbell 202. The user interface 240 can also include a sound adjustment button 264 and a mute button 268. The user interface 240 can include camera manipulation buttons such as zoom, pan, and light adjustment buttons. In some embodiments, the camera assembly 208 automatically adjusts between Day Mode and Night Mode. Some embodiments include an infrared camera and/or infrared lights to illuminate an area near the doorbell 202 to enable the camera assembly 208 to provide sufficient visibility (even at night).

In some embodiments, buttons include diverse means of selecting various options, features, and functions. Buttons can be selected by mouse clicks, keyboard commands, and touching a touch screen. Many embodiments include buttons that can be selected without touch screens.

In some embodiments, the user interface 240 includes a quality selection button 272, which can allow a user to select the quality and/or amount of the data transmitted from the doorbell 202 to the computing device 204 and/or from the computing device 204 to the doorbell 202.

In some embodiments, video can be sent to and/or received from the computing device 204 using video chat protocols such as FaceTime (by Apple Inc.) or Skype (by Microsoft Corporation). In some embodiments, these videos are played by videoconferencing apps on the computing device 204 instead of being played by the user interface 240.

The user interface 240 can include a termination button 276 to end communication between the doorbell 202 and the computing device 204. In some embodiments, the termination button 276 ends the ability of the person located near the doorbell 202 (e.g., the visitor) to hear and/or see the user of the computing device 204, but does not end the ability of the user of the computing device 204 to hear and/or see the person located near the doorbell 202.

In some embodiments, a button 276 is both an answer button (to accept a communication request from a visitor) and a termination button (to end communication between the doorbell 202 and the computing device 204). The button 276 can include the word “Answer” when the system is attempting to establish two-way communication between the visitor and the user. Selecting the button 276 when the system is attempting to establish two-way communication between the visitor and the user can start two-way communication. The button 276 can include the words “End Call” during two-way communication between the visitor and the user. Selecting the button 276 during two-way communication between the visitor and the user can terminate two-way communication. In some embodiments, terminating two-way communication still enables the user to see and hear the visitor. In some embodiments, terminating two-way communication causes the computing device 204 to stop showing video from the doorbell and to stop emitting sounds recorded by the doorbell.

In some embodiments, the user interface 240 opens as soon as the doorbell detects a visitor (e.g., senses indications of a visitor). Once the user interface 240 opens, the user can see and/or hear the visitor even before “answering” or otherwise accepting two-way communication, in several embodiments.

Some method embodiments include detecting a visitor with a doorbell. The methods can include causing the user interface to display on a remote computing device 204 due to the detection of the visitor (e.g., with or without user interaction). The methods can include displaying video from the doorbell and/or audio from the doorbell before the user accepts two-way communication with the visitor. The methods can include displaying video from the doorbell and/or audio from the doorbell before the user accepts the visitor's communication request. The methods can include the computing device simultaneously asking the user if the user wants to accept (e.g., answer) the communication request and displaying audio and/or video of the visitor. For example, in some embodiments, the user can see and hear the visitor via the doorbell before opening a means of two-way communication with the visitor.

In some embodiments, the software includes means to start the video feed on demand. For example, a user of the computing device can wonder what is happening near the doorbell 202. The user can open the software application on the computing device 204 and instruct the application to show live video and/or audio from the security device 202 even if no event near the doorbell 202 has triggered the communication.

In several embodiments, the security device 202 can be configured to record when the security device 202 detects movement and/or the presence of a person. The user of the computing device 204 can later review all video and/or audio records from when the security device 202 detected movement and/or the presence of a person.

Referring now to FIG. 1, in some embodiments, the server 206 controls communication between the computing device 204 and the doorbell 202, which can be a doorbell with a camera, a microphone, and a speaker. In several embodiments, the server 206 does not control communication between the computing device 204 and the doorbell 202.

In some embodiments, data captured by the doorbell and/or the computing device 204 (such as videos, pictures, and audio) is stored by another remote device such as the server 206. Cloud storage, enterprise storage, and/or networked enterprise storage can be used to store video, pictures, and/or audio from the doorbell system 200 or from any part of the doorbell system 200. The user can download and/or stream stored data and/or storage video, pictures, and/or audio. For example, a user can record visitors for a year and then later can review conversations with visitors from the last year. In some embodiments, remote storage, the server 206, the computing device 204, and/or the doorbell 202 can store information and statistics regarding visitors and usage.

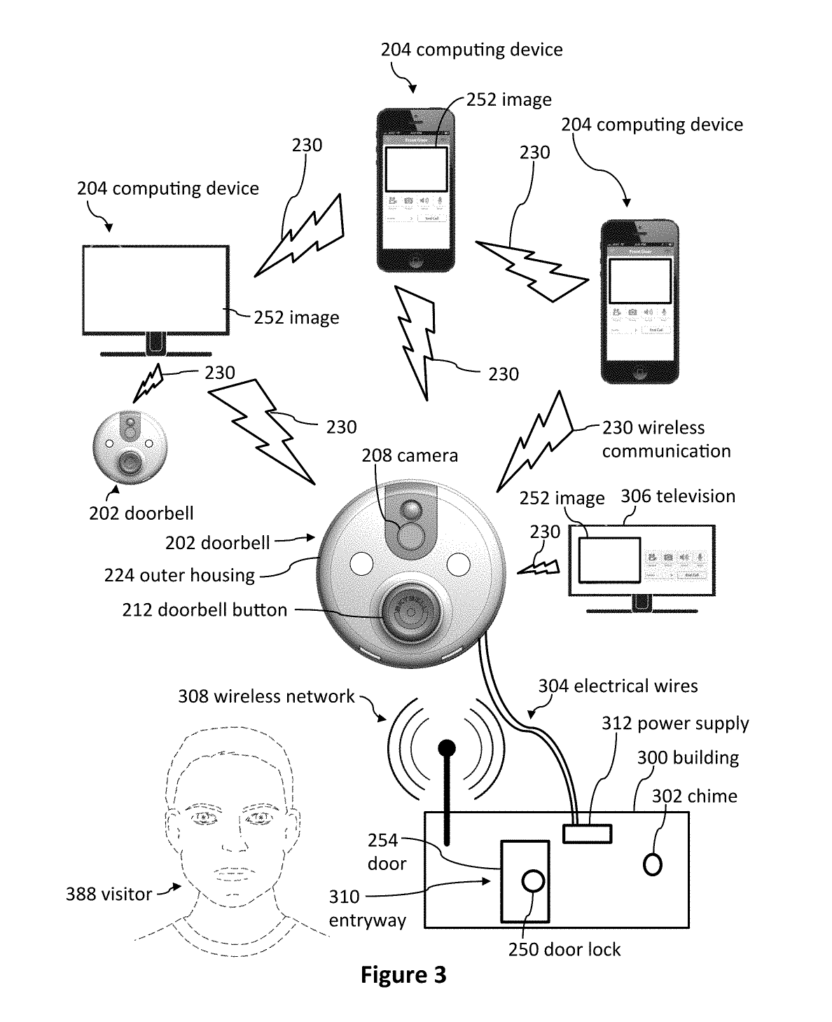

FIG. 3 illustrates an embodiment in which a doorbell 202 is connected to a building 300, which can include an entryway 310 that has a door 254. A visitor 388 can approach the doorbell 202 and then can be detected by the doorbell 202. The visitor 388 can press the doorbell button 212. The user of the doorbell 202 can configure the doorbell 202 such that when the visitor 388 presses the doorbell button 212, the user receives a notification regarding the visitor 388.

Electrical wires 304 can electrically couple the doorbell 202 to the electrical system 312 of the building 300, such that the doorbell 202 can receive electrical power from the building 300. The building can include a door lock 250 to lock the door 254.

A wireless network 308 can allow devices to wirelessly access the Internet. The doorbell 202 can access the Internet via the wireless network 308. The wireless network 308 can transmit data from the doorbell 202 to the Internet, which can transmit the data to remotely located computing devices 204. The Internet and wireless networks can transmit data from remotely located computing devices 204 to the doorbell 202. In some embodiments, a doorbell 202 connects to a home's WiFi.

As illustrated in FIG. 3, multiple computing devices 204 can communicate with one doorbell 202. In some embodiments, one computing device 204 (e.g., a laptop, a smartphone, a mobile computing device, a television) can communicate with multiple doorbells 202.

In some embodiments, the doorbell 202 can communicate (e.g., wirelessly 230) with a television 306, which can be a smart television. Users can view the television 306 to see a visitor and/or talk with the visitor.

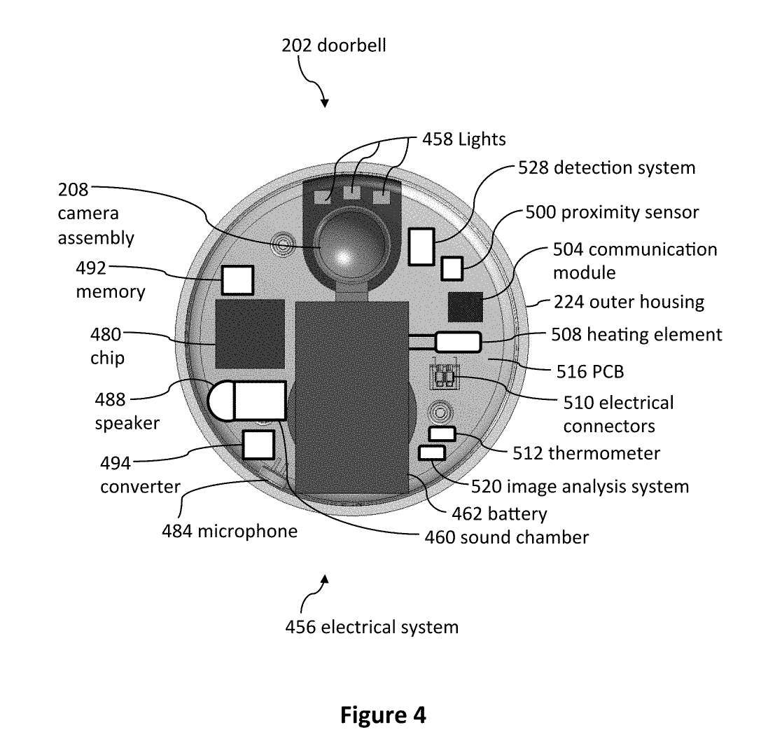

FIG. 4 illustrates an internal view of the doorbell 202. Doorbells 202 can include a chip 480 (e.g., integrated circuits, microprocessor, computer) and a memory 492. Doorbells 202 can also include a microphone 484 and a speaker 488. The speaker 488 can comprise a flat speaker and a sound chamber 460 configured to amplify an emitted sound. The flat speaker can be located in the sound chamber. Some doorbell embodiments include a proximity sensor 500. In several embodiments, doorbells 202 include a wireless communication module 504, such as a WiFi module. The communication module 504 can have an integrated antenna. In some embodiments, an antenna is contained within the outer housing 224.

The doorbell 202 can include one or more heating elements 508 configured to regulate the temperature of the doorbell 202. For example, doorbells 202 can be used in very cold environments, such as in Alaska. The heating element 508 can be used in various methods to protect temperature sensitive portions of the doorbell 202 from cold weather.

While protecting the doorbell 202 from cold weather can be important in some embodiments, protecting visitors from excessive heat can also be important in some embodiments. Excessive heat could burn visitors as they “ring” the doorbell (e.g., press the doorbell button 212 shown in FIG. 1). The doorbell 202 can include a thermometer 512 to enable the system to determine the temperature inside a portion of the doorbell 202 and/or outside the doorbell 202.

Several embodiments can be configured for 9 to 40 volts alternating current (“VAC”) and/or 9 to 40 volts direct current (“VDC”). Some embodiments convert input electricity into direct current (“DC”), such as 12 VDC. Several embodiments include a converter 494 for power conversion (e.g., converting electrical energy from one form to another). The converter 494 can convert input power (e.g., from wiring in a building) to a suitable power form for the doorbell 202. The power conversion can convert between AC and DC, change the voltage, and/or change the frequency. The converter 494 can include a transformer and/or a voltage regulator. In several embodiments, the converter 494 can include a voltage stabilizer, a linear regulator, a surge protector, a rectifier, a power supply unit, a switch, an inverter, and/or a voltage converter. In some embodiments, the converter 494 converts 50 Hertz (“Hz”) power into 60 Hz power.

The electrical components of the doorbell 202 (e.g., the camera assembly 208, the memory 492, the chip 480, the speaker 488, the converter 494, the microphone 484, the lights 458, a rectifier, the proximity sensor 500, the communication module 504, the heating element 508, the electrical connectors 510, the thermometer 512, the image analysis system 520, and the battery 462) can be electrically coupled to a printed circuit board (“PCB”) 516 and can receive electrical power from the PCB 516.

The PCB 516 and the electrical components of the doorbell 202 can be the electrical system 456 of the doorbell 202. Additional details regarding the PCB 516 and the electrical components of the doorbell 202 are described in U.S. Nonprovisional patent application Ser. No. 14/612,376; filed Feb. 3, 2015; and entitled DOORBELL COMMUNICATION SYSTEMS AND METHODS. The entire contents of patent application Ser. No. 14/612,376 are incorporated by reference herein.

The doorbell 202 can include a detection system 528. The doorbell 202 may be configured to alert the user to the presence of a visitor 388 by, for example, sounding a chime 302.

Although some embodiments are described in the context of devices and systems, the device embodiments and the system embodiments can also be formulated as methods. Devices and systems described herein can be applied to the methods incorporated by references herein.

Although some embodiments are described in the context of methods, the method embodiments can also be formulated as devices and systems. Methods described herein can be applied to the devices and systems incorporated by references herein.

Millions of parcels are delivered each week. Often, these parcels are delivered during working hours when the homeowner is away at work. When the parcels are too large to fit in a mailbox, mail carriers and other delivery personnel often leave the parcels on a front porch of the home or even in a common area of an apartment building.

These parcels can sit unattended for long periods of time. Thieves see unattended parcels as soft targets and often drive around neighborhoods looking for unattended parcels. Thieves can jump out of a car, steal the parcel, and then drive away within seconds. With shopping being done increasingly online and the resulting increase in parcel deliveries, parcel theft is becoming more and more of a problem. Until now, little has been done to combat parcel theft.

Embodiments described herein include high-tech floor coverings (e.g., mats) that can communicate wirelessly with a smart doorbell. The floor coverings can include sensors, such as pressure sensors and optical sensors, to detect when a parcel (e.g., a package, an envelope) is placed on the floor covering.

The floor covering can “wake up” the smart doorbell by sending a wireless communication (e.g., via Bluetooth Low Energy) to the doorbell. The doorbell can then send an alert to a remote computing device (e.g., a smartphone) to alert the user regarding the arrival or removal of the delivery parcel.

If the doorbell's motion sensor and/or camera detects a visitor when a delivery parcel is located on the floor covering, the doorbell can start recording a video. If the visitor takes the delivery parcel, then the video will document who took the delivery parcel. If the system senses that the visitor removed the delivery parcel from the floor covering, the system can send an alert (e.g., a push notification) to the remote computing device. This alert can include the video.

The system can recognize when a delivery parcel has arrived via image recognition. The system can create a security zone around the delivery parcel. If a visitor enters the security zone, the system can send an alert to the remote computing device and/or emit lights and sounds (e.g., from the doorbell, from the floor covering). This security zone can be a portion of the field of the view of the camera.

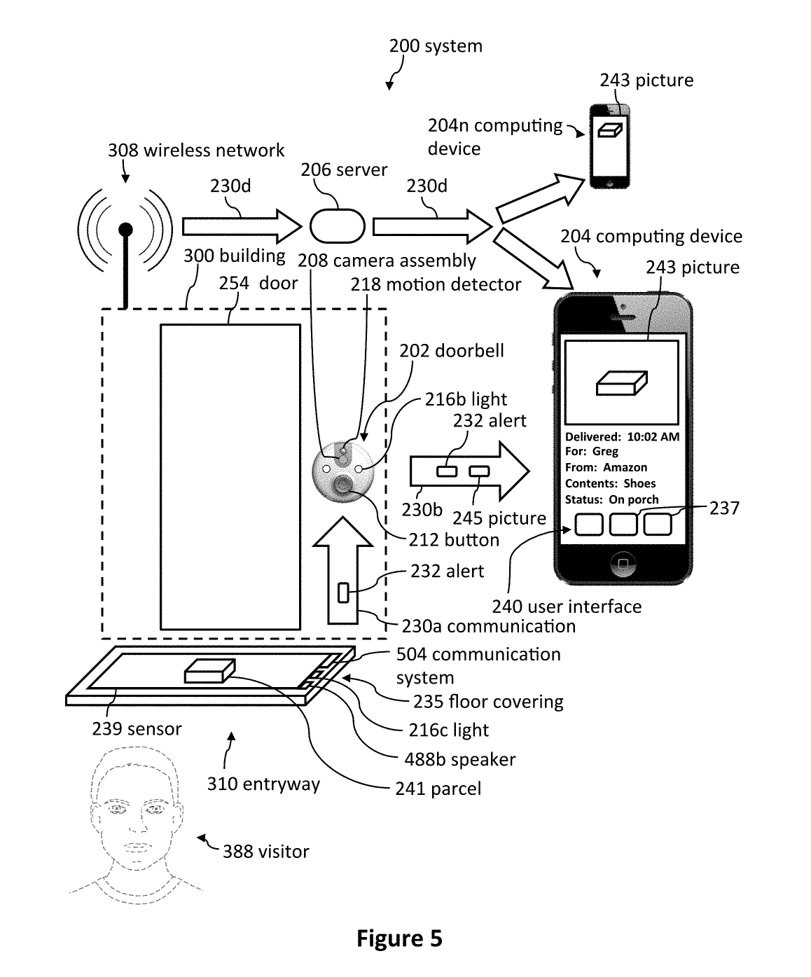

FIG. 5 illustrates a diagrammatic view of a delivery parcel detection system 200. A doorbell 202 is mounted to an exterior of a building 300 (e.g., in an entryway 310 near a door 254). The doorbell 202 can include a camera assembly 208 and a motion detector 218. The camera assembly 208 and the motion detector 218 can detect when a visitor 388 approaches the doorbell 202. This configuration enables the doorbell 202 to monitor the delivery parcel 241, which can be located in the entryway 310.

The floor covering 235 can communicate with the doorbell 202 (e.g., can send information to the doorbell 202). In some embodiments, the floor covering 235 is communicatively coupled (e.g., wirelessly coupled) to a wireless network 308 (e.g., of the building 300). The doorbell 202 can be communicatively coupled to the same wireless network 308 as the floor covering 235.

In several embodiments, the floor covering 235 communicates directly (via wires or wirelessly) with the doorbell 202. For example, Bluetooth, Bluetooth Low Energy, radio waves, and/or any suitable short-range communication system or protocol can be used by the communication system 504b of the floor covering 235 to enable the floor covering 235 to communicate with the doorbell 202.

The doorbell 202 can communicate with a remote computing device 204, which can be located inside the building 300, outside the building 300, or even many miles away from the building 300. The doorbell 202 can be communicatively coupled with the remote computing device 204 via the wireless network 308, the Internet, cellular networks, telecommunication networks, the server 206, and/or any other suitable system.

The delivery parcel 241 is located on top of a floor covering 235, which can be a mat. As used herein, the term “delivery parcel” is used broadly and can mean a box or envelope that is usually given, sent, or delivered to a person. For example, a mail carrier, a FedEx Corporation delivery worker, and any suitable delivery service can place a delivery parcel 241 near the building 300. In some cases, a friend or neighbor places a delivery parcel 241 near the building 300 (e.g., on the floor covering 235). Delivery parcels 241 can be large boxes, small boxes, odd-shaped packages, large envelopes, small envelopes, and/or any object that is placed on the floor covering 235.

As used herein, the term “floor covering” is used broadly. Floor coverings are configured for placing on the ground. Floor coverings can be mats. Mats can have a length and width that are more than ten times their thickness, which is measured vertically upward when the mat is placed on the ground. In some embodiments, mats can be used to wiping soiled shoe soles; however, not all mats are used for wiping shoe soles. For example, mats can be specially designed such that a delivery person can place parcels on the mats. Mats can be made of fabric or can be molded from plastic.

In FIG. 5, the floor covering 235 is located directly in front of the door 254, but in several embodiments, the floor covering 235 is located on the ground to the side of the door 254 to discourage visitors 388 from stepping on the floor covering 235.

The floor covering 235 can include sensors 239 to detect whether a delivery parcel 241 is located on the floor covering 235. In some embodiments, these sensors 239 are pressure sensors.

The pressure sensors can be thin and flexible. Tekscan, Inc., having an office in South Boston, Mass., makes high resolution pressure sensors that can be embedded in floor coverings 235. The nature of Tekscan's pressure sensors enables the system 200 to detect the footprint and the weight of the delivery parcel 241. This information can be compared to a database of parcels that are expected to be delivered to the address at which the floor covering 235 is located. This comparison enables the system 200 to determine which expected parcel has a footprint and/or weight indicative of being the parcel 239 located on the floor covering 235. The communication 230b to the remote computing device 204 can then include information regarding the contents of the parcel 241.

Digi-Key Corporation, having an office in Thief River Falls, Minn., sells many types of pressure sensors that can be embedded into the floor covering 235. Digi-Key sells pressure sensors from Freescale Semiconductor, Inc. that can be mounted to a PCB of the floor covering 235. Digi-Key also sells pressure sensors from STMicroelectronics N.V. that can be surface mounted on the floor covering 235.

In several embodiments, floor covering 235 comprises sensors 239 that are optical sensors. For example, the optical sensors can include light emitting diodes (“LEDs”) that emit light upwards (away from the ground). The optical sensors can also include light sensors configured to detect the light from the LEDs. The optical sensors can face upwards. If no object is located on top of the floor covering 235, the light from the LEDs simply continues upward and is not sensed by the light sensors. If an object is located on top of the floor covering 235, the light from the LEDs can reflect off the object such that the light is redirected back towards the light sensors. As a result, the light sensors can detect the object (e.g., a delivery parcel).

A light sensor can be located in the same upward facing hole as an LED, such that the light sensor is configured to detect light emitted from the LED if a delivery parcel covers the hole to deflect the light emitted from the LED towards the light sensor. The light sensor can be configured to only detect a specific type of light emitted by the LED, such that the sensor system does not confuse the presence or lack of sunlight as the presence or removal of a delivery parcel.

As shown in FIG. 5, a delivery parcel detection system 200 can include a doorbell 202 having a first wireless communication system 504 (shown in FIG. 4); and a floor covering 235 configured for placement on the ground (e.g., an entryway floor). The floor covering 235 can comprise a sensor 239 configured to detect a first indication of a delivery parcel 124 on the floor covering 235. The floor covering 235 is communicatively coupled to the doorbell 202 (e.g., via wires or wirelessly). The doorbell 202 can be mounted to a wall of the building 300 while the floor covering is located on the ground. The floor covering 235 can be a mat that includes a battery to provide electrical power to electrical components of the floor covering 235.

The system 200 can include a first communication 230a (e.g., a Bluetooth wireless communication) sent from the floor covering 235 to the doorbell 202 in response to the floor covering 235 detecting the first indication of the delivery parcel 241. The system 200 can also include a second communication 230b (e.g., a wireless communication) sent from the doorbell 202 to a remote computing device 204 in response to the doorbell 202 receiving the first communication 230a.

The doorbell 202 can include a camera 208. The second communication 230b can comprise a first picture 243 taken by the doorbell 202, such that the doorbell 202 is configured to send the first picture 243 to the remote computing device 204 in response to the floor covering 235 detecting the first indication of the delivery parcel 241. As illustrated in FIG. 5, the first picture 243 can show the delivery parcel 241 to enable the user of the remote computing device 204 to see the delivery parcel 241. The first picture 243 can be sent directly from the doorbell 202 to the computing device 204, but in many embodiments, the first picture 243 is sent from the doorbell 202 to the remote computing device 204 indirectly (e.g., via a server 206).

The first indication of the delivery parcel 241 can be a weight of the delivery parcel 241 sensed by the floor covering 235 (e.g., via a pressure sensor). The first indication of the delivery parcel 241 can also be a light sensed by a light sensor (e.g., as described above). The first indication can be due to the arrival of the delivery parcel (e.g., a pressure increase, a light increase) or can be due to a removal of the delivery parcel from the floor covering 235 (e.g., a pressure decrease, a light decrease).

The first indication can be associated with an arrival of the delivery parcel 241 to the floor covering 235. The first indication can be associated with a removal of the delivery parcel 241 from the floor covering 235. The communication 230b sent to the remote computing device 204 can indicate if the delivery parcel 241 arrived or was removed.

The system 200 can also comprise a first alert 232 regarding the delivery parcel 241. In some embodiments, the first alert is a push notification sent to the remote computing device 204 (e.g., sent wirelessly over various communication networks, sent via WiFi). The first alert 232 can be a text message on the remote computing device. The first alert 232 can be a graphic displayed on the screen of the remote computing device 204. The graphic can be configured to enable a user of the remote computing device 204 to see information regarding the delivery parcel (e.g., a picture of the parcel, a time of parcel arrival, a time of parcel removal, an identity of the person who delivered the parcel, an identity of the person who removed the parcel).

The first alert 232 can be displayed on the remote computing device 204 in response to the remote computing device 204 receiving the second communication 230b from the doorbell 202. The system 200 can include a graphical user interface 240 displayed on the remote computing device 204. The graphical user interface 240 can be configured to display information regarding the delivery parcel 241.

This information regarding the delivery parcel 241 can be displayed simultaneously with weather information (e.g., as detected by the system 200) described in U.S. Nonprovisional patent application Ser. No. 14/813,479; filed Jul. 30, 2015; and entitled DOORBELL COMMUNICATION SYSTEMS AND METHODS, which is incorporated by references herein. For example, the display can show information such as, “your package is outside in the rain” or “wind of 25 miles per hour is blowing your mail away.”

As shown in FIG. 5, the graphical user interface shows a picture 243 of the delivery parcel 241. The graphical user interface 240 can display the following information, and any other relevant information, regarding the delivery parcel 241: delivery time, to whom the delivery parcel is addressed, sender information, contents, and the status. The status can indicate whether the delivery parcel 241 is currently located on the floor covering 235. The status can also indicate if the delivery parcel 241 is still within a detection range (e.g., a field of view of the camera 208) of the doorbell 202.

The graphical user interface 240 is configured to enable changing at least one setting of the lights 216b of the doorbell 202. The user interface 240 can include buttons 237 (e.g., touch screen icons, which are not necessarily physical buttons). At least one of these buttons 237 can be a light adjustment button configured to enable changing settings of a light 216b (e.g., an LED) of the doorbell 202.

The setting that is changed by the button 237 can be a color of the light 216b. For example, the color can change from red to green to blue to white. Millions of color combinations are possible with LEDs. The color can correspond with holiday colors or special occasions.

The setting that is changed by the button 237 can be a brightness of the light 216b. For example, the button 237 can act as a light dimmer.

In some embodiments, the system 200 automatically changes the setting in response to the floor covering 235 detecting the first indication of the delivery parcel 241. For example, parcel 241 removal can cause a red light to flash from the doorbell 202 and/or from the floor covering 235. Parcel 241 arrival can cause a green light to flash.

In several embodiments, the system 200 (e.g., the doorbell) emits a sound or audible words in response to detecting the arrival or removal of the parcel 241. The sound and/or words can thank the deliver and/or warn the remover.

Many types of warning sounds be can emitted from the doorbell 202 (e.g., from the speaker 488 shown in FIG. 4) in response to the system 200 detecting a removal of the delivery parcel 241 from the floor covering 235. The floor covering 235 can also emit the warning sound from a speaker 488b. The warning sound can be a voice saying a predetermined message such as, “stop, package theft is against the law.” Reduced pressure, as sensed by the floor covering 235, can enable the system 200 to detect the removal of the parcel 241.

In addition to having a speaker 488b, the floor covering 235 can also include many warning lights 216c, which can be LEDs. In several embodiments, a warning light and a warning sound are emitted from at least one of the doorbell 202 and the floor covering 235 in response to the system 200 detecting motion (e.g., via the motion detector 218).

In some embodiments, a warning light and a warning sound are emitted from at least one of the doorbell 202 and the floor covering 235 in response to the system 200 detecting that an object (e.g., a visitor 388) has moved into a field of view of a camera 208 of the doorbell 202. For example, if a visitor 388 approaches the doorbell 202 and/or the floor covering 235 while a parcel 241 is located on the floor covering 235 and/or detected by the doorbell 202, the doorbell 202 and/or the floor covering 235 can emit the warning light from the lights 216b, 216c and can emit the warning sounds from the speakers 488b, 488 (shown in FIG. 4). Thus, the system 200 can emit the warnings in response to motion and/or object detection plus in response to the system 200 determining the delivery parcel 241 is located on the floor covering 235.

In some embodiments, the system 200 is configured to not emit a warning if a person carrying the remote computing device 204 is the one removing the parcel 241. In contrast, if a person is removing the parcel 241 when the remote computing device 204 is located far from the doorbell 202 (e.g., is away from home), then the person removing the parcel 241 can be a thief. Thus, some embodiments include a warning light and a warning sound emitted from at least one of the doorbell 202 and the floor covering 235 in response to the system 200 detecting a removal of the delivery parcel 241 from the floor covering 235 during a period when the system has determined that the remote computing device 204 is at least one of not located within a predetermined distance of the doorbell 202 and not located within a detection range of the doorbell 202. The predetermined distance can be within 30 meters of the doorbell 202.

The system 200 can determine if the computing device 204 is within a predetermined distance based on Global Positioning System (“GPS”) information from the doorbell 202 and the remote computing device 204. The system 200 can determine if the remote computing device 204 is within a detection range of the doorbell 202 via the doorbell 202 trying to communicate with the remote computing device 204 directly via a short-range communication protocol such as Bluetooth. If the remote computing device 204 does not respond to the Bluetooth signal from the doorbell 202, then the system 200 determines that the remote computing device 204 is outside of the detection range of the doorbell 202.

Doorbell 202 power consumption minimization can be important, especially in embodiments in which the doorbell 202 is powered exclusively via battery power (rather than via electrical wires 304 from a building 300 as shown in FIG. 3). In some embodiments, the doorbell 202 is in a Sleep Mode that precludes the camera 208 from recording without exiting the Sleep Mode. The floor covering 235 detecting a parcel 241 delivery, movement, or removal can cause the doorbell 202 to exit the sleep mode, take a picture, and/or start recording a video. The picture and video can be sent to the server 206 and/or to the remote computing device 204. In some embodiments, the doorbell 202 comprises an electrical power consumption rate that increases in response to the floor covering 235 detecting the first indication of the delivery parcel 241 (e.g., due to the activity of the camera 208).

In several embodiments, the doorbell 202 comprises a camera 208 configured to take at least one picture in response to the floor covering 235 detecting the first indication of the delivery parcel 241. The sensor 239 can comprise a pressure sensor configured such that placing the delivery parcel 241 on the floor covering 235 enables the pressure sensor to detect the first indication.

A camera 208 can be electrically coupled to the doorbell 202. The camera 208 can also be electrically coupled to the floor covering 235. The system 200 can comprise a video taken by the camera 208 in response to the system detecting a removal of the delivery parcel 241. A video can be taken by the camera 208 in response to the camera 208 detecting an object (e.g., a visitor 388) that has moved into a field of view of the camera 208 during a period when the system 200 has determined the delivery parcel 241 is located on the floor covering 235.

The doorbell 202 can include a motion detector 218. The floor covering can also include a motion detector 218, which can have all the same features and functions of the motion detector 218 of the doorbell 202. In some embodiments, a motion detector 218 and a camera 208 are electrically coupled to at least one of the doorbell 202 and the floor covering 235. The system 200 can comprise a video taken by the camera 208 in response to the motion detector 218 detecting a motion indication during a period when the system 200 has determined the delivery parcel 241 is located on the floor covering 235. A second communication 230b can be sent from the doorbell 202 to the remote computing device 204 in response to the motion detector 218 detecting the motion indication. The second communication 230b can comprise the video.

In several embodiments, the first indication is associated with a removal of the delivery parcel 241 from the floor covering 235. The system can further comprise a first communication 230a sent from the floor covering 235 to the doorbell 202 in response to the floor covering 235 detecting the first indication. The system can also comprise a second communication 230b sent from the doorbell 202 to a remote computing device 204 in response to the doorbell 202 receiving the first communication 230a. As described previously, a camera 208 can be electrically coupled to at least one of the doorbell 202 and the floor covering 235. The second communication 230b can comprise a picture taken by the camera 208 within five seconds of the sensor 239 detecting the first indication. Taking the picture within five seconds can help ensure the picture (which can be a video) shows the thief who removed the parcel 241 (via the system 200 taking the picture before the thief is able to run away).

The system 200 can take pictures 245 when the system 200 detects the arrival of the parcel 241, a visitor 388 moving (e.g., towards the doorbell 202), a movement of the parcel 241, and/or the removal of the parcel 241. The communication 230b between the doorbell 202 and the remote computing device 204 can include these pictures 245. Thus, the system 200 can send many pictures to the remote computing device 204 depending on the preferences of the user of the remote computing device 204. As used herein, sending a video includes sending a picture (because a picture is a portion of a video). Thus, a picture can be a still picture and can be an instant of a video (e.g., can be one frame of a video).

A doorbell communication 230d regarding the parcel 241 can be sent via a wireless network 308 (e.g., of the building 300), via Bluetooth, via cellular networks, via telecommunication networks, via the Internet, and/or via a server 206 to the remote computing device 204. In some embodiments, another remote computing device 204n also receives the doorbell communication 230d regarding the parcel 241. The doorbell communication 230d can include a picture 243 of the parcel 241 and/or a picture 243 taken by a camera 208, 208b of the system 200 at a time within 5 seconds of the doorbell 202 and/or the floor covering 235 detecting of an indication of the parcel 241 (e.g., an arrival of the parcel 241, a movement of the parcel 241, and/or a removal of the parcel 241 from the floor covering 235 and/or from a field of view of the doorbell 202).

In some embodiments, the second remote computing device 204n is a neighbor's remote computing device. The doorbell communication 230d can include a request for the neighbor to pick up and move the parcel 241. In response to this request, the neighbor can bring the parcel 241 to the neighbor's home to prevent the parcel 241 from being stolen until the parcel's owner can get the parcel 241 from the neighbor.

Some embodiments of the system 200 use the floor covering 235 to detect parcels 241. Some embodiments of the system 200, however, do not use the floor covering 235 to detect parcels 241. For example, the doorbell 202 can use the camera 208 to detect parcels 241.

The doorbell 202 can use the camera 208 to take a picture 243 when the doorbell 202 detects movement (via the camera 208 and/or via the motion detector 218). The system 200 can then analyze the picture 243 to determine if the picture 243 shows a parcel 241. This picture analysis can use image recognition procedures to look for indications of a parcel 241 in the picture 243. For example, the image recognition procedure can include looking for colors that are typical of cardboard delivery boxes (e.g., brown). The image recognition procedure can include looking for flat surfaces connected at approximately ninety-degree angles (which are indicative of a box shape). The image recognition procedure can include looking for flat surfaces located in different locations in images taken at different times (which is indicative of a box being carried towards the doorbell 202 such that the box is located in a first position in a first picture and is located in a second position in a second picture taken within 10 seconds of the first picture).

The parcel 241 detection procedure can also include using the microphone 484 (shown in FIG. 4) of the doorbell 202 to listen for sounds indicative of delivery vehicles (e.g., the sounds of large engines and heavy trucks typical of delivery services such as FedEx Corporation and United Parcel Service, Inc.). The system 200 can also use the microphone 484 to listen for sounds indicative of a parcel 241 being dropped on a floor (e.g., of an entryway 310). The system 200 can then analyze the sounds to identify that the parcel 241 has been delivered to the building 300 (e.g., the parcel 241 is located outside of the building 300 within a detection range of the doorbell 202).

The system 200 can hear a delivery vehicle stop within a detection range of the doorbell 202 (e.g., within a range that the microphone 484 can hear the delivery vehicle). However, the system 200 cannot know if the delivery vehicle left a parcel 241 at the building 300 or at a neighbor's home. The system 200 can distinguish between deliveries to neighbors' homes and deliveries to the building 300 by identifying a parcel delivery in response to detecting movement (via the camera 208 and/or via the motion detector 218) within 30 seconds of detecting sounds indicative of a delivery vehicle.

In FIG. 5 illustrates a perspective view of the floor covering 235. The view of FIG. 5 shows a front view of the door 254. FIG. 5 is a view that a visitor 388 typically sees as she walks towards a door 254 of a home.

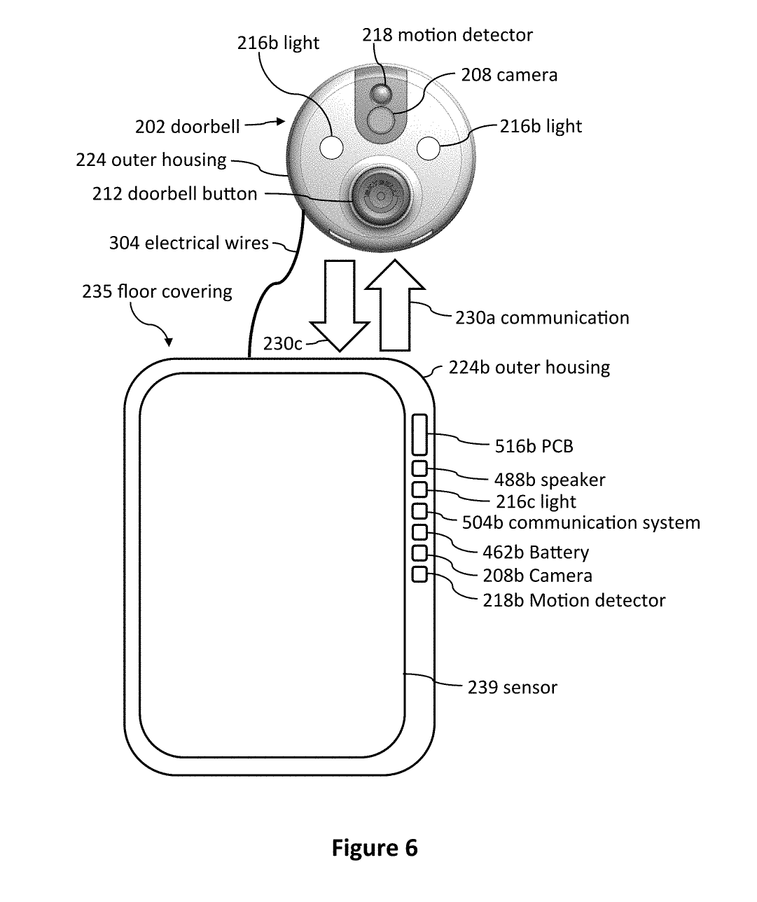

FIG. 6 illustrates a diagrammatic view of the floor covering 235. FIG. 6 illustrates a top view of the floor covering 235 and a front view of the doorbell 202. Electrical wires 304 electrically couple the doorbell 202 to the floor covering 235 to enable the doorbell 202 to provide electrical power to the floor covering 235 (or vice versa). The doorbell 202 can receive electrical power from the building 300 (shown in FIG. 5) and then can provide at least a portion of the electrical power to the floor covering 235 via the electrical wires 304 (e.g., while the doorbell 202 is mounted to a wall of the building 300 and while the floor covering 235 is located on the ground). The electrical wires 304 can also be used for one-way communication and/or two-way communication between the doorbell 202 and the floor covering 235.

Several embodiments do not include electrical wires 304 between the doorbell 202 and the floor covering. The doorbell 202 can send communications 230c to the floor covering 235 wirelessly. The floor covering 235 can send communications 230a to the doorbell 202 wirelessly.

The floor covering 235 can comprise a PCB, a speaker 488b, a light 216c, a battery 462b, a camera 208b, and a motion detector 218b. The floor covering 235 can also include a communication system 504b configured to enable communication between the floor covering 235 and the doorbell 202. The communication system 504b can include a transceiver. The communication system 504b can be a Bluetooth communication system, which can use Bluetooth Low Energy.

The sensor 239 can be configured to detect parcels on at least 60 percent of the top surface of the floor covering 235. This configuration can help minimize the occurrences of failing to detect a parcel that is located on the floor covering 235. The sensor 239 can be made of many individual pressure sensors, light sensors, package sensors, and/or any sensor configured to detect a parcel.

Although some embodiments are described in the context of devices and systems, the device embodiments and the system embodiments can also be formulated as methods. Some embodiments include methods of detecting parcels. Methods can include obtaining a delivery parcel detection system comprising a doorbell having a first wireless communication system; and a floor covering configured for placement on an entryway floor. The floor covering can comprise a sensor. Methods can include detecting, by the sensor of the floor covering, a first indication of a delivery parcel on the floor covering. Methods can include communicatively coupling the doorbell to the floor covering; mounting the doorbell to a building; and/or placing the floor covering in on an entryway floor.

Several embodiments include sending a first communication from the floor covering to the doorbell in response to the floor covering detecting the first indication of the delivery parcel. Some methods include sending a second communication from the doorbell to a remote computing device in response to the doorbell receiving the first communication.

The second communication can comprise a first picture taken by the doorbell. Some methods comprise sending, by the doorbell, the first picture to the remote computing device in response to the floor covering detecting the first indication of the delivery parcel.

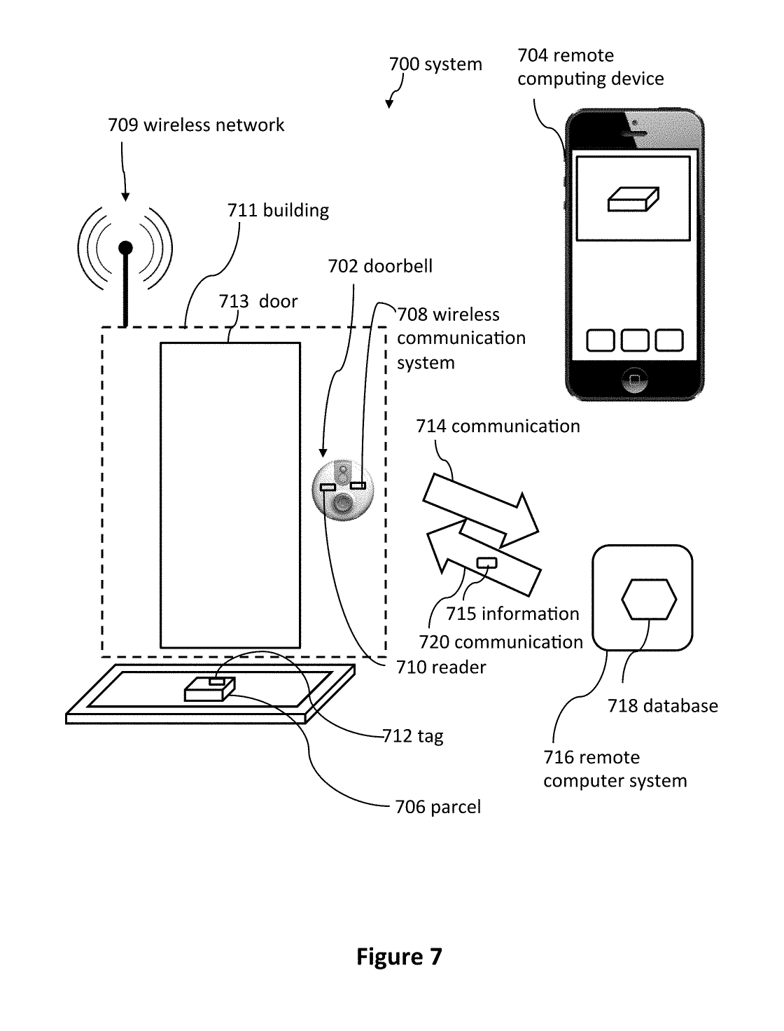

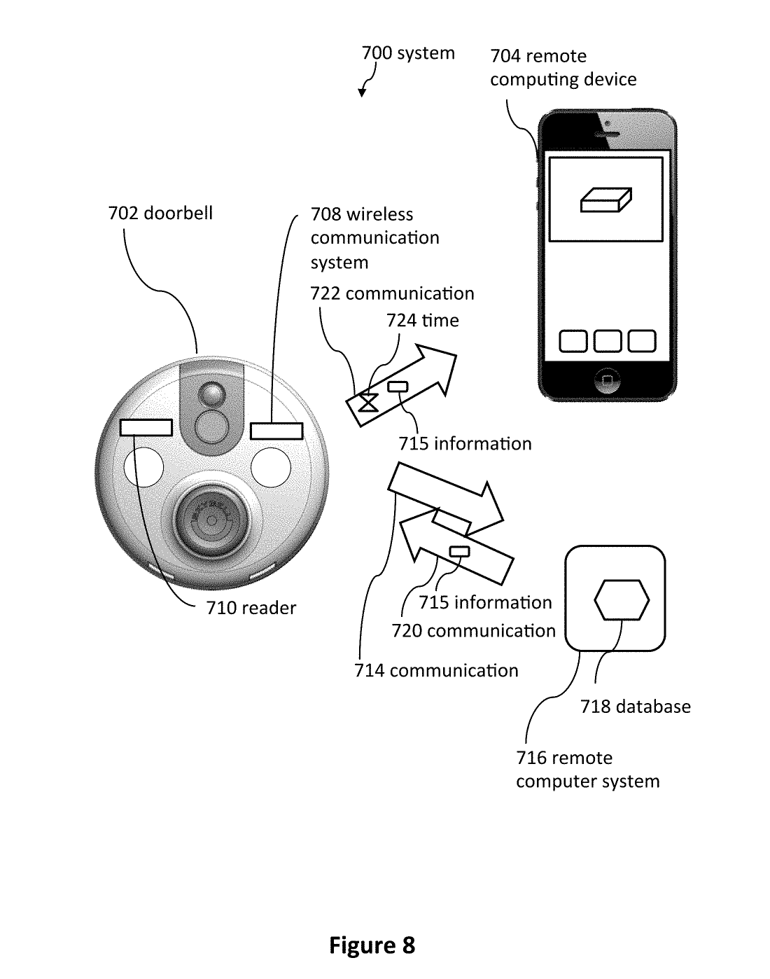

Referring now to FIGS. 7 and 8, in several embodiments, a delivery parcel detection system 700 includes a doorbell 702, a remote computing device 704, and a delivery parcel 706. The doorbell 702 may have a first wireless communication system 708 and a radio-frequency identification reader 710. The doorbell 702 can be attached to the outside wall of a building 711, (e.g., near a door 713). The remote computing device 704 may be communicatively coupled with the doorbell 702 via the first wireless communication system 708. The first wireless communication system 708 may be configured to interface with or include a wireless network 709. The delivery parcel 706 may have a radio-frequency identification tag 712. When a parcel 706 with a radio frequency identification tag 712 is left near the door 713 by, for example, a mail carrier, the doorbell 702 can detect the parcel 706. The doorbell 702 detects the parcel 706 by the radio-frequency identification reader 710 reading the radio-frequency identification tag 712 of the delivery parcel 706.

When the doorbell 702 detects the radio-frequency identification tag 712, a first communication 714 can be sent from the doorbell 702 to a remote computer system 716. The remote computer system 716 may comprise a database 718. The remote computer system 716 may be affiliated with the sender. The database 718 may have information 715 regarding the delivery parcel 706. A second communication 720 may be sent from the remote computer system 716 to the doorbell 702 in response to the remote computer system 716 receiving the first communication 714. The second communication 720 may comprise the information 715 regarding the delivery parcel 706.

In some embodiments, the system 700 may further comprise a third communication 722 sent from the doorbell 702 to the remote computing device 704 in response to the doorbell 702 receiving the second communication 720. The third communication 722 can contain the information 715 that was received by the doorbell 702 from the sender. The third communication 722 may also contain a time 724 indicative of when the doorbell 702 first detected the delivery parcel 706.

For example, the user may order a product from the sender online. The sender ships the product and when it arrives on the doorstep (the delivery parcel 706), the doorbell 702 detects the parcel 706 and sends a communication 714 to the sender that the parcel 706 has arrived at its destination. The sender may then send information 715 associated with the delivery parcel 706 back to the doorbell 702. Once the doorbell 702 has this information 715 it may send it on, in another communication, to the user, thus allowing the user to be notified that they have a parcel 706 and information 715 about it. The communication may also notify them of the time of delivery of the parcel 706. The information 715 associated with the delivery parcel 706 may be a description of the contents of the parcel 706, the name of the sender of the parcel 706, the value of the parcel 706, etc. The remote computer system 716 may be, for example, a server, a website, a computer, or a workstation.

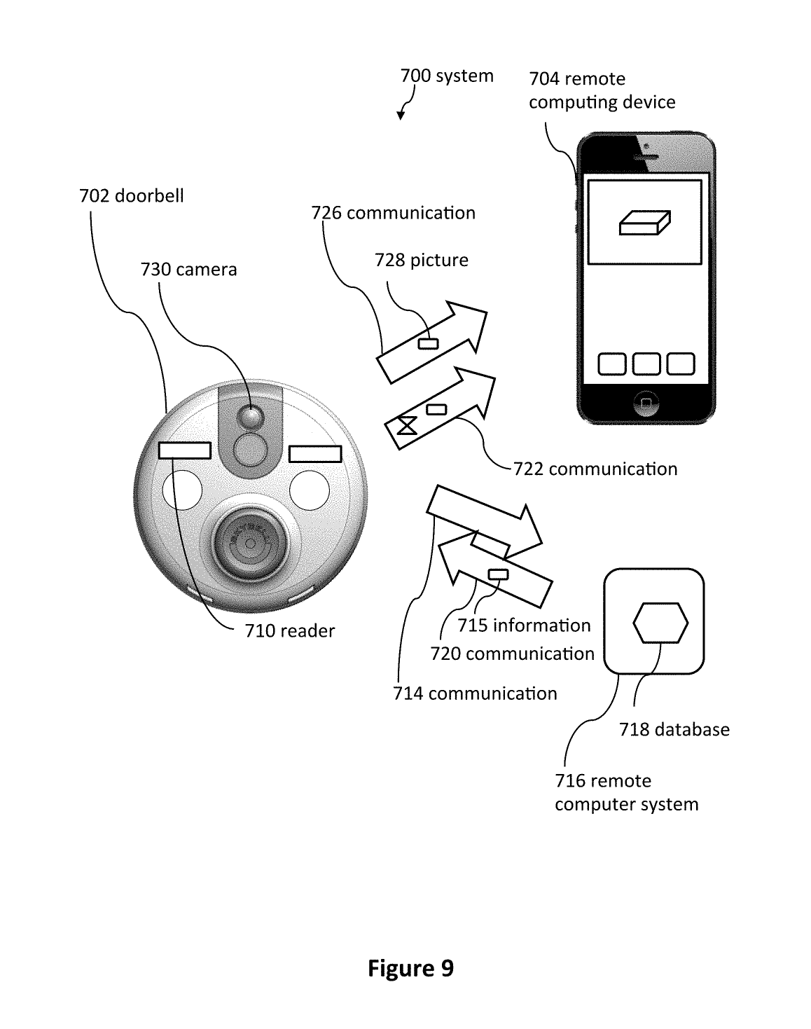

Referring now to FIG. 9, the doorbell 702 may also include a camera 730 to allow the user to see the parcel 706 that has been delivered. When the doorbell 702 detects a parcel 706, it may take a picture of the parcel 706 and send it to the remote computing device 704 in a fourth communication 726. A fourth communication 726 may also be sent from the doorbell 702 to the remote computing device 704 in response to the doorbell 702 receiving the second communication 720. The fourth communication 726 may comprise a first picture 728 taken by a camera 730. The first picture 728 may show the delivery parcel 706.

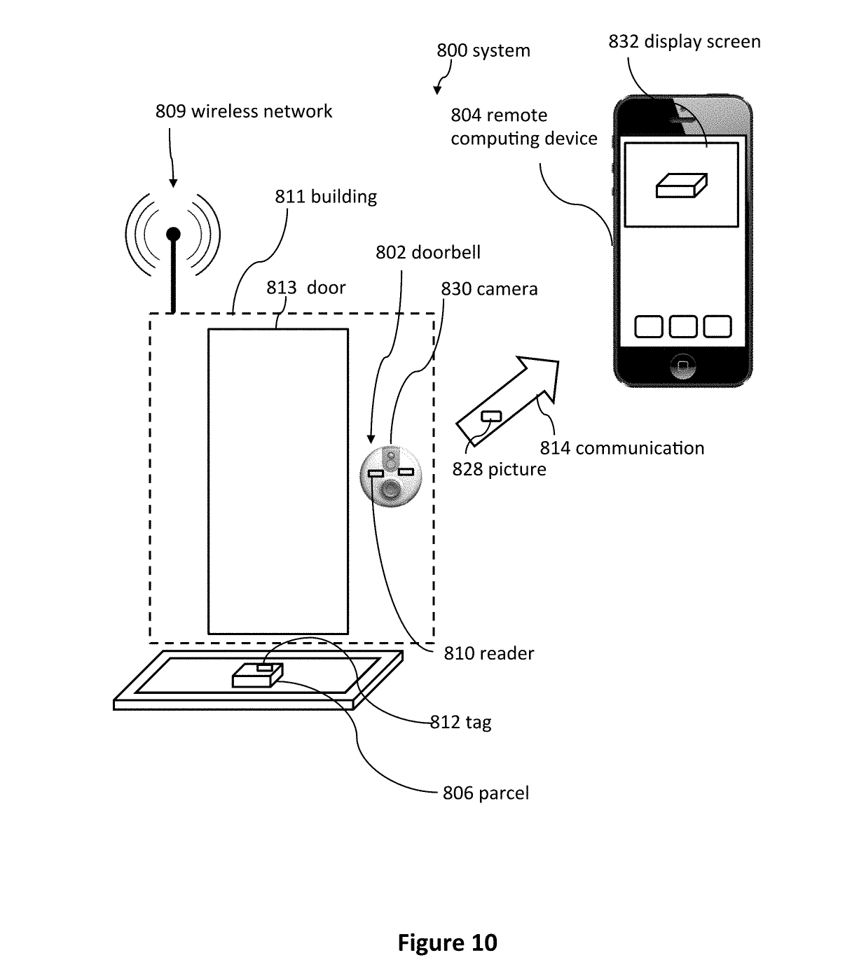

Referring now to FIG. 10, in several embodiments the system 800 may comprise a first notification 814 sent from the doorbell 802 to the remote computing device 804 in response to the doorbell 802 detecting the radio-frequency identification tag 812 of the delivery parcel 806. The first notification 814 may comprise a first picture 828 taken by a camera 830 of the doorbell 802 in response to the doorbell 802 detecting the radio-frequency identification tag 812 of the delivery parcel 806. The remote computing device 804 may have a display screen 832 to allow a user to, for example, view at least a portion of the first picture 828 displayed on the display screen 832. The system 800 may be configured to enable a user of the remote computing device 804 to see the delivery parcel 806 on the display screen 832 in response to the first notification 814.

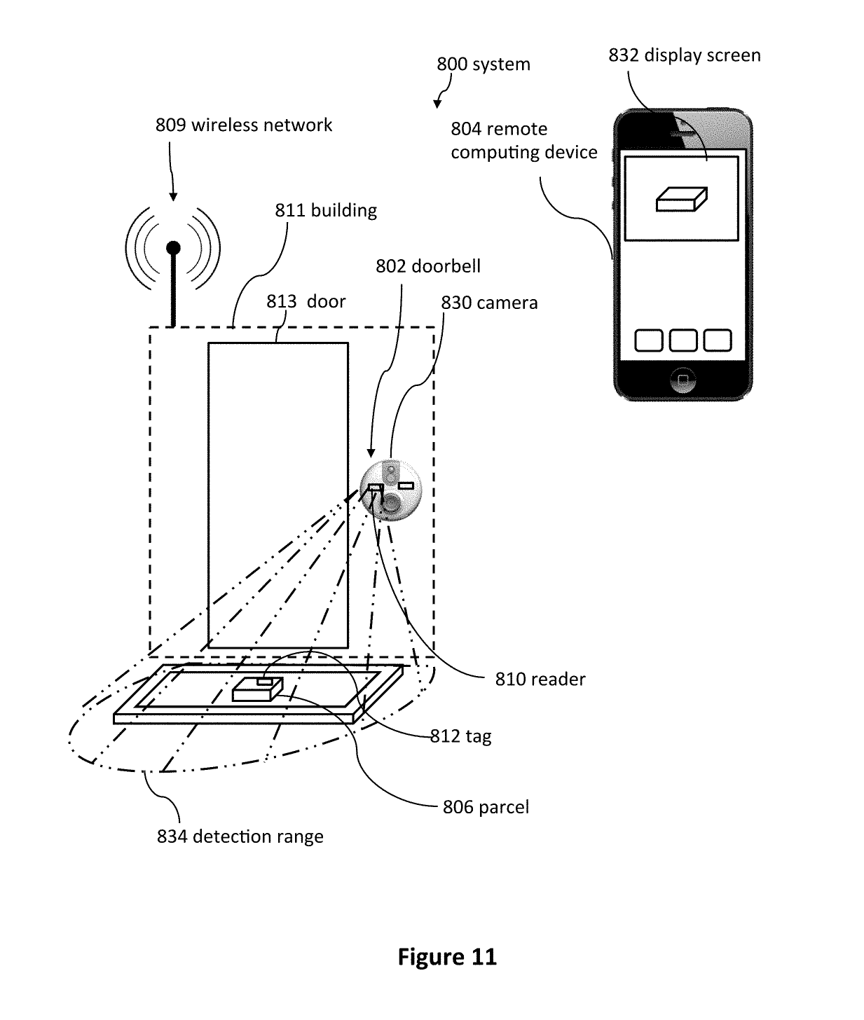

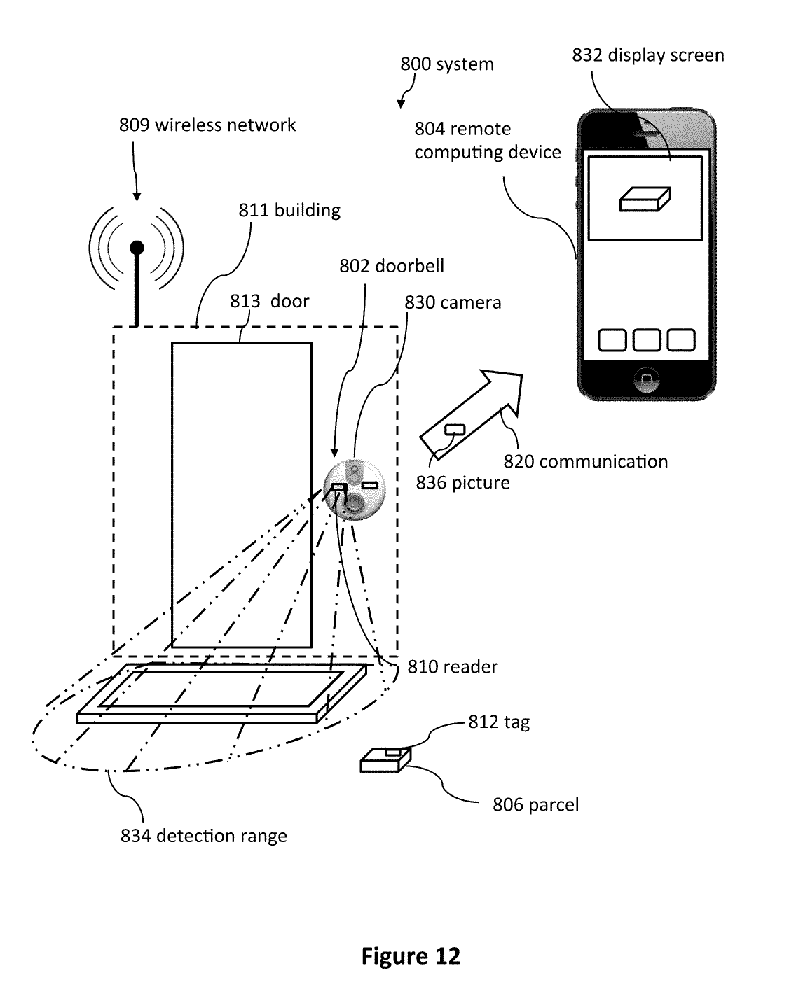

Referring now to FIGS. 11 and 12, the doorbell 802 may be attached to a building 811, for example, near a door 813. The doorbell has a radio-frequency identification reader 810, which has a specific detection range 834. When a package is brought into this detection range 834, the radio-frequency identification reader 810 is able to read the radio-frequency identification tag 812 on the parcel 806. The system 800 may send a notification 814 to the remote computing device when a parcel 806 with a radio-frequency identification tag 812 enters the detection range 834. Likewise, if a parcel 806 with a radio-frequency identification tag 812 is removed from the detection range 834 (e.g., is no longer detected by the doorbell 802), the doorbell 802 may send a notification 820 to the remote computing device 804. The removal of a parcel 806 may trigger the camera 830 to take a picture 836. The picture 836 may allow a user to determine if the parcel 806 was stolen, or blown away, etc. The notification 820 that the parcel 806 has been removed could also alert a user when a parcel 806 is picked up by, for example, a mail carrier. The notification 820 that the parcel 806 has been removed may contain the picture 836 taken by the camera 830 of the doorbell 802 as well as other information (e.g., the time, date, etc.).

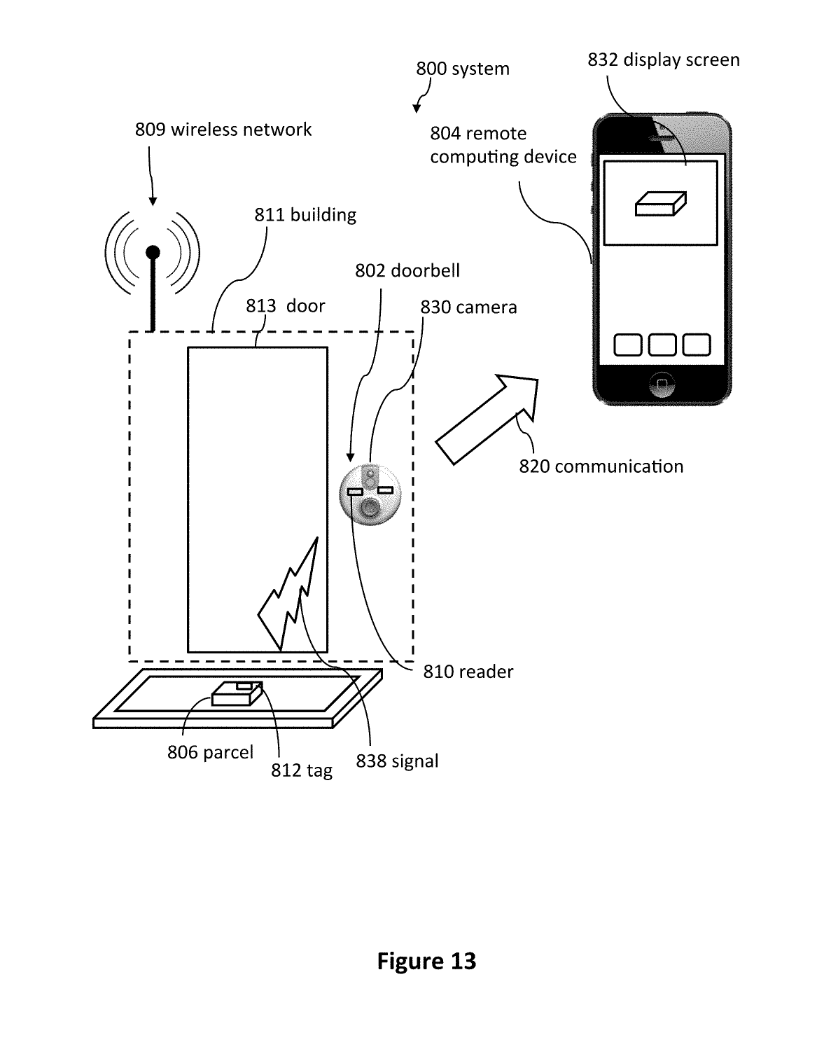

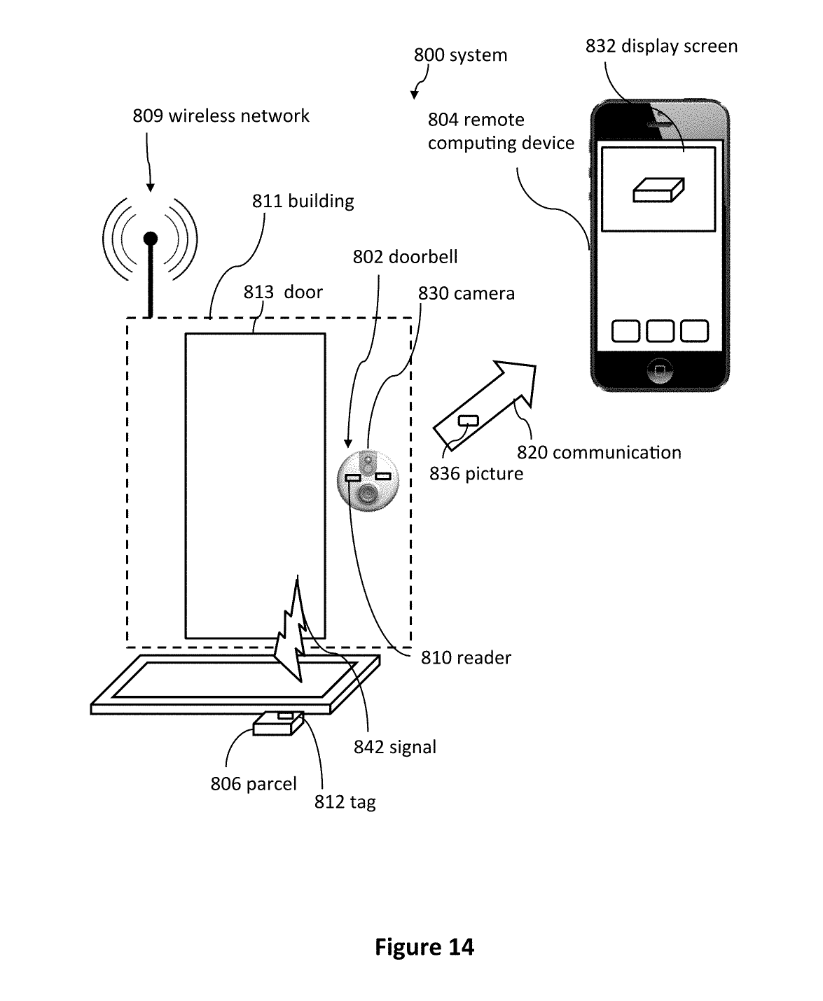

Referring now to FIGS. 13 and 14, the doorbell 802 may also detect when the parcel 806 is moving. It may detect the parcel moving by comparing strengths of two different signals 838, 842 from the radio-frequency identification tag 812 on the parcel 806. For example, the system 800 may further comprise a first signal 838 of the radio-frequency identification tag 812 detected by the doorbell 802 at a first time, a second signal 842 of the radio-frequency identification tag 812 detected by the doorbell 802 at a second time 844, and a second notification 820 sent from the doorbell 802 to the remote computing device 804. The system may determine that the parcel is moving farther from the doorbell 802 or is being removed if the second signal 842 is weaker than the first signal 838. In response to the doorbell 802 detecting the parcel moving farther from the doorbell or a removal of the delivery parcel 806 the doorbell 802 may send a second notification 820 to the remote computing device 804. The doorbell 802 may also take a picture 836 with the camera 830 in response to the doorbell 802 detecting the parcel 806 is moving or is removed. The second notification 820 may comprise the second picture 836 taken by a camera 830 of the doorbell 802. The radio-frequency identification tag 812 may be an active tag. The doorbell 802 may be configured to detect the delivery parcel 806 by the radio-frequency identification reader 810 reading the passive radio-frequency identification tag 812 of the delivery parcel 806. The doorbell 802 may be configured to detect the delivery parcel 806 by the radio-frequency identification reader 810 reading the active radio-frequency identification tag 812 of the delivery parcel 806.

Package theft is a growing problem. One way to combat package theft is to enable a delivery person to place packages inside the home. This approach, however, often depends on providing a key to the delivery person. Some embodiments provide physical keys, but many embodiments provide temporary digital keys that enable the delivery person to unlock a smart lock that secures the door.

Ensuring that only authorized delivery personnel can use digital keys is important. Embodiments provide diverse ways to help appropriate delivery personnel to gain access to homes while precluding, for example, a burglar from using a package to open a lock.

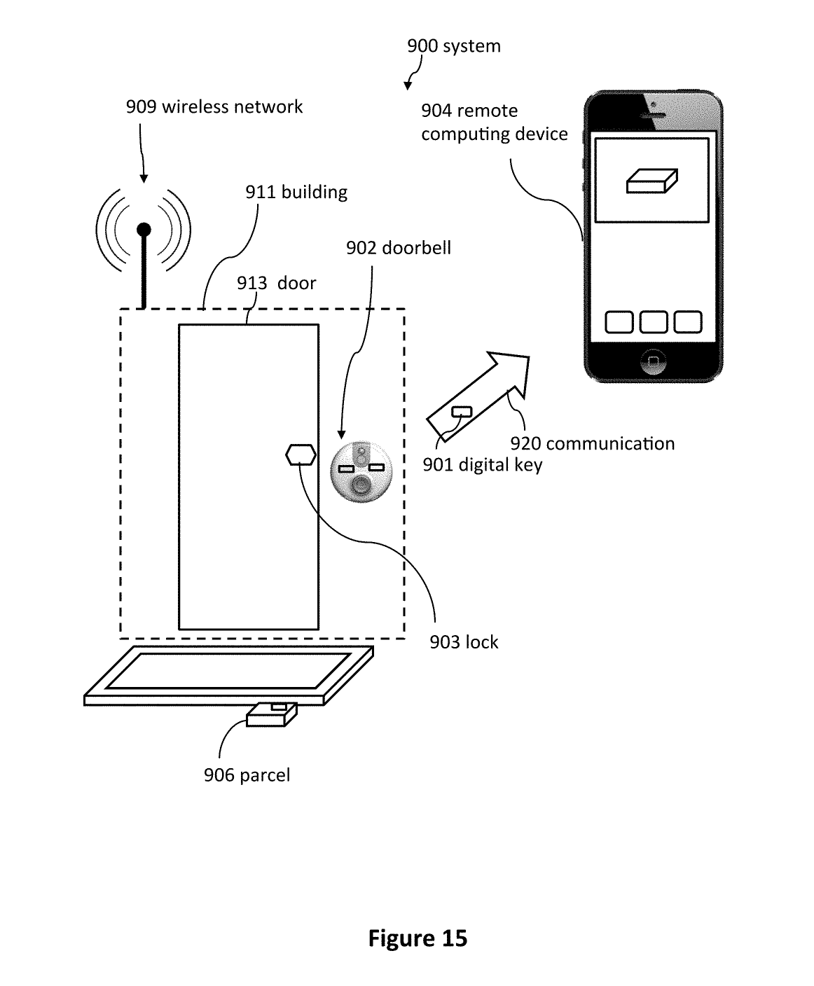

FIG. 15 shows a delivery parcel detection system 900. A delivery person may receive a digital key 901 from a delivery parcel detection system 900, from a smart lock 903, and/or from a doorbell 902. The delivery person may receive the digital key 901 on, for example, the remote computing device 904 of the delivery person. The digital key 901 can be configured to enable unlocking a door 913 of a building 911 to which a delivery parcel 906 is addressed to permit the delivery person to place the delivery parcel 906 inside the building 911 in response to detecting the digital key 901. The building 911 may be one or more of the following: a house, an apartment, a hotel room, a business, an office, a shed, or a closet. The door 913 may include a lock system 903 configured to impede unauthorized entry into the building 911. The system may include a wireless network 909. At least one of a doorbell 902 and the lock system 903 may detect the digital key 901 via a first wireless communication 920 from the remote computing device 904 to at least one of the doorbell 902 and the lock system 903. Enabling the door 913 to be unlocked can include unlocking the door 913 in response to detection of the digital key 901, disengaging the locking mechanism to allow the door 913 to be opened, allowing a lock 903 to be turned by a delivery person prior to opening the door 913, and/or enabling a code or a password to be used to unlock the door 913. The door 913 can be any door of a building. In some embodiments, the door 913 is a front door with side hinges. In several embodiments, the door 913 is a garage door configured to be opened vertically by a garage door opener. In some embodiments, the door 913 is a gate.

Further security measures may be used or designed to, for example, ensure security of the building 911. Some of these security measures may incorporate one or more of the following: timed delivery windows, package identification, delivery vehicle tracking, proximity detectors, delivery person identification, video surveillance, and/or any combination thereof.

The digital key 901 can be sent to a remote computing device 904 such as a smartphone or the package scanning device often used by delivery personnel. The remote computing device 904 can be communicatively coupled to the doorbell 902 and/or lock 903 of the building 911 via a direct wireless communication and/or via indirect wireless communication (e.g., through a cellular network or the cloud).

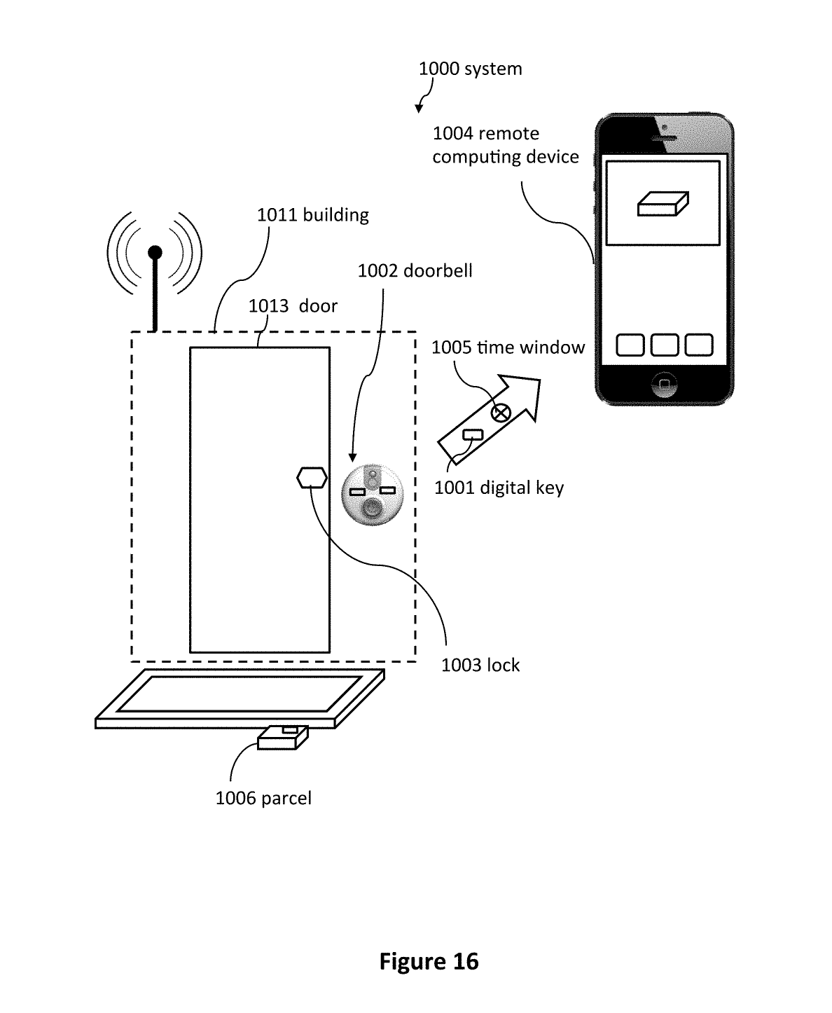

Referring now to FIG. 16, it may not be desirable for a delivery person to have a digital key 1001 that can allow them access to a house or building 1011 at any time. One way to increase security and better control access to the building 1011 or room can include the delivery parcel 1006 having an expected delivery time window 1005. Many delivery services already provide an expected delivery time or expected delivery time window 1005 (e.g., between 10:00 am to 2:00 pm on Wednesday) for when the parcel 1006 will be delivered. There are several ways to control access to the house or building 1011 using the expected delivery time window 1005. For example, the digital key 1001 can be sent to the remote computing device 1004 only once this time window 1005 has arrived, e.g., at 10:00 am on Wednesday in the example above. The digital key 1001 can be configured to enable unlocking the door 1013 during a delivery window 1005. For example, if a delivery parcel 1006 (such as a package or envelope) is scheduled to arrive from 10:00 am to 2:00 pm on Wednesday, the digital key 1001 will only enable unlocking the lock 1003 from 10:00 am to 2:00 pm on Wednesday. The digital key 1001 may also be sent within a predetermined period prior to the expected delivery time window, e.g., the digital key 1001 is sent one hour prior to the expected delivery time window 1005, and then the system 1000 may only enable the digital key 1001 once the expected delivery window 1005 has arrived. Since, packages do not always arrive precisely within their expected delivery window 1005, in some embodiments, the digital key 1001 will also permit unlocking the lock 1003 for a certain amount of time before and after the delivery window. (e.g., ten minutes before the expected delivery window 1005). Enabling the digital key 1001 can include the system recognizing the digital key 1001 or configuring the lock 1003 and/or doorbell 1002 to unlock the door 1013 in response to detecting the digital key 1001. The digital key 1001 may also be disabled in response to a second time being past the expected delivery time window 1005 or a second time being outside of a certain amount of time after the expected delivery window 1005. Disabling the digital key 1001 can include the system 1000 no longer recognizing the digital key 1001 or configuring the lock 1003 and/or doorbell 1002 to not unlock the door 1013 in response to detecting the digital key 1001. By enabling the digital key 1001 only during an expected time window 1005, or for a certain time around an expected time window 1005, and/or disabling it after the expected time window 1005, or a certain time around an expected time window 1005, users can better control access to the building 1011 or home.

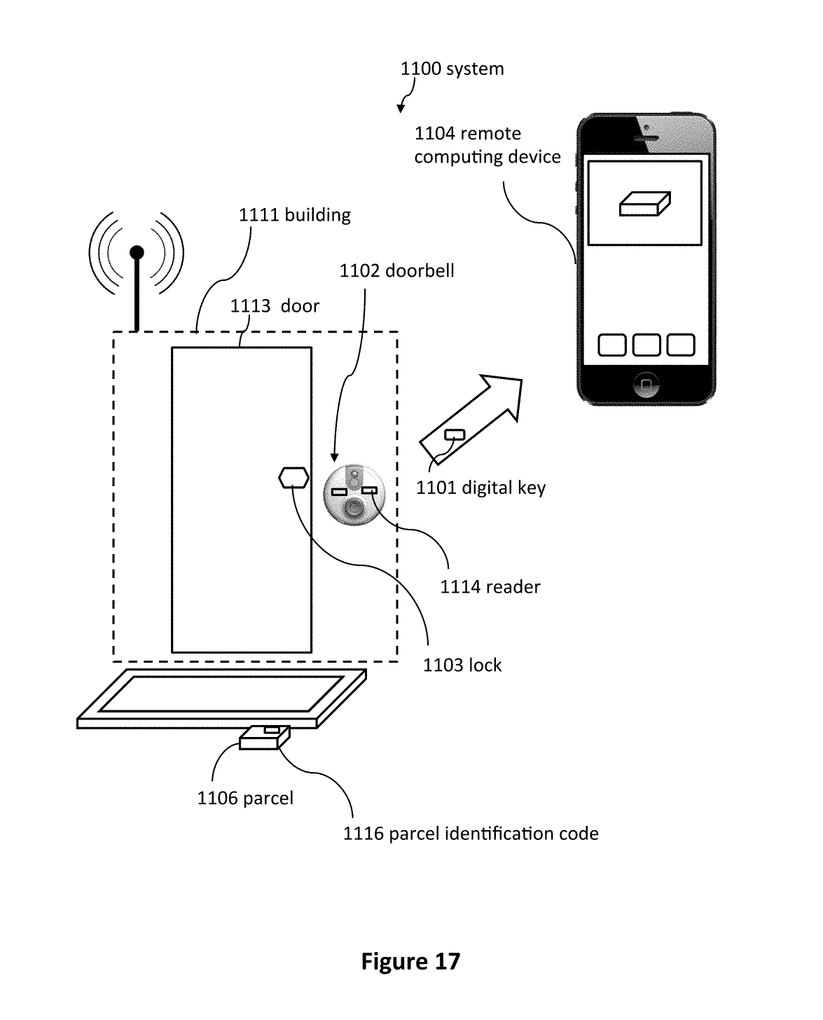

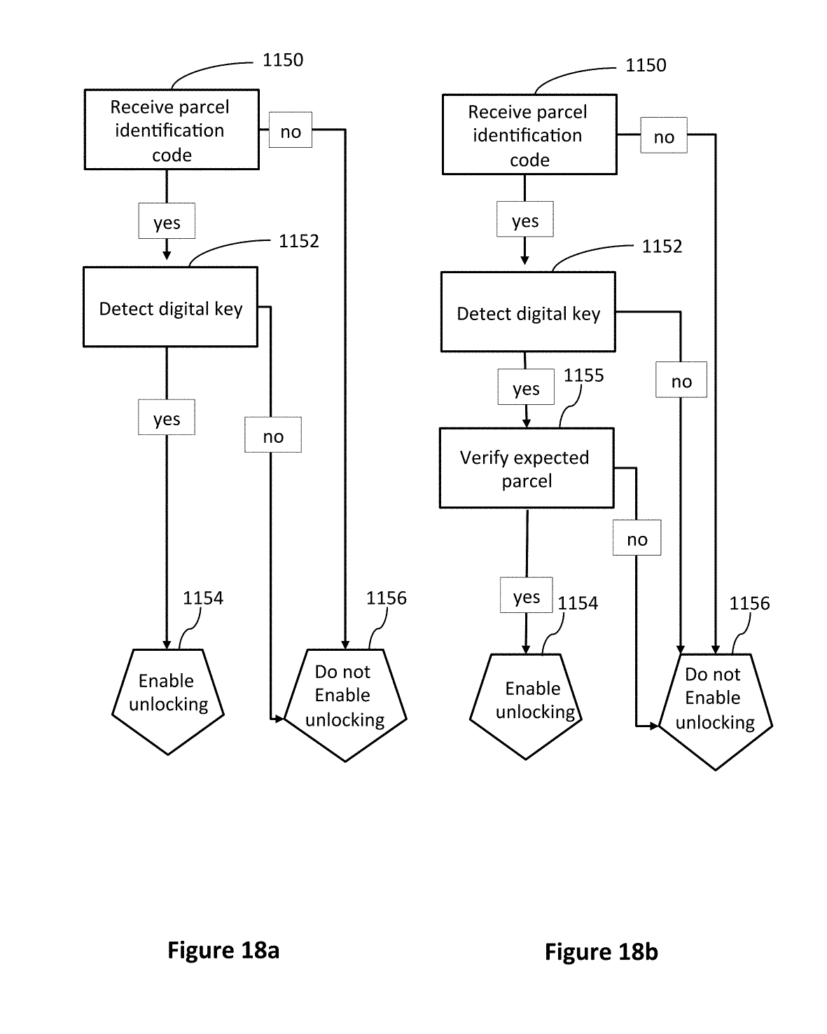

Referring now to FIGS. 17, 18a, and 18b, another way to increase security would be to “tie” the digital key 1101 to the parcel 1106. The digital key can be “tied” to the parcel delivery such that the digital key is not functional unless used in conjunction with the parcel delivery. Tying the parcel 1106 to the digital key 1101 would only allow the digital key 1101 to function when used in conjunction with the parcel delivery. This may be used as another line of security. A person who has the digital key 1101 but not the parcel 1106 cannot gain access to the building 1111 and likewise, someone who has the parcel 1106 but not the digital key 1101 cannot gain access.

One way to tie the parcel 1106 to the digital key 1101 is with the use of a parcel identification code 1116. The doorbell 1102 and/or the lock system 1103 can receive 1150 a delivery parcel identification code 1116 of the delivery parcel 1106. The doorbell 1102 or lock system 1103 may receive 1150 the delivery parcel identification code of the delivery parcel 1106 by detecting it (e.g., when the delivery parcel 1106 or remote computing device 1104 is within direct wireless communication with the lock system 1103 or doorbell 1102), it may be received when the delivery person manually enters or scans a code, or in some other way. The delivery parcel identification code 1116 may be a radio-frequency identification (“RFID”) tag, a barcode, or another type of identification code. The delivery parcel identification code 1116 can be scanned by the delivery person, using his remote computing device 1104 or another scanner, or may be scanned by the lock 1103 and/or doorbell 1102 either wirelessly or via a reader 1114. The doorbell 1102 and/or the lock system 1103 can also detect 1152 a digital key 1101. In response to both detecting 1152 the digital key 1101 and receiving 1150 the delivery parcel identification code 1116 the system can enable unlocking 1154 of the door 1113. The system does not enable unlocking 1156 of the door 1113 if it does not detect 1152 the digital key 1101 or does not receive 1150 the parcel identification code 1116. In order to ensure that the delivery parcel identification code 1116 is associated with a parcel 1106 which is expected by the user, the system 1100 can verify 1155 any number of features of the parcel 1106 prior to enabling 1154 the lock 1003 to be disengaged, as shown in FIG. 18b. For example, the system 1100 can verify that the delivery parcel identification code 1116 corresponds to an expected delivery time window. The system 1100 can verify that the delivery parcel identification code 1116 corresponds to an expected delivery item (e.g., something the user has ordered and that is expected to be delivered). If the parcel 1106 does not correspond to an expected parcel 1106, the system does not enable 1156 unlocking of the door 1113.

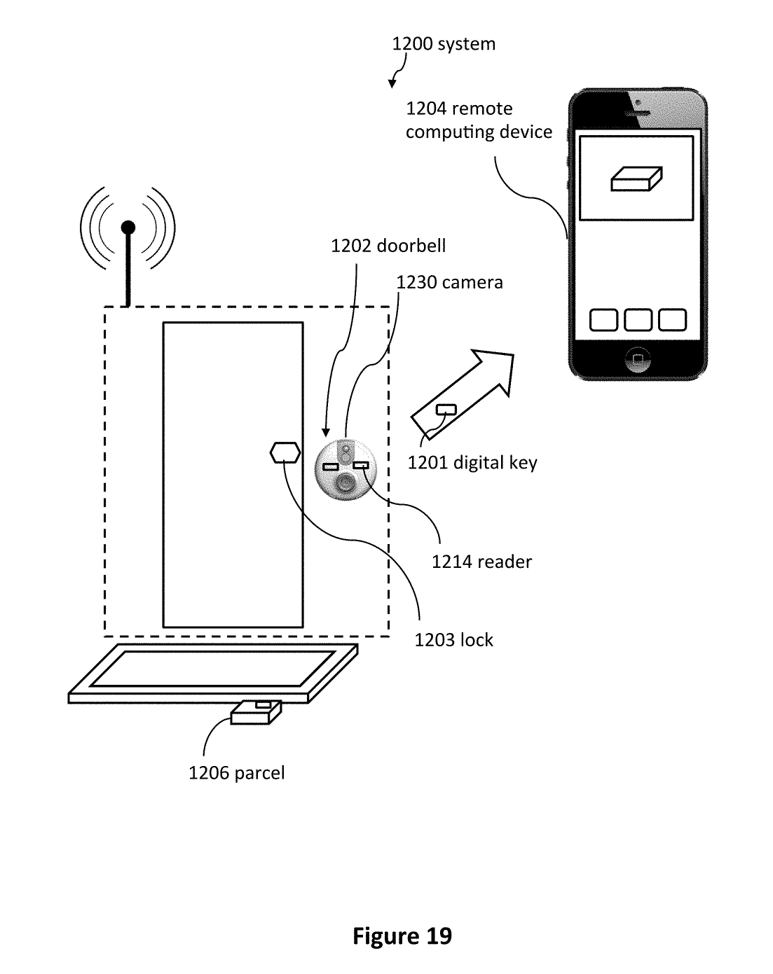

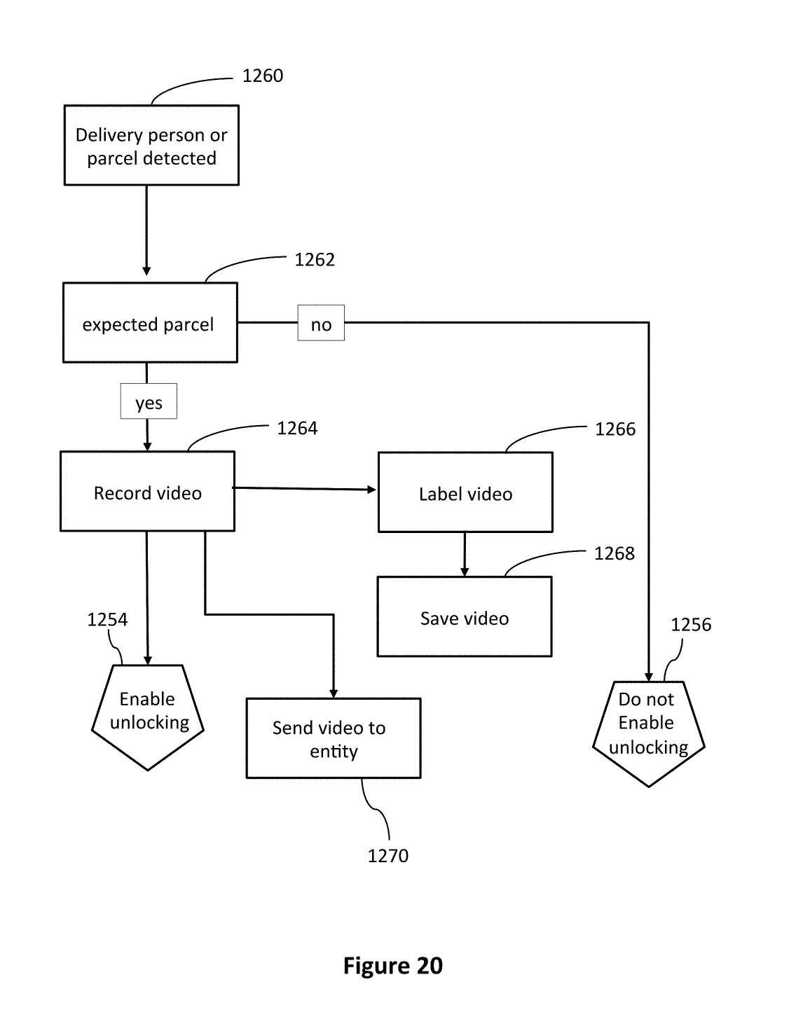

Referring now to FIGS. 19 and 20, the doorbell 1202 can include a camera 1230. The camera 1230 could allow the doorbell 1202 to be configured to automatically record video upon detection of a delivery person (e.g., a UPS, FedEx, or USPS delivery person). The system 1200 can be configured to know that the package delivery is authorized, can record a video of the delivery and/or of the parcel 1206, and/or can save the video as a delivery recording.

Retailers and delivery services may want to know that a parcel 1206 has been correctly delivered. The video can be sent to an entity associated with the delivery (e.g., to show Amazon that their parcel 1206 was delivered to the delivery address). This video can be used to resolve disputes regarding whether the parcel 1206 was actually delivered to preclude customers from receiving a parcel 1206, claiming they did not receive the parcel 1206, and then receiving a refund.

The system 1200 can include the ability to use visual analysis to detect the shape (e.g., rectangle, square, circle, etc.) of a parcel 1206 and notify the user that her parcel 1206 has arrived. Shape recognition may be used to verify the parcel 1206 is an expected delivery item prior to sending the digital key 1201 or prior to enabling the lock 1203 to be disengaged. The notification can specify whether the parcel 1206 is outside on the ground or is in their possession (e.g., inside the home).

The doorbell 1202 records a video 1264 in response to detecting 1260 the delivery person and/or in response to determining 1262 that the delivery parcel 1206 is an expected delivery item. The system may enable the unlocking 1254 of the door in response to determining the parcel 1206 is an expected parcel and does not enable the unlocking 1256 of the door in response to determining the parcel 1206 is not an expected delivery parcel. A parcel 1206 may be an envelope, a box, a padded envelope, a bag, and/or container. Several methods may be used to determine that the delivery parcel 1206 is an expected delivery item including RFID tag scanning, bar code scanning by the camera 1230, reader 1214, or remote computing device 1204, shape recognition, label identification, etc. The video can then be saved 1268 to a phone, computer, the cloud, other online storage, or within the doorbell system itself and labeled 1266 as a delivery. A doorbell 1202 can record many videos during the day, labeling 1266 the video indicates to a doorbell user that the video shows the delivery of at least one item. A user may have many videos on their phone, computer, or the cloud, and a label may be useful in identifying a video that contains data relating to a parcel 1206 thus allowing the user to more easily find the appropriate video.

When a video is recorded 1264 by the doorbell, several methods may be used to determine that the video shows a delivery. Once it is determined the video shows a delivery, then the video may be labeled to indicate that the video shows a delivery. The labeling can indicate to a doorbell user that the video shows the delivery of at least one item. Videos may then be sent to an entity 1270 associated with sending the delivery parcel. For example, if the delivery parcel is from Amazon, the entity can be Amazon, a third party that organizes the sending the delivery parcel, or the delivery service provider such as UPS, FedEx, or USPS, or any combination of those.

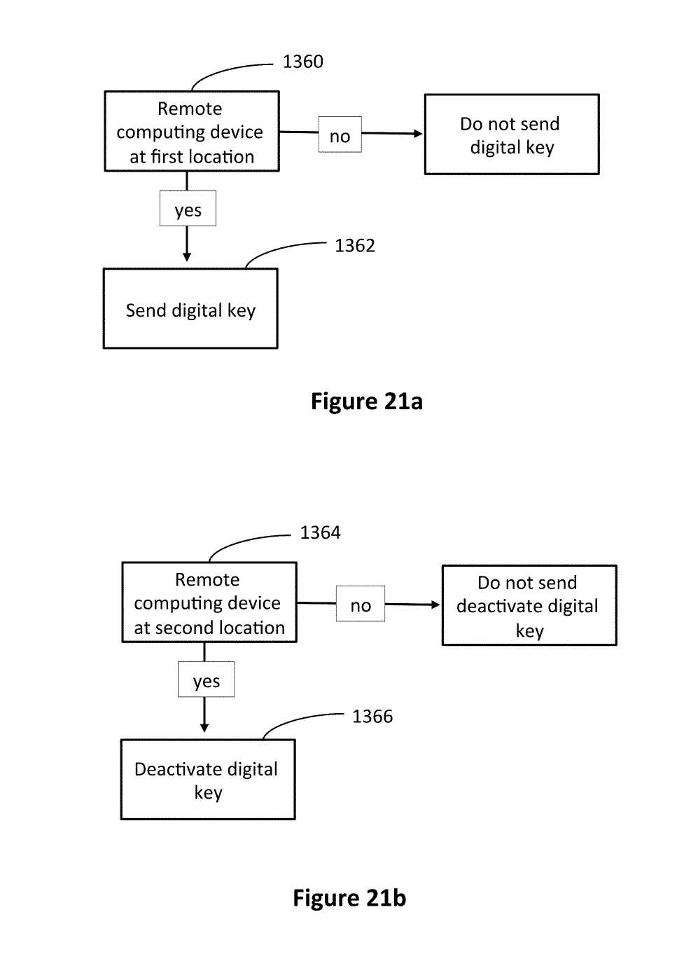

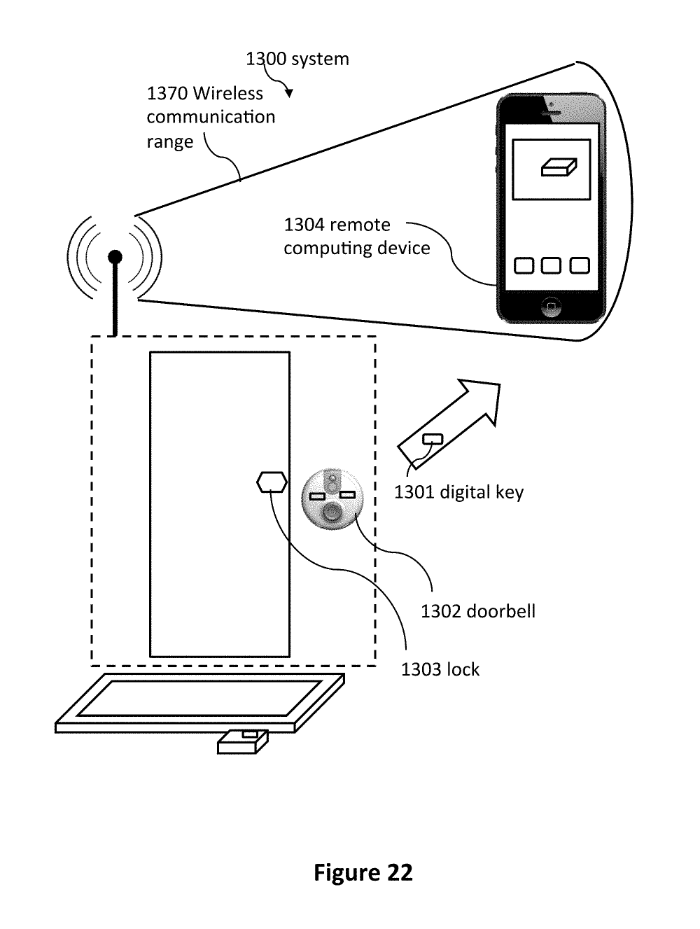

Referring now to FIGS. 21a, 21b, and 22, a digital key 1301 can be a code that the delivery person enters, or it can be transmitted from the remote computing device 1304 to the lock 1303 or doorbell 1302 without the delivery person ever seeing the actual “key”. In order to limit the time that the digital key 1301 is active and therefore the time that the delivery person has access to a house or other building, the digital key 1301 may be sent to the delivery person or the remote computing device 1304 only when they are within a certain distance of the building or when they are at a certain location. The system 1300 detects 1360 when the remote computing device 1304 is at a first location and in response to detecting 1360 that the remote computing device 1304 is at this location, sends 1362 the digital key 1301 to the remote computing device 1304. The first location can be the delivery warehouse, the scheduled stop before the delivery of the user's package, the house or building of the user, or a specific distance away from the house or building of the user (e.g., within one mile of the lock system or the doorbell or within one mile of the lock system or doorbell, etc.). Several methods may be used to determine the location of the remote computing device 1304, including GPS tracking, or tracking over a cellular network. The digital key 1301 may also be delivered to the remote computing device 1304 in response to the remote computing device 1304 being within a direct wireless communication range 1370 of the doorbell 1302 or lock system 1303. Direct wireless communication range 1370 may be the range of WiFi associated with the doorbell 1302 and/or lock 1303, the range of Bluetooth associated with the lock 1303 and/or doorbell 1302, the range of an RFID reader associated with the lock 1303 and/or doorbell 1302, or the range of another wireless communication system associated with the lock 1303 and/or doorbell 1302. Likewise, the digital key 1301 may be sent to the remote computing device 1304 at any time prior to delivery and then only activated once the remote computing device 1304 has been detected at the first location. It may also be desirable to deactivate 1366 the digital key 1301 when the remote computing device 1304 is detected 1364 at a second location. For example, the digital key 1301 may be deactivated 1366 when the remote computing device 1304 is detected at the next scheduled delivery stop, when the remote computing device 1304 is detected to be outside of a certain distance of the house or building, or when the remote computing device 1304 is no longer in a direct wireless communication range 1370 of the doorbell 1302 and/or lock 1303.

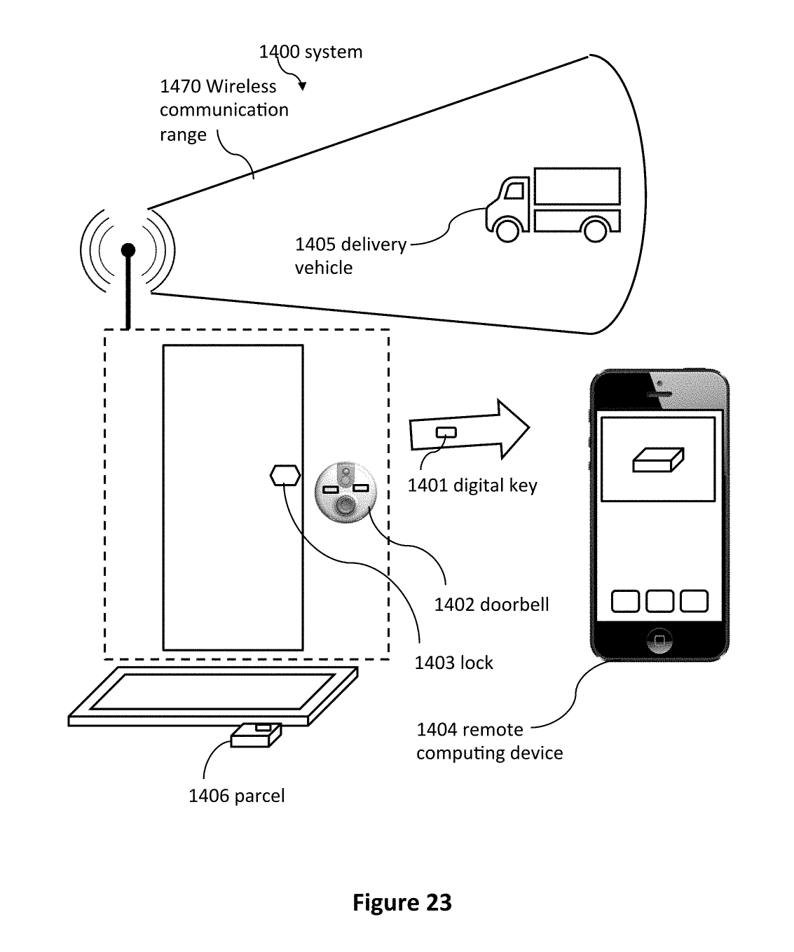

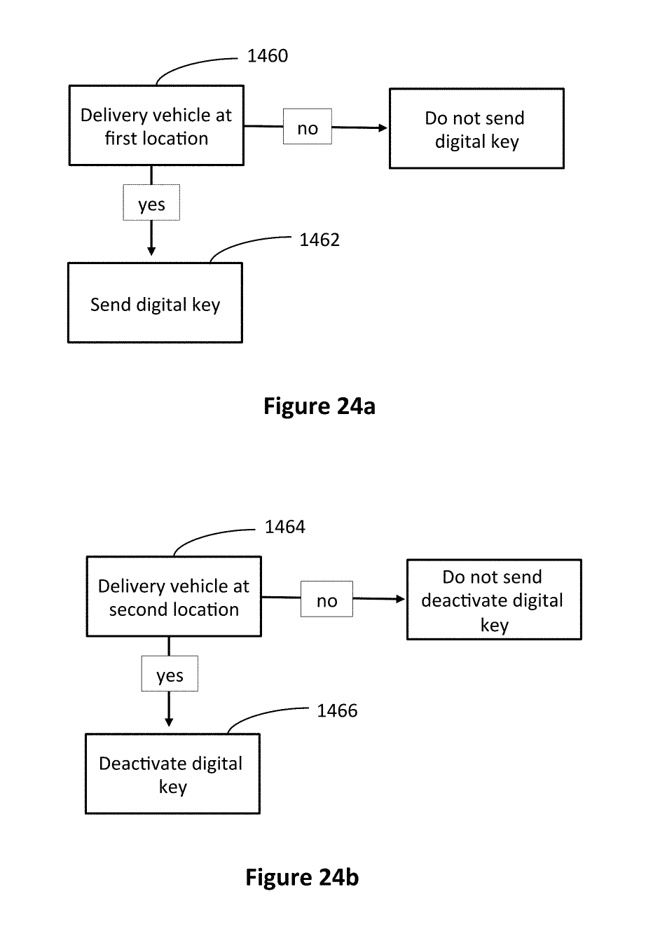

Some types of remote computing devices are small and can be stolen or given to another person. Referring now to FIGS. 23, 24a, and 24b, tracking the location of the delivery vehicle 1405 may be a more secure way to ensure that only the person delivering the parcel 1406 has access to the house or building. The digital key 1401 may be sent 1462 to the remote computing device 1404 in response to the lock system 1403 or doorbell 1402 detecting a first location 1460 of a delivery vehicle 1405. The system 1400 detects 1460 when the delivery vehicle 1405 is at a first location and in response to detecting 1460 that the delivery vehicle 1405 is at this location, sends 1462 the digital key 1401 to the remote computing device 1404. The first location can be the delivery warehouse, the scheduled stop before the delivery of the user's package, the house or building of the user, or a specific distance away from the house or building of the user (e.g., within one mile of the lock system or the doorbell or within one mile of the lock system or doorbell, etc.). The location of a delivery vehicle 1405 can be detected using a GPS attached to the delivery vehicle 1405 or another locator connected to the delivery vehicle 1405. The delivery vehicle can be configured to transport the remote computing device 1404 and the delivery parcel 1406. Methods may include sending the digital key 1401 to the remote computing device 1404 in response to the first location being within a direct wireless communication range 1470 of at least one of the doorbell 1402 and the lock system 1403. Direct wireless communication range 1470 may be the range of WiFi associated with the doorbell 1402 and/or lock 1403, the range of Bluetooth associated with the lock 1403 and/or doorbell 1402, the range of an RFID reader associated with the lock 1403 and/or doorbell 1402, or the range of another wireless communication system associated with the lock 1403 and/or doorbell 1402. Likewise, the digital key 1401 may be sent to the remote computing device 1404 at any time prior to delivery and then only activated once the delivery vehicle 1405 has been detected at the first location. It may also be desirable to deactivate 1466 the digital key 1401 when the delivery vehicle 1405 is detected at a second location 1464. For example, the digital key 1401 may be deactivated 1466 when the delivery vehicle 1405 is detected at the next scheduled delivery stop, when the delivery vehicle 1405 is detected to be outside of a certain distance of the house or building, or when the delivery vehicle 1405 is no longer in a direct wireless communication range 1470 of the doorbell 1402 and/or lock system 1403.

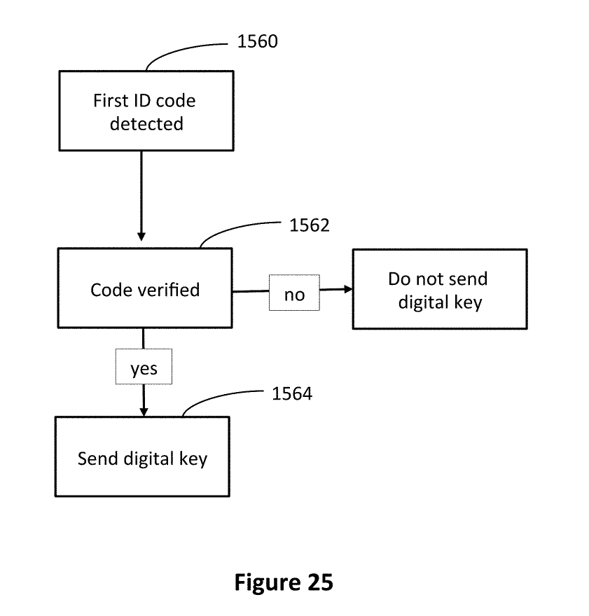

Referring now to FIG. 25, the system detects a first identification code 1560 from the remote computing device. Then the system verifies 1562 that the first identification code is indicative of the remote computing device being authorized for deliveries. The system may then send the digital key 1564 to the remote computing device in response to detecting the first identification code 1560 and in response to verifying the first identification code 1562. The identification code may be a digital identification code sent wirelessly or may be a physical identification code (e.g., a badge or a bar code). Verifying the first identification code 1562 may include checking the code against a database of valid codes stored in the lock and/or doorbell, or stored remotely. For example, in the cloud or on a server to see if the code is valid. The first identification code may be detected by at least one of the doorbell and the lock system.

The door can be a garage door that is configured to open in response to detecting an authorized delivery parcel. A garage door opener can be configured to receive a wireless communication configured to cause the garage door opener to open the garage at least part way in response to the system (which can be any system described herein and/or incorporated by reference) determining that the delivery parcel is an expected and/or authorized delivery parcel. The system can determine that the delivery parcel is expected and/or authorized by analyzing an identification code of the delivery parcel.

A garage door opening system can comprise a parcel identification detection system, which can comprise a camera, scanner, and/or RFID receiver configured to detect a delivery parcel identification code of a delivery parcel. The garage door opening system can comprise a garage door opener configured to open a garage door; and a first computer system configured to receive the delivery parcel identification code detected by the parcel identification detection system, compare the delivery parcel identification code to a first database comprising at least one expected delivery identification code, and send a first communication to the garage door opener in response to determining that the delivery parcel identification code is indicative of the delivery parcel being an expected delivery. The garage door opener can be configured to open the garage door at least partially in response to the first communication. The first computer system can be communicatively coupled to the parcel detection system and the garage door opener. The parcel identification detection system can be coupled to a building that comprises the garage door. A doorbell system can comprise the parcel identification detection system.

In some embodiments, a doorbell detects a delivery parcel identification code (e.g., by scanning a barcode of a shipping label or by receiving the delivery parcel identification code via a wireless communication). The system can check with a database (which can be located in the doorbell's memory or can be located remotely relative to the doorbell) to verify that the delivery parcel is supposed to be delivered to the address of the doorbell. Once the system verifies the delivery parcel, the system can send a command (which can be wireless) to a lock system to enable a delivery person to unlock the door of the building to enable the delivery person to put the delivery parcel inside the building. Placing the delivery parcel inside the building can dramatically reduce delivery parcel theft.

In several embodiments, the system records a video of the delivery. The system can send this video to the doorbell owner and/or to an occupant of the building. The system can also send this video to the “sender” of the delivery parcel. The sender can use the video as proof that the package was delivered.

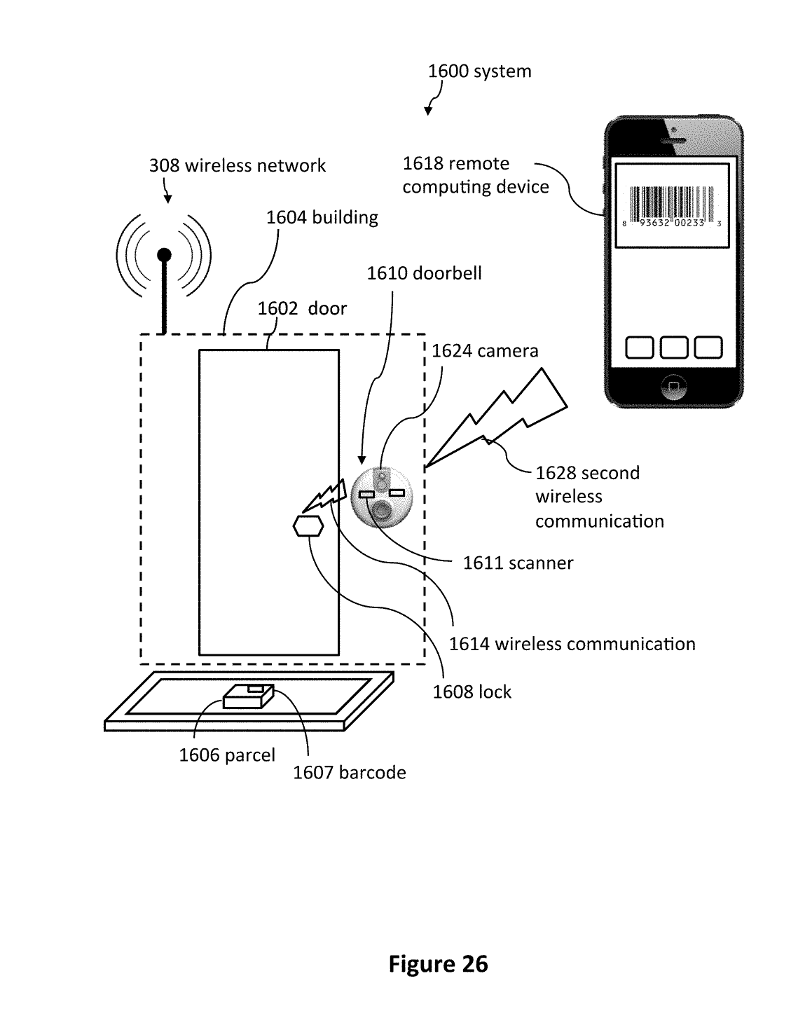

Referring now to FIG. 26, a delivery parcel detection system 1600 can be configured to enable a door 1602 of a building 1604 to which a delivery parcel 1606 is addressed to be unlocked. Enabling the door 1602 to be unlocked may include sending a message to the lock system. The door can include a lock system 1608 which may be configured to impede unauthorized entry into the building 1604. When a doorbell system 1610 receives a delivery parcel identification code 1612 of the delivery parcel 1606, the doorbell system 1610 can send a first wireless communication 1614 to the lock system 1608 (e.g., in response to receiving the delivery parcel identification code 1612, the doorbell system 1610 sends a first wireless communication 1612 to the lock system 1608). The system can enable unlocking the door in response to receiving the first wireless communication.

The first wireless communication 1614 may enable unlocking the door 1602 such that the delivery parcel detection system 1600 is configured to enable a delivery person to place the delivery parcel 1606 inside the building 1604.

To ensure security, the system may enable unlocking of the door 1602 in response to the doorbell system 1610 and/or the lock system 1608 verifying the delivery parcel 1606. The system may enable unlocking of the door 1602 in response to the doorbell system 1610 and/or the lock system 1608 verifying that the delivery parcel identification code 1612 corresponds to an expected delivery item (e.g., something the user has ordered). Verifying that the parcel identification code 1612 corresponds to an expected delivery item may include the parcel identification code 1612 being compared to a database to ensure it is the correct parcel, or checking it in another way. Several attributes may be used to verify the parcel 1606 is the expected delivery item before enabling the door 1602 to be unlocked. The system may enable unlocking of the door 1602 in response to the doorbell system 1610 and/or the lock system 1608 verifying that the delivery parcel identification code corresponds to an expected delivery time. Many delivery services already provide an expected delivery time or expected delivery time window (e.g., between 10:00 am to 2:00 pm on Wednesday) for when the parcel 1606 will be delivered. Verifying the delivery parcel identification code corresponds to an expected delivery time would prevent entry to the building 1604 outside of the expected delivery time window and may keep out unauthorized users and ensure that the user of the doorbell is not disturbed unexpectedly. The system may enable unlocking of the door 1602 in response to the doorbell system 1610 and/or the lock system 1608 verifying that the delivery parcel identification code corresponds to the address of the building where the parcel 1606 is being delivered.

The doorbell system 1610 may receive the delivery parcel identification code 1612 of the delivery parcel 1606 in several ways. For example, the doorbell system 1610 may scan a delivery parcel 1606 (e.g., scanning a barcode on the delivery parcel via a scanner 1611), the doorbell system 1610 may detect a RFID tag, may receive the delivery parcel identification code 1612 wirelessly, or the delivery parcel identification code 1612 may be input manually (e.g., on a pin pad). Receiving the delivery parcel identification code can include scanning, by the doorbell system 1610, a barcode 1607 of the delivery parcel 1606. The doorbell system 1610 can include a barcode scanner 1611. The barcode scanner 1611 can have a light source and a light sensor. The barcode scanner 1611 can be used to receive the delivery parcel identification code.

The doorbell system 1610 may include a camera 1624. The camera 1624 may be used to receive the delivery parcel identification code. Receiving the delivery parcel identification code can include the camera 1624 taking a picture of the barcode 1607 and analyzing the picture to identify the delivery parcel identification code.

In some embodiments, receiving the delivery parcel identification code comprises using the doorbell 1610 to scan a barcode 1607 of a shipping label. The barcode 1607 can represent a number (e.g., 8-93632-00256-2). A database can include the number such that the system can use to look up the number in a database to find additional information regarding the parcel 1606 such as the intended delivery address, the name of the person who should receive the delivery, an expected delivery time window, and a description of the contents of the package.

A barcode 1607 can be an optical, machine-readable, representation of data. Barcodes 1607 can be in many formats including QR codes. Barcodes 1607 can be linear barcodes, matrix barcodes, or any other suitable type of barcode.

The delivery parcel identification code may also be received via a second wireless communication 1628 from a computing device 1618 configured to scan packages. This computing device can be a smartphone that has a camera that takes a picture to “scan” a barcode on the delivery parcel. This computer can also be one of the handheld package scanners often used by FedEx Corporation (“FedEx”) and United Parcel Service of America, Inc. (“UPS”). Example package scanners include a delivery information acquisition device (“DIAD”) made by Honeywell International Inc. (“Honeywell”), a mobile delivery device (“MDD”) made by Honeywell, and a FedEx Power Pad made by FedEx Corporation. The delivery person can use the handheld package scanner to “scan” the package to detect the delivery parcel identification code. Then, the handheld package scanner can send the delivery parcel identification code to the doorbell system via a wireless communication, which can be a direct wireless communication (e.g., via Bluetooth or any other suitable radio communication).

Visual analysis may also be used by the doorbell system 1610 to detect a shape of the delivery parcel 1606. The system can then notify a user of the doorbell 1610 that the delivery parcel 1606 has arrived in response to detecting the shape. Visual analysis can include machine vision or computer vision to use the camera of the doorbell to take a picture of the delivery parcel and then analyze the shape in the picture to determine if a delivery parcel is present. For example, the system can use machine vision to differentiate between a cat on a porch and a parcel 1606 on a porch. This approach can reduce misleading package notifications that are bothersome to users.

The system can be configured to notify a user whether the parcel 1606 is located inside the home or outside the home (e.g., on the ground).

The door can be a front door, a garage door that opens vertically, a shed door, or an office door. Unlocking the garage door can comprise opening the garage door part of the way or all the way. The amount the garage door opens can be determined by at least one dimension (e.g., the smallest dimension of the package. This approach enables opening the garage door just enough to slide the package under the garage door (while hopefully discouraging the delivery person from sliding under the garage door).

In some embodiments, the delivery parcel detection system is configured to only unlock the door if the package was ordered by the occupant at the address to which the package is addressed. For example, if a delivery person tries to unlock a door at the wrong address, in several embodiments, the system would preclude the delivery person from unlocking the door. This approach can reduce the number of incorrect deliveries and can increase home security.

A database can be located remotely relative to the building, the doorbell system, and/or the lock system. The database can also be part of the building, the doorbell system, and/or the lock system. The database can include data regarding deliveries that are scheduled to be sent to an address of the building and/or were ordered (e.g., by an occupant) to the building.

Methods can comprise analyzing the database to determine whether the delivery parcel identification code represents a delivery parcel that should be delivered to the address. For example, the delivery parcel identification code can be a code such as a barcode number. The system can look up the barcode number in the database's portion for the address of the building. If the barcode number is located in the database's portion for the address, then the system can decide that the delivery parcel should be permitted entry into the building (e.g., by unlocking the door and/or enabling the door to be unlocked).

Several embodiments comprise analyzing the database which includes data regarding deliveries to be sent to an address of the building, and then unlocking the door in response to verifying that the delivery parcel identification code is indicative of the delivery parcel being associated with the address of the building.

The database can include information regarding delivery parcels for a particular address such as contents of the delivery parcels and the estimated delivery windows. Each delivery parcel can have a delivery parcel identification code listed in the database. For example, a delivery parcel identification code of “4713” can be associated with an address of 404 Castleview Place, Nike tennis shoes, and an estimated delivery window of Tuesday from 9:00 to noon.

The delivery parcel detection system can receive a delivery parcel identification code (e.g., by scanning a barcode of the delivery parcel or by receiving the delivery parcel identification code from a wireless communication from a remote computing device such as a FedEx portable package scanner that scanned the barcode of the delivery parcel). The system can then search a portion of the database associated with the address to which the delivery person has delivered the delivery parcel to see if the delivery parcel identification code is present. If the delivery parcel identification code is not present in that portion of the database, the system can refuse to unlock the door and/or can emit an alert (e.g., an audible alert, a text message, a push notification to a smartphone, a flashing light, a notification on a display screen). The system can verify that the delivery parcel identification code is indicative of the delivery parcel being associated with the address of the building by determining the delivery parcel identification code is present in the portion of the database for the particular address to which the package was delivered.

The doorbell system 1610 and/or the lock system 1608 may analyze a database comprising data regarding deliveries to be sent to an address of the building to verify the address. Then, in response to verifying the address, the doorbell can send the first wireless communication. The first wireless communication can enable the door to be unlocked. The doorbell system 1610 and/or the lock system 1608 may analyze a database comprising data regarding deliveries to be sent to an address of the building, and then, in response to verifying that the delivery parcel identification code is indicative of the delivery parcel associated with the address of the building, unlock the door. The doorbell system may include a database having data regarding deliveries to be sent to an address of the building. The doorbell system 1610 and/or the lock system 1608 may analyze the database and then unlock the door in response to verifying that the delivery parcel identification code is indicative of the delivery parcel being associated with the address of the building. The database may be within the doorbell system, the lock system, or stored in a remote location (e.g., a server or the cloud).

The system may enable unlocking of the door 1602 in response to the doorbell system 1610 and/or the lock system 1608 verifying the identity of the delivery person. Verifying the identity of the delivery person may include any of the following: the doorbell detecting an RFID in the name badge of the delivery person; the doorbell receiving an identification indication from the smartphone; package scanner, or remote computing device of the delivery person; the system detecting a location of the delivery vehicle of the delivery person (e.g., via GPS or another location device connected to the vehicle, or a device connected to the vehicle that sends out a signal), etc. Any of these verification methods may be used alone or in combination to provide further verification. Enabling the door to be unlocked can include unlocking a knob that is mechanically coupled to the deadbolt such that turning the knob unlocks the door. Enabling the door to be unlocked can include allowing a delivery person to unlock the lock by removing a mechanical, magnetic, or other impediment. Enabling the door to be unlocked can include allowing a handle to engage a lock that could not be engaged previously (e.g., the handle can spin freely until enabled, once it is enabled, the handle can engage the lock).

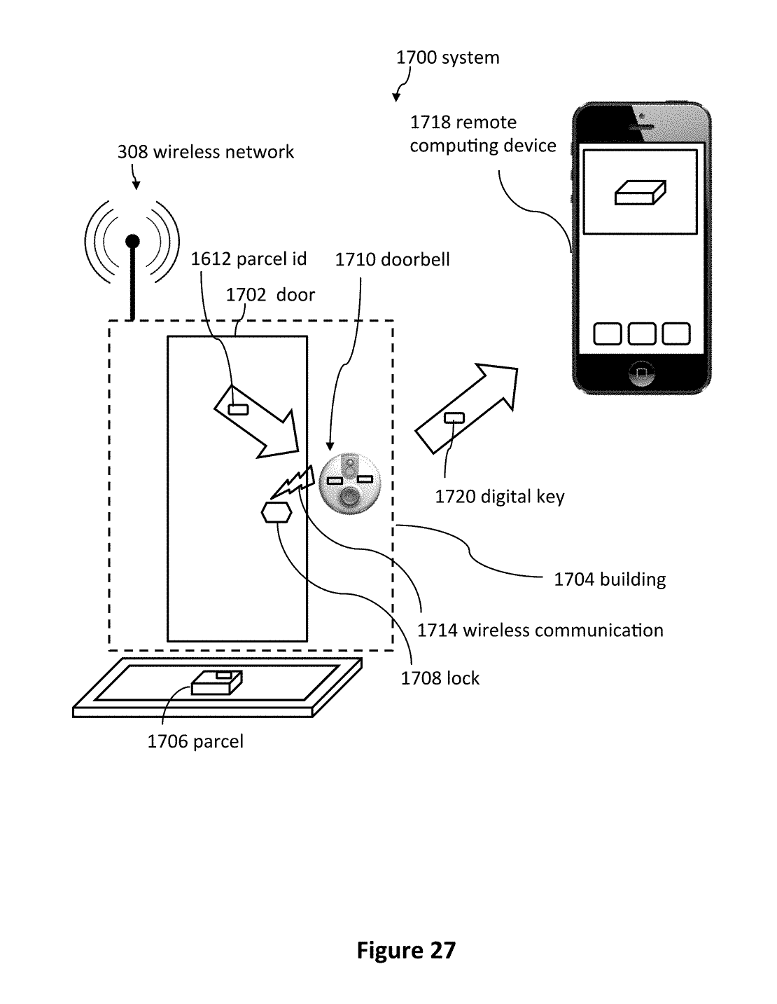

Referring now to FIG. 27, a delivery parcel detection system 1700 can be configured to enable a door 1702 of a building 1704 to which a delivery parcel 1706 is addressed to be unlocked. The door can include a lock system 1708 which may be configured to impede unauthorized entry into the building 1704. When a doorbell system 1710 receives a delivery parcel identification code of the delivery parcel 1706, the doorbell system 1710 can send a first wireless communication 1714 to the lock system 1708 (e.g., in response to receiving the delivery parcel identification code, the doorbell system 1710 sends a first wireless communication 1714 to the lock system 1708). The system can enable unlocking the door 1702 in response to receiving the first wireless communication 1714. The doorbell system 1710 and/or lock system 1708 may send a digital key 1720 to a remote computing device 1718 of the delivery person in response to receiving, by the doorbell system 1710, the delivery parcel identification code. The digital key 1720 may allow unlocking the door.

In some embodiments, the system actually unlocks the door. In other embodiments, the system enables a person to physically unlock the door, but the system does not actually unlock the door. For example, the door can include a deadbolt and a knob configured such that turning the knob unlocks the door. A locking mechanism can engage the knob such that turning the knob is not possible (due to interference of the locking mechanism) until the system disengages the locking mechanism. Once the locking mechanism is disengaged, the deadbolt can still be positioned such that door is locked, but the delivery person can move the knob to unlock the door. In some embodiments, the locking mechanism comprises an electromagnet configured to impede turning the knob (until the electromagnet is turned “off”).

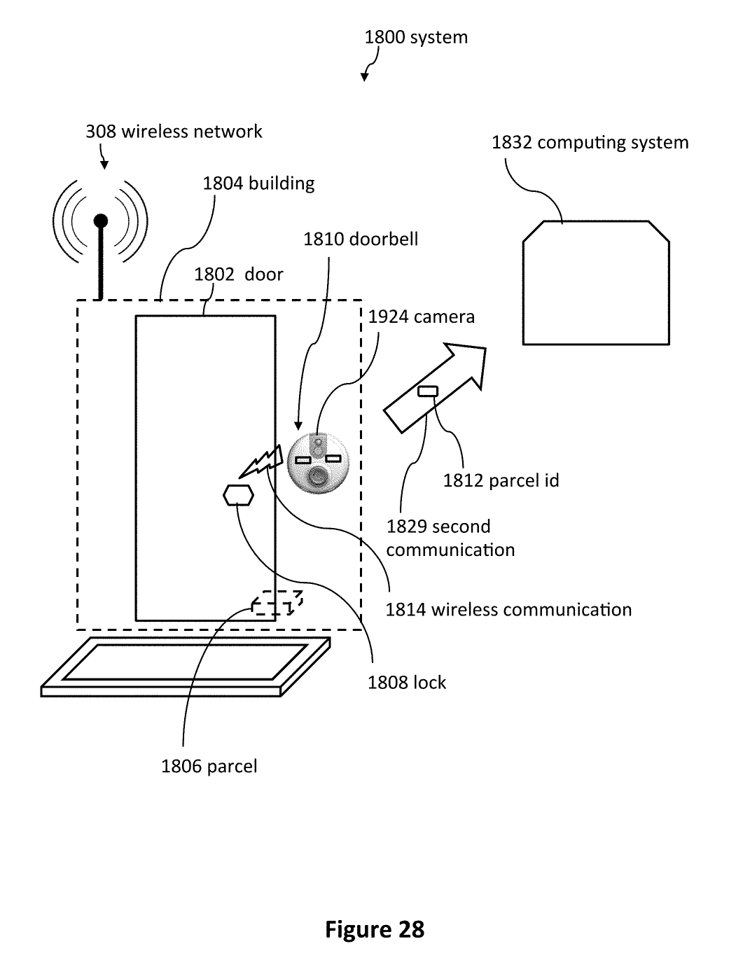

Referring now to FIG. 28, a delivery parcel detection system 1800 can be configured to enable a door 1802 of a building 1804 to which a delivery parcel 1806 is addressed to be unlocked. Enabling the door 1802 to be unlocked may include sending a message to the lock system. The door can include a lock system 1808 which may be configured to impede unauthorized entry into the building 1804. When a doorbell system 1810 receives a delivery parcel identification code of the delivery parcel 1806, the doorbell system 1810 can send a first wireless communication 1814 to the lock system 1808 (e.g., in response to receiving the delivery parcel identification code, the doorbell system 1810 sends a first wireless communication 1812 to the lock system 1808). The system can enable unlocking the door in response to receiving the first wireless communication.

A second communication 1829 may be sent having the delivery parcel identification code to a computing system 1832. The computing system 1832 can then determine that the delivery parcel identification code 1812 is associated with an address of the building 1804. A computing system 1832 may be contained within the doorbell system 1810 (e.g., the doorbell system 1810 may comprise the computing system 1832), may be part of the lock system 1808 (e.g., the lock system 1808 may comprise the computing system 1832), or could be a remote computing system. In response to determining that the delivery parcel identification code 1812 is associated with the address, the system can enable the delivery person to unlock the door 1802 or can unlock the door 1802.

A second wireless communication may be sent to a remote computing system. The remote computing system can be the cloud, a remote server, or another remote computing system. The second wireless communication can have the delivery parcel identification code 1812. The remote computing system can then determine that the delivery parcel identification code 1812 is associated with an address of the building 1804. Then, in response to determining that the delivery parcel identification code 1812 is associated with the address, the door 1802 may be unlocked. The second communication 1829 may be the second wireless communication.

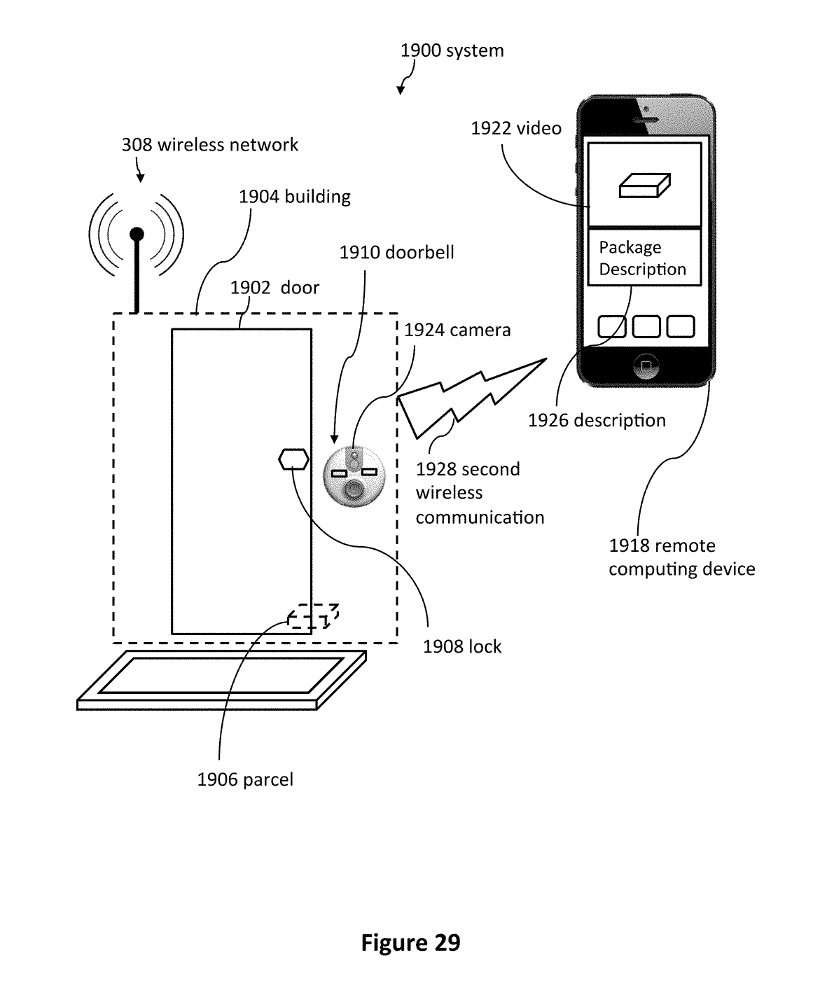

Referring now to FIG. 29, retailers and delivery services may want to know that a parcel 1906 has been correctly delivered. The doorbell system 1910 can include a camera 1924. The camera 1924 could allow the doorbell system 1910 to be configured to automatically record video upon detection of a delivery person (e.g., a UPS, FedEx, or USPS delivery person). The video may be recorded by the camera 1924 of the doorbell system 1910 in response to unlocking the door 1902, in response to the doorbell system 1910 or lock system 1908 enabling the unlocking of the door 1902, in response to receiving the delivery parcel identification code, in response to detecting the delivery person, and/or in response to determining that the delivery parcel 1906 is an expected delivery item.

The system 1900 can be configured to know that the package delivery is authorized, can record a video of the delivery and/or of the parcel 1906, and/or can save the video as a delivery recording. The video 1922 can be labeled as a delivery. A doorbell system 1910 may record many videos and labeling the video can indicate to a doorbell user that the video shows the delivery of at least one item. The video 1922 may be of the delivery parcel 1906, the delivery person, the door, and/or a specific part of the inside or outside of the building 1904.

The video 1922 can be sent to an entity associated with sending the delivery parcel (e.g., to show Amazon that their parcel 1906 was delivered to the delivery address). For example, if the delivery parcel 1906 is from Amazon, the entity can be Amazon, a third party that organizes sending the delivery parcel, or the delivery service provider such as UPS, FedEx, or USPS. Any entity that arranges the shipment or actually ships the delivery parcel 1906 is associated with sending the delivery parcel 1906. A company that sold the item in the delivery parcel is associated with sending the delivery parcel 1906 (to fulfill the order). As used herein, a customer that orders an item is not associated with the “sending” of the delivery parcel. This video can be used to resolve disputes regarding whether the parcel 1906 was actually delivered to preclude customers from receiving a parcel 1906, claiming they did not receive the parcel 1906, and then receiving a refund. Videos can also provide a line of security for users and delivery personnel by recording the delivery person while they have access to the building 1904.

The doorbell can analyze the delivery parcel identification code to identify a description 1926 of contents of the delivery parcel 1906, and send a second wireless communication 1928 to a remote computing device 1918. A description 1926 of the contents of the delivery parcel 1906 can help a user or entity know which parcel 1906 has been delivered if, for example, multiple parcels 1906 are expected at the address in one day. The second wireless communication 1928 can include, among other things, the video 1922 and the description of the contents 1926.

The camera 1924 may be on the doorbell 1910, or may be in another location (e.g., inside the building 1904, connected to the outside of the building 1904, or may be detached from the building 1904 all together).

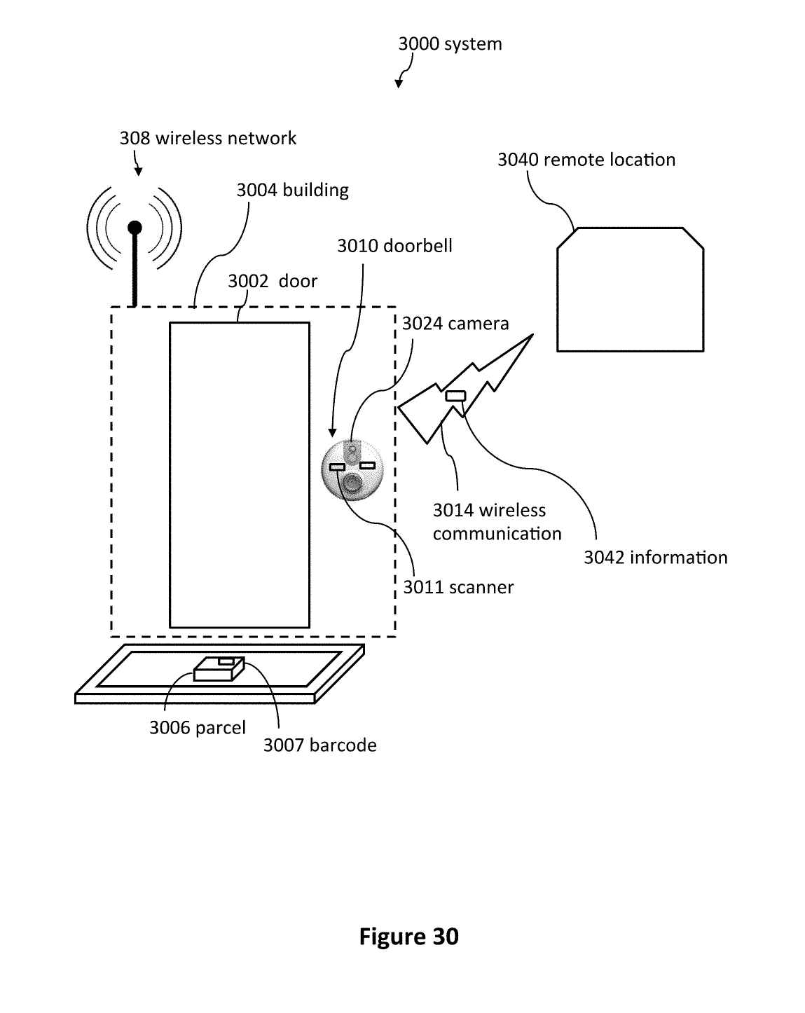

Referring now to FIG. 30, a delivery parcel detection system 3000 includes a doorbell system 3010 located near a door 3002 of a building 3004. The doorbell system 3010 is configured to scan a barcode 3007 of a delivery parcel 3006.

The doorbell system 3010 can including an integrated scanner that has a light source configured to shine light on a barcode of a package. The integrated scanner of the doorbell system 3010 can also include a light sensor configured to detect light from the light source as it bounces back to the doorbell system 3010. The reflected light can be analyzed to identify black and white areas of the barcode. Analyzing the black and white areas can allow the system to determine a code (which can be a number) represented by the black and white areas of the barcode.

An integrated scanner can be replaced by a camera-based system that takes a picture of the barcode. The picture can capture a visual representation of the black and white areas of the barcode. Software can then be used to analyze which areas are black and which areas are white to enable the system to interpret the barcode. This interpretation enables the system to determine a number represented by the black and white areas. In some embodiments, the barcode includes other colors and the system is configured to interpret the colors to determine identifying information represented by the barcode.

In response to scanning the barcode 3007, the doorbell system 3010 can identify a delivery parcel identification code of the delivery parcel 3006. The doorbell system 3010 can then send at least one wireless communication 3014 regarding the delivery parcel identification code to a remote location 3040. The remote location may be associated with an entity associated with sending the delivery parcel or an entity associated with the seller. For example, the remote location 3040 may be a server of the delivery service delivering the delivery parcel 3006.

The doorbell system 3010 includes a barcode scanner 3011, which includes a light source and a light sensor. One way for the doorbell system 3010 to scan the barcode 3007 includes scanning the barcode 3007 of the delivery parcel 3006 using the barcode scanner 3011. There are several ways that the doorbell system 3010 can scan the barcode 3007 of the delivery parcel 3006. The doorbell system 3010 may include a camera 3024. Scanning the barcode 3007 can include taking a picture of the barcode 3007 of the delivery parcel 3006 using the camera 3024. The doorbell system 3010 can then identify the delivery parcel identification code of the delivery parcel 3006 by analyzing the picture to identify the delivery parcel identification code.

The wireless communication 3014 can be sent to an entity associated with sending the delivery parcel 3006 in order to notify the entity associated with sending the delivery parcel 3006 that the delivery parcel 3006 was delivered. The wireless communication 3014 can include information 3042 about the delivery parcel 3006. For example, the wireless communication 3014 can include the delivery parcel identification code, the wireless communication 3014 may include an indication of an address of the doorbell system 3010, and the wireless communication 3014 can include other data, such as time or date of delivery. The doorbell system 3010 can also notify, via the wireless communication, the entity associated with sending the delivery parcel that the delivery parcel 3006 was delivered to the intended address. The entity associated with sending the delivery parcel 3006 can be the entity sending the parcel or the entity delivering the parcel, or another entity involved with sending the parcel. For example, if the delivery parcel 3006 is from Amazon, the entity can be Amazon, a third party that organizes the sending the delivery parcel, or the delivery service provider such as UPS, FedEx, or USPS. The doorbell system 3010 can also notify, via the wireless communication 3014, a seller of the delivery parcel 3006 that the delivery parcel 3006 was delivered. An entity associated with a seller of the delivery parcel 3006 can be, for example, the person or business selling the item (e.g., Walmart or Target) or a third party associated with the seller (e.g., Amazon or eBay). The doorbell system 3010 can notify, via the wireless communication 3014, the seller that the delivery parcel was delivered to the intended address. The indication of the address can be the actual address, a code representing the address, a code that is associated with the address in a database, or any other data configured to enable the entity to determine the address.

The camera 3024 of the doorbell system 3010 can record a video and send the video to an entity associated with sending the delivery parcel. The video can show the delivery parcel and/or the delivery person. The video may be used to provide video evidence to the entity of the delivery parcel 3006 being delivered. The video may be sent in conjunction with other identifying information, such as the parcel identification code, the address of the doorbell system 3010, or information regarding the delivery person. The video may be sent in response to identifying the delivery parcel identification code.

The doorbell system 3010 sending the wireless communication 3014 regarding the delivery parcel identification code can include sending the wireless communication 3014 to a seller of the delivery parcel 3006 or an entity associated with the selling of the delivery parcel 3006. The video can be used to provide video evidence of the delivery parcel 3006 being delivered.

Once the delivery parcel identification code has been identified by the doorbell system 3010 by, for example, scanning the barcode, the doorbell system 3010 can determine an identity of an entity associated with sending the delivery parcel 3006. The doorbell system 310 can determine the identity of an entity associated with sending the delivery parcel 3006 by, for example, looking up the delivery parcel identification code in a database. Once the entity has been identified by the doorbell system 3010, a wireless communication 3014 regarding the delivery parcel identification code is sent to the entity. The wireless communication can include, among other things, a video, taken by a camera of the doorbell system, an address to which the delivery parcel was delivered, and/or the delivery parcel identification code. The video can show a delivery of the delivery parcel.

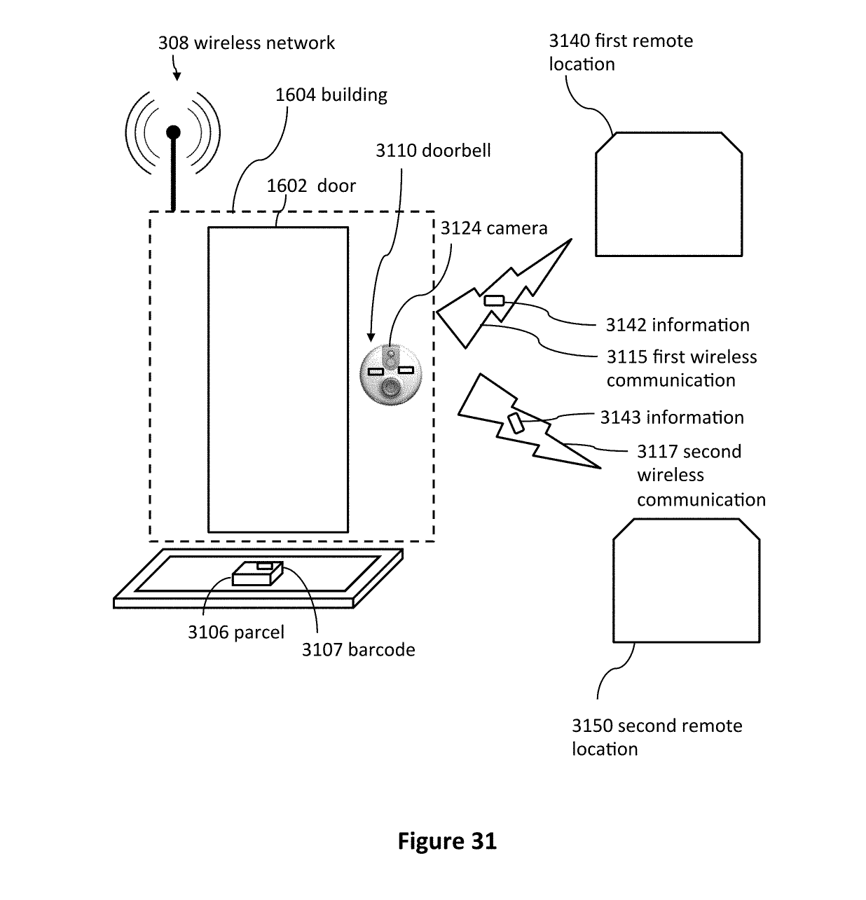

Referring now to FIG. 31, often there are several different entities associated with sending and selling the delivery parcel 3106. Delivering entities and selling entities may each want to verify that the parcel 3106 was delivered to, for example, prevent customers from claiming they never received a delivery parcel 3106 that was correctly delivered. The doorbell system 3110 can send out more than one wireless communication 3115, 3117 in order to, for example, inform several entities of the delivery of the delivery parcel 3006. To illustrate, a first wireless communication 3115 regarding the delivery parcel identification code 3142 can be sent to an entity associated with sending the delivery parcel 3006 at a first remote location 3140 and a second wireless communication 3117 regarding the delivery parcel identification code 3143 to a to a seller of the delivery parcel 3006 (or an entity associated with the selling of the delivery parcel) at a second remote location 3150. The second wireless communication 3117 can be sent to any second remote location 3150. The second remote location 3150 may be, among other things, a remote computing device of the seller, a server associated with the seller, or a remote computing device of a delivery person. The information 3142, 3143 sent in the first wireless communication 3115 and/or second wireless communication 3117 can be, among other things, the delivery parcel identification code, the video recorded by the camera 3124, the address of the doorbell system 3110, and/or the barcode 3107. The information 3142 contained in the first wireless communication 3115 and the information 3143 contained in the second wireless communication 3117 can be the same or can be different.

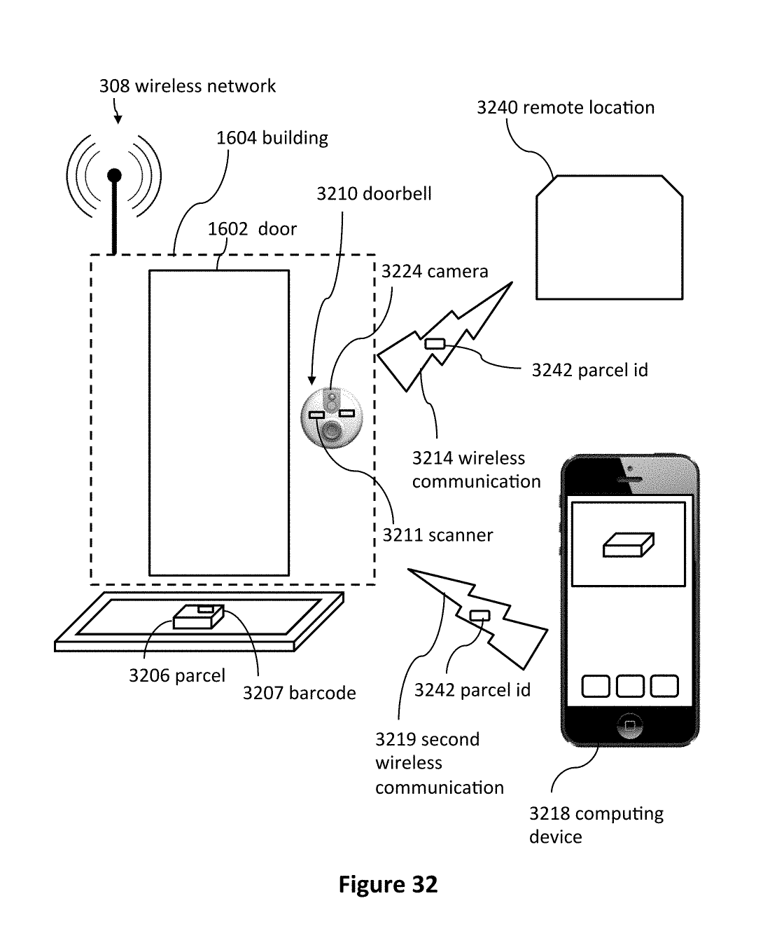

Referring now to FIG. 32, the doorbell system 3210 can receive a delivery parcel identification code of a delivery parcel 3206 and send at least one wireless communication 3214 to a remote location 3240. The wireless communication 3214 can comprise the delivery parcel identification code 3242. The remote location 3240 can be associated with an entity associated with sending the delivery parcel and/or an entity associated with the seller. The doorbell system may have a barcode scanner 3211 having a light source and a light sensor. The doorbell system 3210 can receive the delivery parcel identification code of a deliver parcel 3206 by, for example, scanning the barcode 3207 of the delivery parcel 3206. The doorbell system 3210 may also receive the delivery parcel identification code by taking a picture of the barcode 3207 with the camera 3224 and analyzing the picture to identify the delivery parcel identification code. The doorbell system 3210 may also receive the delivery parcel identification code 3242 wirelessly. For example, receiving the delivery parcel identification code can include receiving a second wireless communication 3219 from a computing device 3218 configured to scan packages. This computing device can be a camera of a smartphone of the delivery person or the scanner that the delivery person uses.

The wireless communication 3214 can be configured to verify, by the doorbell system 3210, that the delivery parcel 3206 was delivered to an address of the doorbell system 3210. Verifying that the delivery parcel 3206 was delivered to an address of the doorbell system 3210 can include checking the delivery parcel identification code and the address of the doorbell system 3210 to insure the communicated data matches with expected data. Checking the delivery parcel identification code and the address of the doorbell system 3210 may include, for example, looking up the delivery parcel identification code and/or the address in a database and confirming that the delivered information matches the expected information.

The camera 3224 of the doorbell system 3210 can also record a video. The video can be configured to show the delivery parcel 3206 and/or the delivery person. The video is then sent to the entity associated with sending the delivery parcel 3206 and/or an entity associated with the seller. The video can provide, among other things video evidence to the entity of the delivery parcel 3206 being delivered. The video can be sent to the entity associated with sending or the entity associated with the seller in response to receiving the delivery parcel identification code 3242 and determining an identity of the entity associated with sending and/or selling the delivery parcel 3206.

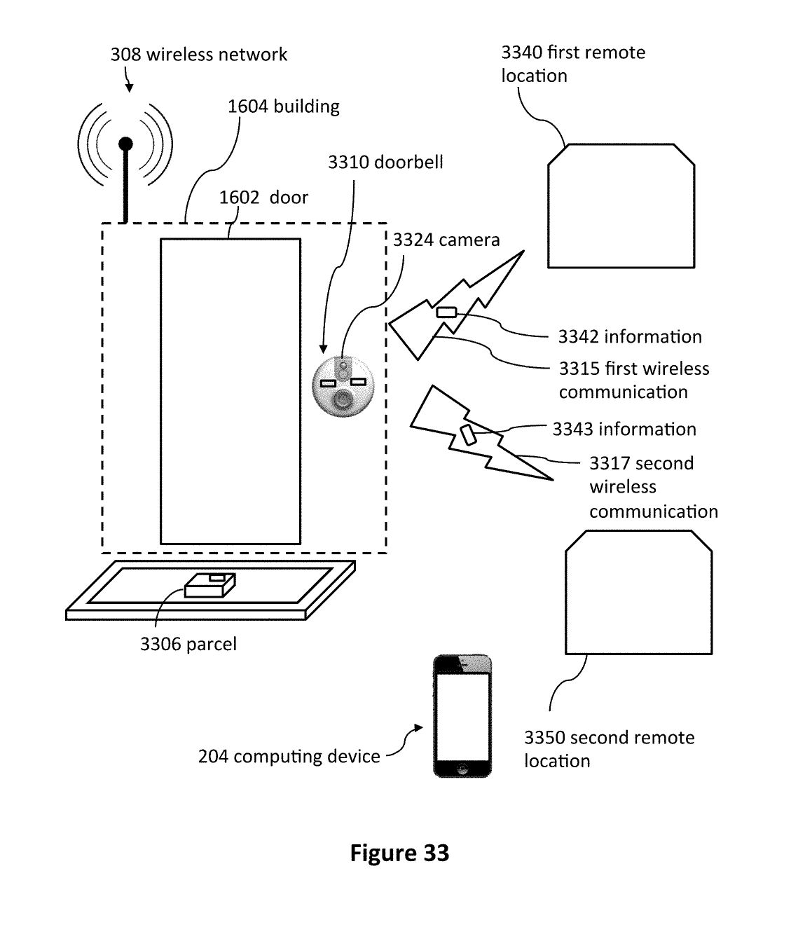

Referring now to FIG. 33, more than one wireless communication 3315, 3317 can be sent to different entities associated with sending and/or selling the delivery parcel 3306. To illustrate, the doorbell system 3110 sends a first wireless communication 3315 to a first remote location 3340 and a second wireless communication 3317 to a second remote location 3350. The first remote location 3340 is associated with an entity associated with sending the deliver parcel 3306. The second remote location 3350 is associated with an entity associated with the seller of the delivery parcel 3206. The first wireless communication 3315 and the second wireless communication 3117 include information 3342, 3343 regarding the delivery parcel. The information 3342, 3343 can include, for example, the delivery parcel identification code, a picture or a video of the delivery parcel 3306 taken by the camera 3324, and/or the address of the doorbell system 3310. The information 3342 contained in the first wireless communication 3315 and the information 3343 contained in the second wireless communication 3317 can be the same or can be different.

Some embodiments use a doorbell system (e.g., as described in the context of FIGS. 1-4 and also as described in the context of other figures). Embodiments, however, can use many, some, or essentially all of the components of a doorbell system without actually including a doorbell button. These systems that include components of a doorbell system but do not include a doorbell button can be referred to as camera systems. For example, camera systems can be coupled to an outside of a building (e.g., to watch an entryway of the building). Camera systems can also be coupled to an inside of a building (e.g., to watch an entryway from the inside of the building or to watch other parts of the inside of the building).

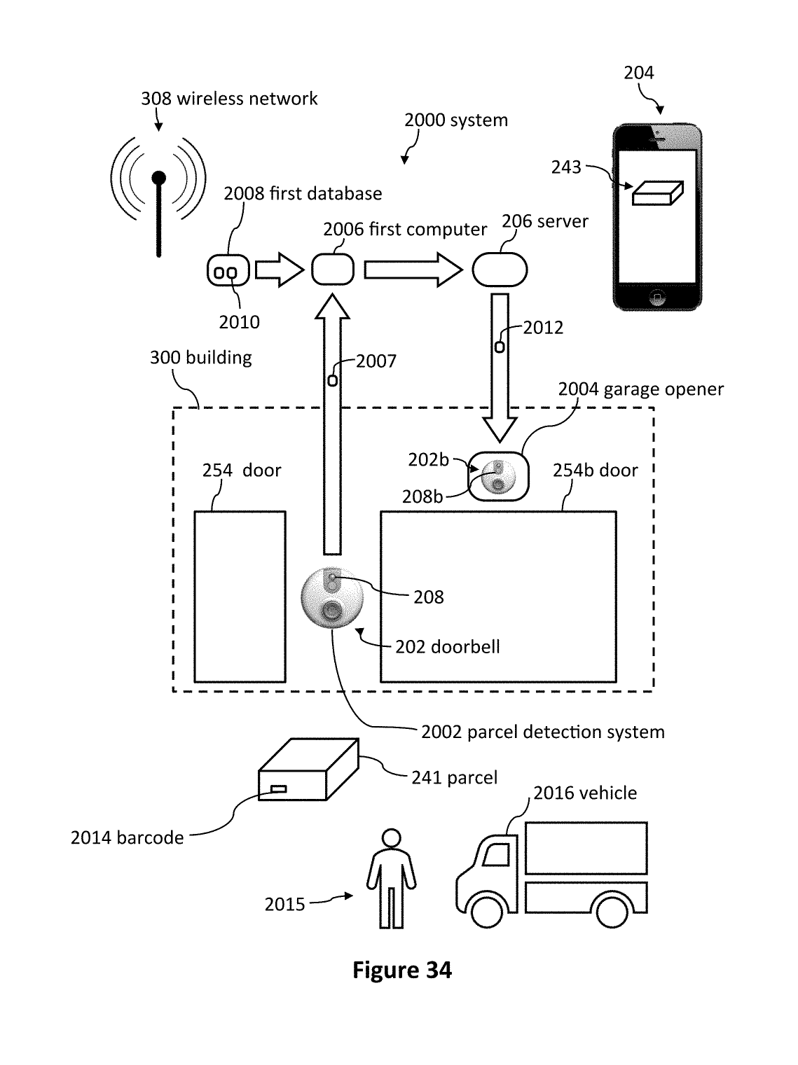

Referring now to FIG. 34, a garage door opening system 2000 includes a parcel identification detection system 2002, a garage door opener 2004, and a first computer system 2006. The parcel identification detection system 2002 is configured to detect a delivery parcel identification code 2007 of a delivery parcel 241 and is coupled to a building 300 with a garage door 254b. The parcel identification detection system 2002 can be a camera, scanner, or RFID receiver. The garage door opener 2004 (e.g., SilentMax 750 manufactured by Genie, Heavy-Duty Chain Drive Garage Door Opener manufactured by Chamberlain, ½ HP DC Chain Drive Garage Door Opener manufactured by SkyLink, ¾ HP Garage Door Opener manufactured by Direct Drive) is configured to open a garage door 254b. The first computer system 2006 receives the delivery parcel identification code 2007 detected by the parcel identification detection system 2002. The first computer system 2006 then compares the delivery parcel identification code 2007 to a first database 2008 to, for example, check that the delivery parcel identification code 2007 matches an expected delivery identification code 2010. The first database 2008 may comprise, among other things, at least one expected delivery identification code 2010. The first computer system 2006 can be communicatively coupled to the parcel identification detection system 2002 and the garage door opener 2004. The first computer system 2006 then sends a first communication 2012 to the garage door opener 2004. The first communication may be sent in response to determining that the delivery parcel identification code 2007 is indicative of the delivery parcel 241 being an expected delivery (e.g., the delivery parcel identification code 2007 matches an expected delivery identification code 2010). The garage door opener 2004 can be configured to open the garage door 254b at least partially in response to the first communication 2012.

The garage door opener 2004 can be configured to open the garage door less than fully. By opening the garage door 254b only partially, the delivery person (or another person) may be precluded from entering the building 300. For example, a garage door that opens vertically may only be opened enough to slip a parcel underneath the opening. Opening the garage door 254b less than fully, can enable the parcel 241 to be inserted under the garage door 254b while impeding the delivery person from sliding under the garage door because the gap is too small for a person to fit, but is large enough for the parcel 241. The garage door opening less than fully can also prevent a delivery person from seeing the entire contents of the garage or building 300 they are delivering the delivery parcel 241 to, thus adding a measure of security. The garage door 254b opening less than fully may also prevent a delivery person from removing other items from the garage or building 300 that would be too big to fit through the opening. For example, the garage door opener 2004 can be configured to open the garage door 254b less than 20 percent at least partially in response to the first communication 2012. Opening the garage door 254b only partially enables an entity 2015 that delivers the delivery parcel 241 to push the delivery parcel under the partially open garage door 254b.

The garage door 254b may be configured to open an amount at least partially based on a size (e.g., a height or thickness) of the delivery parcel 241, in response to the first communication 2012. For example, if the delivery parcel 241 is an envelope, the garage door 254b, may only open a few inches. If the delivery parcel 241 is a large box, the garage door 254b may open wide enough to accommodate the box. If the delivery parcel 241 is 5 inches thick, the garage door 254b may open to allow 6 inches of room to slide the delivery parcel 241 under the garage door 254b. The garage door opener 2004 can be configured to open the garage door 254b to any amount within its operating range (e.g., 15%, 25%, 60%, or 100%).

Opening the garage door just enough to slide the delivery parcel under the garage door can reduce the odds of the delivery person entering the garage. For example, many packages have a smallest dimension (e.g., width, height, thickness) that is less than the thickness of a person (e.g., as measured from the back of the person to the front of the chest or stomach of the person). Opening the garage door just enough for the smallest dimension of the delivery parcel to slide under the garage can result in a gap between the floor of the garage and the bottom of the garage door that is too small for the delivery person to slide through.

In some embodiments, the garage door opens a first distance (e.g., as measured from the floor of the garage to the bottom of the garage door, or as measured by the amount the bottom of the garage door moves from the closed position). The first distance can be less than 6 inches, less than 10 inches, and/or less than 18 inches greater than a dimension of the delivery parcel. The dimension can be the smallest dimension of the delivery parcel.

The garage door can open an amount that is based, at least in part, on a dimension of the delivery parcel, a size of the delivery parcel, and/or a type of the delivery parcel (e.g., a flat envelope, a bubble mailer, a box, a predetermined box category). For example, FedEx has the following box sizes: the FedEx Small Box called “S1,” the FedEx Small Box called “S2,” the FedEx Medium Box called “M1,” the FedEx Medium Box called “M2,” the FedEx Large Box called “L2,” and the FedEx Extra Large Box called “X2.”

The “S2” FedEx box has the following inside dimensions: 8¾″×2 11/16″×11 5/16″ (and outside dimensions that are slightly larger). The smallest inside dimension is 2 11/16 inches. The smallest outside dimension is about 3 inches. The system could be configured to determine that the delivery parcel is an “S2” box, and then open the garage door 4 inches (based on the dimensions of the “S2” box) to enable the delivery person to slide the delivery parcel under the garage (while impeding the delivery person from entering the garage).

The “X2” FedEx box has the following inside dimensions: 15¾″×14 3/16″×6″ (and outside dimensions that are slightly larger). The smallest inside dimension is 6 inches. The smallest outside dimension is about 6.3 inches. The system may be configured to open the garage door more for the “X2” box than for the “S2” box. The system can be configured to receive a wireless communication configured to open the garage door 7 inches in response to detecting a barcode and/or an identity of the “X2” box.

The garage door opener 2004 can then be configured to close the garage door 254b after the delivery parcel 241 has been placed inside the building 300. The garage door opening system 2000 can determine the delivery parcel 241 has been placed inside the building 300 in several ways. For example, the garage door opener 2004 may be configured to close the garage door 254b in response to a predetermined amount of time passing. The garage door opening system 2000 may include one or more cameras 208, 208b. The garage door opening system 2000 may also include a second computer system configured to analyze a picture taken by a camera 208, 208b to determine that the entity 2015 has left at least a portion of a field of view of the camera 208, 208b. One of these cameras 208, 208b may be located, for example, inside of the garage or inside of the building 300. At least one of these cameras may be located outside of the building 300. The garage door opener 2004 may be configured to close the garage door 254b in response to the second computer system determining that the entity 2015 has left. Referring now to FIGS. 3 and 4, the system can comprise a doorbell 202 that includes all of the features of the doorbells 202 described herein and/or incorporated by reference. The system can include a camera 208 and a second computer system 520, which can be an image analysis system.

The garage door opening system 2000 can include a camera system 208 configured to take a first picture of the delivery parcel 241. The camera system 208 can be configured to take a second picture of the garage door 254b in an at least partially open state. The first picture and the second picture may both be taken by the same camera 208. The first picture may be taken by a first camera 208 and the second picture may be taken by the second camera 208b. The garage door opening system 2000 may be configured to send the first picture and/or the second picture to a remote computing device 204. The camera 208 can be configured to take a first picture of the delivery parcel 241 in response to the parcel identification detection system 2002 detecting the delivery parcel 241.

The parcel identification detection system 2002 can be a camera, scanner, or RFID receiver and may detect the delivery parcel identification code 2007 in one or more of several different ways. For example, the parcel identification detection system 2002 may include a camera 208 which takes a picture of a barcode 2014 on the delivery parcel 241. In response to the camera 208 taking a picture of a barcode 2014 on the delivery parcel 241, the parcel identification detection system 2002 may then detect the delivery parcel identification code 2007 by, for example, analyzing the picture to identify the delivery parcel identification code 2007. The parcel identification detection system 2002 may comprise a barcode scanner comprising a light source and a light sensor. The parcel identification detection system 2002 can be configured to detect the delivery parcel identification code 2007 in response to the scanner scanning a barcode 2014 on the delivery parcel 241. The parcel identification detection system 2002 may be configured to detect the delivery parcel identification code 2007 in response to an entity 2015 that delivers the delivery parcel 241 scanning the delivery parcel 241 on, for example, the remote computing device of the entity 2015 that delivers the parcel. The parcel identification detection system 2002 can be configured to detect the delivery parcel identification code 2007 in response to an entity 2015 that delivers the delivery parcel 241 scanning the delivery parcel 241 and wirelessly transmitting the delivery parcel identification code 2007 to the parcel identification detection system 2002. The parcel identification detection system 2002 may include an antenna and may be configured to detect the delivery parcel identification code 2007 in response to the antenna receiving a second wireless communication having the delivery parcel identification code 2007 from a computing device 204 configured to scan packages.

The garage door opening system 2000 can include a means to validate that the delivery person or entity 2015 is the one using the parcel 241 to open the garage door 254b (and not a burglar who saw the parcel 241 and wanted to use it to enter the building 300). The means to validate that the entity 2015 is authorized can be a device of the entity 2015 (RFID badge, Bluetooth and/or WiFi from the delivery person's remote computing device 204 to the garage door opening system 2000, wireless communication of any kind, and/or Bluetooth BLE). The garage door opening system 2000 can include a deliverer identification detection system configured to detect a first deliverer identification code associated with an entity 2015 that delivers the delivery parcel 241. The garage door opening system 2000 may include a third computer system configured to receive the first deliverer identification code detected by the deliverer identification detection system, compare the first deliverer identification code to a second database, and determine that the first deliverer identification code is indicative of the entity 2015 being authorized to deliver the delivery parcel 241 and/or open the garage door 254b. The second database can include, among other things, at least one expected deliverer identification code. Determining that the first deliverer identification code is indicative of the entity 2015 being authorized to deliver the delivery parcel 241 and/or open the garage door 254b can include checking that the deliverer identification code matches an expected deliverer identification code. The garage door opener 2004 may be configured to open the garage door 254b at least partially in response to the third computer system determining that the first deliverer identification code is indicative of the entity 2015 being authorized (e.g., the deliverer identification code matches an expected deliverer identification code). The garage door opening system 2000 may be configured to open the garage door 254b less than 60 percent, less than 15 percent, or to any amount within its operating range at least partially in response to the third computer system determining that the first deliverer identification code is indicative of the entity 2015 being authorized. Opening the garage door 254b less than fully keeps a delivery person or another person from easily walking into the garage or building 300.

The garage door opening system 2000 can include a radio-frequency identification device having the first deliverer identification code and configured to be transported by the entity 2015 that delivers the delivery parcel 241. The deliverer identification detection system may be configured to wirelessly detect the first deliverer identification code from the radio frequency identification device. The radio frequency identification device may be configured to be worn by a delivery driver and/or may be coupled to a delivery vehicle 2016 that transports the delivery parcel. The garage door opening system 2000 may include a remote computing device 204 comprising the radio frequency identification device. The remote computing device 204 is configured to be carried by a delivery driver.

The delivery person or entity 2015 associated with delivering the delivery parcel 241 might not know which houses have a garage door opening system 2000. The garage door opening system 2000 can send the driver an audible alert, smartphone alert, or sign pad alert that this home has opted in to receiving packages via the garage door opening system 2000. The alert can be sent in response to the delivery person approaching the building 300 (e.g., in wireless communication range, or within a certain distance of the building 300). The user of the garage door opening system 2000 can opt in to authorize all or some delivery parcels 241 to be placed inside the building 300 via the front door or garage door 254b. Users may allow only certain delivery parcels 241 or certain types of delivery parcels 241 (e.g., medicine, electronics, or parcels worth a certain amount of money) to be placed inside the building 300. The garage door opening system 2000 may include a remote computing device 204 configured to wirelessly transmit the first deliverer identification code to the deliverer identification detection system. The remote computing device 204 can be configured to read a barcode 2014 on the delivery parcel 241 to determine the delivery parcel identification code 2007, and wirelessly transmit the delivery parcel identification code 2007 to the parcel identification detection system 2002 to enable the parcel identification detection system 2002 to detect the delivery parcel identification code 2007.

The garage door opening system 2000 may include a speaker and an audio file. When the garage door opening system 2000 detects a delivery person or a scan of a package via the camera 208, the garage door opening system 2000 can play an audio file that says, for example, “Please put the delivery parcel in the garage.” At the same time, the garage door 254b can open at least partially to allow the parcel 241 to be slid under the door. The garage door 254b is then closed once the parcel 241 is detected inside the building 300. This detection can be done by a camera 208, a motion sensor (e.g., in the garage), or a doorbell 202b that is used as a garage monitoring unit.

The garage door opening system 2000 may be configured to play the audio file via the speaker in response to detecting an entity 2015 that delivers the delivery parcel 241 and/or in response to detecting the delivery parcel 241. The audio file may be configured to instruct the entity 2015 to put the delivery parcel 241 inside a building 300 having the garage door 254b. The garage door opening system 2000 may include a camera 208, a barcode scanner, an RFID scanner, and/or a motion detector configured to detect the delivery parcel 241.

In several embodiments, the garage door opening system 2000 may include a second wireless communication sent from the garage door opening system 2000 to a remote computing device 204 of an entity 2015 that delivers the delivery parcel 241 in response to the garage door opening system 2000 detecting the entity 2015 and/or the delivery parcel 241. The second wireless communication may be configured to instruct the entity 2015 to put the delivery parcel 241 inside a building 300 to which the garage door 254b is attached. The system 2000 may include a speaker and an audio file. The garage door opening system 2000 may be configured to play the audio file via the speaker in response to the garage door opening system 2000 detecting the delivery parcel 241 and/or an entity 2015 that delivers the delivery parcel 241. The audio file may be configured to instruct the entity 2015 to put the delivery parcel 241 inside a building 300 to which the garage door 254b is attached.

The garage door opener 2004 can include a monitoring device 202b that includes all the features, capabilities, and methods of the doorbells 202 described herein and/or incorporated by reference. For example, the monitoring device 202b can include a camera 208 and all the other items described in the context of FIG. 4. The monitoring device 202b can record videos to monitor an inside of a garage and can record videos in response to the garage door opening and/or any motion inside the garage.

In some embodiments, the doorbell 202 is placed inside the garage (and may or may not include a doorbell button 212). The camera assembly 208 of the doorbell 202 can be used to monitor the inside of the garage. For example, a user can open an “app” on her remote computing device 204 to activate the camera assembly 208 to enable the user to see (via a live video shown on the remote computing device 204) if her garage door 254b is open. The “app” can include an icon such that the user can touch the screen of the remote computing device 204 in the area of the icon to close the garage door 254b.

In several embodiments, the system sends a notification to the remote computing device 204 if a vehicle leaves the garage without closing the garage door 254b. This notification can be a wireless communication send via remote servers, WiFi networks, cellular networks, and any other communication means from the doorbell 202 located inside the garage to the remote computing device 204.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “can,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A garage door opening system comprising:
a parcel identification detection system configured to detect a delivery parcel identification code of a delivery parcel;
a garage door opener configured to open a garage door; and
a first computer system configured to receive the delivery parcel identification code detected by the parcel identification detection system, compare the delivery parcel identification code to a first database comprising at least one expected delivery identification code, and send a first communication to the garage door opener in response to determining that the delivery parcel identification code is indicative of the delivery parcel being an expected delivery, wherein the garage door opener is configured to open the garage door at least partially in response to the first communication.

2. The system of claim 1, wherein the first computer system is communicatively coupled to the parcel identification detection system and the garage door opener.

3. The system of claim 1, wherein the parcel identification detection system is coupled to a building that comprises the garage door.

4. The system of claim 1, wherein the garage door opener is configured to open the garage door less than 20 percent at least partially in response to the first communication to enable an entity that delivers the delivery parcel to push the delivery parcel under the partially open garage door.

5. The system of claim 1, wherein the garage door opener is configured to open the garage door less than fully, and the garage door is configured to open an amount at least partially based on a size of the delivery parcel in response to the first communication to enable an entity that delivers the delivery parcel to push the delivery parcel under the garage door.

6. The system of claim 5, wherein the garage door opener is configured to close the garage door in response to a predetermined amount of time passing.

7. The system of claim 5, further comprising a camera and a second computer system configured to analyze a picture taken by the camera to determine that the entity has left at least a portion of a field of view of the camera, wherein the garage door opener is configured to close the garage door in response to the second computer system determining that the entity has left.

8. The system of claim 1, further comprising a camera system configured to take a first picture of the delivery parcel and to take a second picture of the garage door in an at least partially open state.

9. The system of claim 1, further comprising a camera configured to take a first picture of the delivery parcel, wherein the garage door opening system is configured to send the first picture to a remote computing device.

10. The system of claim 1, further comprising a camera configured to take a first picture of the delivery parcel in response to the parcel identification detection system detecting the delivery parcel.

11. The system of claim 1, wherein the parcel identification detection system comprises a camera, and the parcel identification detection system is configured to detect the delivery parcel identification code in response to the camera taking a picture of a barcode on the delivery parcel.

12. The system of claim 11, wherein the parcel identification detection system is configured to detect the delivery parcel identification code in response to analyzing the picture to identify the delivery parcel identification code.

13. The system of claim 1, wherein the parcel identification detection system comprises a barcode scanner comprising a light source and a light sensor, and the parcel identification detection system is configured to detect the delivery parcel identification code in response to the barcode scanner scanning a barcode on the delivery parcel.

14. The system of claim 1, wherein the parcel identification detection system is configured to detect the delivery parcel identification code in response to an entity that delivers the delivery parcel scanning the delivery parcel.

15. The system of claim 1, wherein the parcel identification detection system is configured to detect the delivery parcel identification code in response to an entity that delivers the delivery parcel scanning the delivery parcel and wirelessly transmitting the delivery parcel identification code to the parcel identification detection system.

16. The system of claim 1, wherein the parcel identification detection system comprises an antenna and is configured to detect the delivery parcel identification code in response to the antenna receiving a second wireless communication having the delivery parcel identification code from a computing device configured to scan packages.

17. The system of claim 1, further comprising a deliverer identification detection system configured to detect a first deliverer identification code associated with an entity that delivers the delivery parcel, and
a third computer system configured to receive the first deliverer identification code detected by the deliverer identification detection system, compare the first deliverer identification code to a second database comprising at least one expected deliverer identification code, and determine that the first deliverer identification code is indicative of the entity being authorized to at least one of deliver the delivery parcel and open the garage door,
wherein the garage door opener is configured to open the garage door at least partially in response to the third computer system determining that the first deliverer identification code is indicative of the entity being authorized.

18. The system of claim 17, wherein the garage door opening system is configured to open the garage door less than 60 percent at least partially in response to the third computer system determining that the first deliverer identification code is indicative of the entity being authorized.

19. The system of claim 17, wherein the garage door opening system is configured to open the garage door less than 15 percent at least partially in response to the third computer system determining that the first deliverer identification code is indicative of the entity being authorized.

20. The system of claim 17, further comprising a radio-frequency identification device having the first deliverer identification code and configured to be transported by the entity that delivers the delivery parcel, wherein the deliverer identification detection system is configured to wirelessly detect the first deliverer identification code from the radio-frequency identification device.

21. The system of claim 20, wherein the radio-frequency identification device is configured to be worn by a delivery driver.

22. The system of claim 20, wherein the radio-frequency identification device is coupled to a delivery vehicle that transports the delivery parcel.

23. The system of claim 20, further comprising a remote computing device comprising the radio-frequency identification device, wherein the remote computing device is configured to be carried by a delivery driver.

24. The system of claim 17, further comprising a remote computing device configured to wirelessly transmit the first deliverer identification code to the deliverer identification detection system.

25. The system of claim 24, wherein the remote computing device is configured to read a barcode on the delivery parcel to determine the delivery parcel identification code, and is configured to wirelessly transmit the delivery parcel identification code to the parcel identification detection system to enable the parcel identification detection system to detect the delivery parcel identification code.

26. The system of claim 1, further comprising a speaker and an audio file, wherein the garage door opening system is configured to play the audio file via the speaker in response to detecting an entity that delivers the delivery parcel, wherein the audio file is configured to instruct the entity to put the delivery parcel inside a building having the garage door.

27. The system of claim 1, further comprising a speaker and an audio file, wherein the garage door opening system is configured to play the audio file via the speaker in response to detecting the delivery parcel, wherein the audio file is configured to instruct an entity to put the delivery parcel inside a building having the garage door.

28. The system of claim 27, further comprising at least one of a camera and a motion detector configured to detect the delivery parcel.

29. The system of claim 1, further comprising a second wireless communication sent from the garage door opening system to a remote computing device of an entity that delivers the delivery parcel in response to the garage door opening system detecting at least one of the entity and the delivery parcel, wherein the second wireless communication is configured to instruct the entity to put the delivery parcel inside a building to which the garage door is attached.

30. The system of claim 1, further comprising a speaker and an audio file, wherein the garage door opening system is configured to play the audio file via the speaker in response to the garage door opening system detecting at least one of the delivery parcel and an entity that delivers the delivery parcel, wherein the audio file is configured to instruct the entity to put the delivery parcel inside a building to which the garage door is attached.
